(19) United States
(12) Patent Application Publication
(10) Pub. No.: US 2010/0241947 A1
(43) Pub. Date: Sep. 23, 2010

(54) ADVANCED FEATURES, SERVICE AND DISPLAYS OF LEGAL AND REGULATORY INFORMATION

(76) Inventors: Michael Dahn, Farmington, MN (US); Steven Fischer, Burnsville, MN (US); Aaron Cooper, Cologne, MN (US); Scott Francis, Prior Lake, MN (US); James John Jarvis, Eagan, MN (US); Mary B. Larson, St. Paul, MN (US); Anita Trivedi Pagey, Eagan, MN (US); Brian C. Quinn, St. Paul, MN (US)

Correspondence Address: Thomson Reuters c/o Intellectual Property Dept.;Attn: Michelle Chang, 3 Times Square, New York, NY, 10036, US

(21) Appl. No.: 12/791,437

(22) Filed: Jun. 1, 2010

Related U.S. Application Data
(63) Continuation-in-part of application No. 12/319,133, filed on Dec. 31, 2008.
(60) Provisional application No. 61/009,601, filed on Dec. 31, 2007.

(51) Int. Cl. G06F 17/00; G06F 17/30

(52) U.S. Cl. 715/233; 707/769; 707/783; 707/E17.005; 707/E17.014

(57) ABSTRACT

Systems and techniques are disclosed that allow a user to enter a query in a query input region of a graphical user interface and respond to the query by automatically directing it to an appropriate database, saving a user from having to choose among the myriad databases within the system. The system provides shareable folders for not only selected documents or excerpts from documents, but also for annotations and markups associated with documents. The system also enables a user to set permissions as to whether to allow documents, as well annotations and markups, private or publicly available to other users. Further, the system allows a user to specify an action that is to occur once a particular event occurs affecting a document, annotation or markup.

### CROSS-REFERENCE TO RELATED APPLICATIONS

This application is a continuation-in-part of U.S. application Ser. No. 12/319,133 filed Dec. 31, 2008, which claims priority to U.S. Provisional Application 61/009,601 filed on Dec. 31, 2007, the contents of which are all incorporated herein in their entirety, and also claims priority to U.S. Provisional Application Ser. No. 61/217,522, filed on Jun. 1, 2009, the contents of which is incorporated herein in its entirety.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2010 Thomson Reuters Global Resources.

### TECHNICAL FIELD

This disclosure relates to online research systems, and more particularly to online legal research systems.

### BACKGROUND

The American legal system, as well as some other legal systems around the world, rely on both statutory law and case law (written judicial opinions that interpret statutes and/or articulate uncodified law) to resolve legal disputes. Moreover, the law typically varies based on whether the disputes falls under federal, state, or local jurisdiction. Furthermore, laws change over time. Thus, lawyers are continually called upon to research the law to effectively serve the needs of their clients.

To facilitate their research, many lawyers use online legal research systems, such as the popular Westlaw^{TM} system, as a basic tool. Retrieving information using such systems typically requires users to select one of set of many proprietary databases or information sources and to enter a terms and connectors type query or a natural language query. Specialized search templates for the selected database are sometimes made available to assist the user in formulating the query.

The present inventors recognize that effective use of these systems often takes considerable experience and knowledge, given that users typically need some knowledge of which databases to use and how to construct good queries. Indeed, much information that may be useful to a user can easily go overlooked simply because the user was ignorant of where to search. In addition, the present inventors also recognize that these systems, though quite powerful, lack many service features and conveniences that could make lawyers more effective at their work.

For example, many lawyers print and then mark up and/or annotate research retrieved from these systems. Many of these annotations and/or markups include important information, such as a lawyer's insight and knowledge regarding the retrieved research, which are not captured by these systems. Furthermore, online legal research systems do not foster collaboration among lawyers. For example, lawyers associated with a same law firm or that are researching similar topics of law, do not have the ability to share their research and/or annotations and markups of that research with other lawyers through these systems.

Accordingly, there exists a need for improved services and features in online legal research systems.

### SUMMARY

To address this and/or other needs, systems and techniques for an improved online legal research are disclosed. The system allows a user to enter a query in a query input region of a graphical user interface and responds to the query by automatically directing it to an appropriate database, saving the user from having to choose among the myriad databases within the system. The exemplary system also provides shareable folders for not only selected documents or excerpts from documents, but also for annotations and markups associated with documents. The system also enables a user to set permissions as to whether to make documents as well annotations and markups private or publicly available to other users. Further, the system allows a user to specify an action that is to occur once a particular event occurs affecting a document and/or annotation and markup associated with the document.

Various aspects of the system relate to document retrieval and annotations associated with retrieved documents.

For example, according to one aspect, a method of providing online legal research includes receiving a first signal including a first query for searching a first set of legal documents, identifying a second set of legal documents in response to the first query, the second set of legal documents being a subset of the first set of documents, receiving a second signal indicative of a user annotation to be associated with a particular document within the second set of legal documents, associating the user annotation with the particular document, and storing the user annotation and a reference to the particular document in a data store.

In one embodiment, for example, the method further includes receiving a third signal including a request for the particular document, and sending a fourth signal indicative of the user annotation and the reference in response to the request. Associating the user annotation with the reference can include associating location information included in the second signal indicative of a location in the particular document with the user annotation.

In another embodiment, the method includes associating multimedia information included in the second signal to at least a portion of the particular reference, the multimedia information describing at least one of a visual indicator and audio indicator. The visual indicator can include a graphical highlight of a portion of content included in the particular reference.

In one embodiment, for example, the multimedia information and the user annotation are associated with one of a username, a date and time value, a client identifier, a project identifier, or combinations thereof. In one embodiment, the second signal further includes at least one of a user name, a group of users, a client identifier, or project identifier that is allowed viewing, modification, or deletion of the user annotation or the multimedia indicator.

In another embodiment, for example, the method further includes receiving a fifth signal indicative of an event type to be associated with one of a folder, the multimedia information, or the user annotation. The method includes associating the event type with one of the multimedia information, the user annotation, and the folder, and sending a sixth signal comprising a notification of an event occurring relating to the event type. The event type can be associated with an addition, modification, or deletion of a folder, the user annotation or the multimedia information. Further the notification can be an email notification or invitation to view the particular document and at least one of the user annotation and media information.

In yet another embodiment, for example, the method further includes receiving a fifth signal comprising a second query for searching at least one of a first set of user annotations and a first set of multimedia information. In response to the second query, the method includes identifying at least one of a second set of user annotations and a second set of multimedia information, and sending a sixth signal indicative of at least one of the second set of user annotations and the second set of multimedia information. Identifying the second set of user annotations can include comparing content of each of the first set of user annotations to the second query.

In some implementations, one or more of the following advantages may be present. For example, the system can foster collaboration among users by allowing the sharing and searching of folders containing documents, as well as annotations and markups of those documents. Furthermore, the system can be used to notify users of events affecting any particular user, topic, document, folder, annotation or markup.

Additional features and advantages will be readily apparent from the following detailed description, the accompanying drawings and the claims.

### BRIEF DESCRIPTION OF THE DRAWINGS

FIG. A1 is a diagram of an exemplary online legal research system 100 corresponding to one or more embodiments of the invention;

FIG. A1A is a diagram of exemplary program modules included an exemplary online legal research system 100 corresponding to one or more embodiments of the invention;

FIG. A2 is a flowchart of an exemplary method of operating system 100, which corresponds to one or more embodiments of the invention;

FIGS. A3 and 1-56 are facsimiles of exemplary graphical user interfaces corresponding to one or more embodiments of the invention;

FIGS. 57-63 are facsimiles of exemplary graphical user interfaces illustrating folder sharing according to one or more embodiments of the invention;

FIGS. 64-82 are facsimiles of exemplary graphical user interfaces illustrating annotations according to one or more embodiments of the invention;

FIGS. 83-85 are facsimiles of exemplary graphical user interfaces illustrating management of annotations according to one or more embodiments of the invention;

FIGS. 86-88 are facsimiles of exemplary graphical user interfaces illustrating notifications according to one or more embodiments of the invention;

FIGS. 89-100 are facsimiles of exemplary graphical user interfaces illustrating contact information according to one or more embodiments of the invention.

Like reference symbols in the various drawings indicate like elements.

### DETAILED DESCRIPTION OF EXEMPLARY EMBODIMENT(S)

This description describes one or more specific embodiments of one or more inventions. These embodiments, offered not to limit but only to exemplify and teach the inventive subject matter, are shown and described in sufficient detail to enable those skilled in the art to implement or practice the various embodiments of the invention. Thus, where appropriate to avoid obscuring the invention, the description may omit certain information known to those of skill in the art.

### Exemplary Information-Retrieval System

FIG. A1 shows an exemplary online information-retrieval (or legal research) system 100. System 100 includes one or more databases 110, one or more servers 120, and one or more access devices 130.

Databases 110 includes a set of primary databases 112, a set of secondary databases 114, and a set of metadata databases 116. Primary databases 112, in the exemplary embodiment, include a caselaw database 1121 and a statutes databases 1122, which respectively include judicial opinions and statutes from one or more local, state, federal, and/or international jurisdictions. Secondary databases 114, which contain legal documents of secondary legal authority or more generally authorities subordinate to those offered by judicial or legislative authority in the primary database, includes an ALR (American Law Reports) database, 1141, an AMJUR database 1142, a West Key Number (KNUM) Classification database 1143, and an law review (LREV) database 1144. Metadata databases 116 includes case law and statutory citation relationships, KeyCite data (depth of treatment data, quotation data, headnote assignment data, and ResultsPlus secondary source recommendation data). Also, in some embodiments, primary and secondary connote the order of presentation of search results and not necessarily the authority or credibility of the search results.

Databases 110, which take the exemplary form of one or more electronic, magnetic, or optical data-storage devices, include or are otherwise associated with respective indices (not shown). Each of the indices includes terms and phrases in association with corresponding document addresses, identifiers, and other conventional information. Databases 110 are coupled or couplable via a wireless or wireline communications network, such as a local-, wide-, private-, or virtual-private network, to server 120.

Server 120, which is generally representative of one or more servers for serving data in the form of webpages or other markup language forms with associated applets, ActiveX controls, remote-invocation objects, or other related software and data structures to service clients of various “thicknesses.” More particularly, in one embodiment, server 120 includes a processor module 121, a memory module 122, a subscriber database 123, a primary search module 124, metadata research module 125, and a user-interface module 126.

Processor module 121 includes one or more local or distributed processors, controllers, or virtual machines. In the exemplary embodiment, processor module 121 assumes any convenient or desirable form.

In one exemplary embodiment, memory module 122, which takes the exemplary form of one or more electronic, magnetic, or optical data-storage devices, stores subscriber database 123, primary search module 124, secondary search module 125, and user-interface module 126. In another exemplary embodiment, as shown in FIG. 1A1, the memory module 122 also stores an annotation module 140, a contact module 142, an annotation search module 144, an event module 146 and a folder module 148.

Subscriber database 123 includes subscriber-related data for controlling, administering, and managing pay-as-you-go or subscription-based access of databases 110. In the exemplary embodiment, subscriber database 123 includes one or more user preference (or more generally user) data structures. In the exemplary embodiment, one or more aspects of the user data structure relate to user customization of various search and interface options. To this end, some embodiments include user profile information such jurisdiction of practice, area of practice, and position within a firm.

Primary search module 124 includes one or more search engines and related user-interface components, for receiving and processing user queries against one or more of databases 110. In the exemplary embodiment, one or more search engines associated with search module 124 provide Boolean, tf-idf, natural-language search capabilities.

Metadata research module 125 includes one or more search engines for receiving and processing queries against metadata databases 116 and aggregating, scoring, and filtering, recommending, and presenting results. In the exemplary embodiment, module 125 includes one or more feature vector builders and learning machines to implement the functionality described herein. Some embodiments charge a separate or additional fee for accessing documents from the second database.

User-interface module 126 includes machine readable and/or executable instruction sets for wholly or partly defining web-based user interfaces, such as search interface 1261 and results interface 1262, over a wireless or wireline communications network on one or more accesses devices, such as access device 130.

Folder module 148 includes machine readable and/or executable instruction sets for providing access and storage of research documents, user annotations of documents, and markups of documents. In one embodiment, the folder module 148 organizes documents and any annotations and markups associated therewith, in an electronic data store of the server, such as but not limited to a database, in response to a signal received from a graphical user interface. As used herein, the term “folder” refers to a data structure used for accessing and storing documents and any associated annotations and markups associated therewith. Example operations performed by the folder module 148 on a folder include, but are not limited to, creating a folder in a data store, adding a folder to a data store, creating sub-folders arranged hierarchically in a folder of a data store, naming a folder of a data store, associating a folder with a user, group of users, client identifier and/or project identifier, and setting access permissions for a folder.

For example, in one embodiment, the folder module 148 creates a shareable folder that is accessible to a plurality of users in a data store of the server in response to receiving a signal. In one example embodiment, the folder module 148 receives the signal from a graphical user interface (GUI) 138 executing on an access device 130. Further, in another embodiment, the folder module 148 is configured to manage content of the shareable folder based on a received signal from the GUI 138. The management of content provided by the annotation module 148 includes, but is not limited to, adding content to the folder, modifying content of the folder, and deleting content of the folder based on a user name, a group name, a client identifier, a project identifier, or combinations thereof.

The annotation module 140 includes machine readable and/or executable instruction sets for storing and retrieving user annotations and markups associated with documents. In one embodiment, for example, in response to receiving a signal indicative of a user annotation to be associated with a particular document, the annotation module 140 associates and stores the user annotation and a reference (“link”) to the particular document in a data store managed by the folder module 148. Typically, the particular document is selected from a set of second documents previously identified by the primary search module 124, the metadata research module 125, or a combination thereof. In one embodiment, for example, the link is a thirty-three (33) byte identifier of the particular document and is stored with the user annotation in a folder.

The annotation module 140 also can receive a signal associated with a markup to associate with a particular document. As used herein, the term “markup” refers to a multimedia indicator, such as a visual indicator or an audio indicator. An example visual indicator can include, but is not limited to, a highlight or reverse video of a portion of text included in a particular document. In one embodiment, for example, the annotation module 140 stores information relating to the multimedia indicator as an XML style sheet in a folder. An example audio indicator includes, but is not limited to, one or more sounds.

The annotation module 140 is also configured to provide user annotations and markups associated with documents in response to a request. In one embodiment, for example, in response to receiving a signal including a request for a particular document, the annotation module 140 transmits a signal indicative of one or more user annotations or markups associated with the particular document, as well as the particular document itself in response to the request. In one embodiment, the signal is transmitted to the GUI for display.

The annotation module 140 is configured to receive location information included in a received signal that defines a position in the particular document in which the user annotation and/or markup relates to. In one embodiment, the annotation module 140 stores the location information with the associated user annotation or markup in a folder. Upon receiving a request for a particular document associated with an annotation, the annotation module 140 provides the location information to the GUI, which in turn displays the associated user annotation and/or associated markup at a position in the particular document previously defined. In one implementation, the location information is stored by the annotation module as a comma-separated values (CSV) file in a folder.

Further, in one embodiment, the annotation module 140 associates and stores both the multimedia information and user annotation with one or more of the following: a username, a date, a client identifier and a project identifier. In yet another embodiment, the annotation module 140 manages access to user annotations and markups. For example, in one implementation, the annotation module allows a user to view, modify or delete one or more user annotations or multimedia indicators based on a username, group of users, client identifier or project identifier included in a received signal.

In yet another embodiment, the annotation module 140 is configured to identify and provide one or more annotations and markups associated with a document in response to a request. For example, in one embodiment, when a user performs an online legal search, the annotation module 140 receives a signal to search any related annotations and markups that are associated with the search result documents, and for which the user is allowed to access. The annotation module 140 identifies any associated annotations and markups associated with request and for which the user is allowed to access, and then transmits a signal indicative of the allowed associations and markups for display to the user. In one embodiment, for example, the annotation module 140 searches and identifies content of associated user annotations and transmits a signal indicative of a snippet (e.g., a small grouping of information content included in the user annotation) of the associated annotation for display to the user.

The event module 146 is configured to associate and execute an action once a particular event occurs affecting either a folder, document, user annotation, markup, or combination thereof. In one embodiment, for example, the event module 146 receives a signal indicative of an event type that is to be associated with a folder, document, user annotation or markup. The event module 146 then associates the event type with the particular item and stores the event in a data store. The event module 146 then monitors the particular item for occurrence of an event associated with the event type. Upon occurrence of the event, the event module 146 transmits a signal that includes a notification that the event occurred. In one embodiment, for example, the event is associated with at least one of an addition, modification and deletion of a user annotation, multimedia information, folder or particular document, and the notification is an e-mail notification. In another embodiment, the notification is an invitation to view the particular document and at least one of the user annotation and media information.

The contact module 142 is configured to manage and store information concerning users and groups of users. In particular, the contact module 142 provides functionality to allow for the addition and deletion of users and groups of users to the system, as well as facilitate the addition and deletion of users to one or more groups of users. Information stored by the contact module 142 is accessible to both users of the system as well as program modules of the system.

Access device 130 is generally representative of one or more access devices. In the exemplary embodiment, access device 130 takes the form of a personal computer, workstation, personal digital assistant, mobile telephone, tablet computer, such as an iPad by Apple Computer, Inc., or any other device capable of providing an effective user interface with a server or database. Specifically, access device 130 includes a processor module 131 one or more processors (or processing circuits) 131, a memory 132, a display 133, a keyboard 134, and a graphical pointer or selector 135.

Processor module 131 includes one or more processors, processing circuits, or controllers. In the exemplary embodiment, processor module 131 takes any convenient or desirable form. Coupled to processor module 131 is memory 132.

Memory 132 stores code (machine-readable or executable instructions) for an operating system 136, a browser 137, and the graphical user interface (GUI)138. In the exemplary embodiment, operating system 136 takes the form of a version of the Microsoft Windows operating system, and browser 137 takes the form of a version of Microsoft Internet Explorer. Operating system 136 and browser 137 not only receive inputs from keyboard 134 and selector 135, but also support rendering of GUI 138 on display 133. Upon rendering, GUI 138 presents data in association with one or more interactive control features (or user-interface elements). (The exemplary embodiment defines one or more portions of interface 138 using applets or other programmatic objects or structures from server 120.)

More specifically, the graphical user interface 138 defines or provides one or more display regions, such as a query or search region 1381 and a search-results region 1382, and transmits and receives signals from various modules included memory 122 of the server 120.

As shown in FIG. A1, Query region 1381 is defined in memory and upon rendering includes one or more interactive control features (elements or widgets), such as a query input region 1381A, a query submission button 1381B. Search-results region 1382 is also defined in memory and upon rendering presents a variety of types of information in response to a case law query submitted in region 1381. In the exemplary embodiment, the results region identifies one or more source case law documents (that is, one ore good cases, usually no more than five), jurisdictional information, issues information, additional key cases, key statutes, key briefs or trial documents, key analytical materials, and/or additional related materials. (See FIG. 3, which is described below, for a more specific example of a results region.) Each identified document in region 1382 is associated with one or more interactive control features, such as hyperlinks, not shown here. User selection of one or more of these control features results in retrieval and display of at least a portion of the corresponding document within a region of interface 138 (not shown in this figure.) Although FIG. 1 shows query region 1381 and results region 1382 as being simultaneously displayed, some embodiments present them at separate times.

### Exemplary Operation

FIG. A2 shows a flow chart 2000 of one or more exemplary methods of operating a system, such as system 100. Flow chart 2000 includes blocks 2010-2060, which, like other blocks in this description, are arranged and described in a serial sequence in the exemplary embodiment. However, some embodiments execute two or more blocks in parallel using multiple processors or processor-like devices or a single processor organized as two or more virtual machines or sub processors. Some embodiments also alter the process sequence or provide different functional partitions to achieve analogous results. For example, some embodiments may alter the client-server allocation of functions, such that functions shown and described on the server side are implemented in whole or in part on the client side, and vice versa. Moreover, still other embodiments implement the blocks as two or more interconnected hardware modules with related control and data signals communicated between and through the modules. Thus, the exemplary process flow (in FIG. A2 and elsewhere in this description) applies to software, hardware, and firmware implementations.

Block 2010 entails presenting a search interface to a user. In the exemplary embodiment, this entails a user directing a browser in an client access device to internet-protocol (IP) address for an online information-retrieval system, such as the Westlaw system and then logging onto the system. Successful login results in a web-based search interface, such as interface 138 in Figure Al being output from server 120, stored in memory 132, and displayed by client access device 130.

Using interface 138, the user can define or submit a case law query and cause it to be output to a server, such as server 120. In other embodiments, a query may have been defined or selected by a user to automatically execute on a scheduled or event-driven basis. In these cases, the query may already reside in memory of a server for the information-retrieval system, and thus need not be communicated to the server repeatedly. Execution then advances to block 2020.

Block 2020 entails receipt of a query. In the exemplary embodiment, the query includes a query string and/or a set of target databases (such as jurisdictional and/or subject matter restricted databases), which includes one or more of the select databases. In some embodiments, the query string includes a set of terms and/or connectors, and in other embodiment includes a natural-language string. Also, in some embodiments, the set of target databases is defined automatically or by default based on the form of the system or search interface. Also in some embodiments, the received query may include temporal restrictions defining whether to search secondary resources. In any case, execution continues at block 2030.

Block 2030 entails identifying a starter set of documents based on the received query. In the exemplary embodiment, this entails the server or components under server control or command, executing the query against the primary databases and identifying documents, such as case law documents, that satisfy the query criteria. A number of the starter set of documents, for example 2-5, based on relevance to the query are then selected as starter cases. Execution continues at block 2040.

Block 2040 entails identifying a larger set of recommended cases (documents) based on the starter set of cases. In the exemplary embodiment, this entails searching the metadata databases based on the citations in and to the starter cases, based on secondary legal documents that are associated with the starter cases, legal classes (West KeyNumber classifications) associated with the starter cases, and statutes query to obtain a set of relevant legal classes. In the exemplary embodiment, this larger set of recommended cases, which is identified using metadata research module 126, may include thousands of cases. In some embodiments, the set of recommended cases is based only on metadata associated with the set of starter cases (documents.)

Block 2050 entails ranking the recommended cases. In the exemplary embodiment, this ranking entails defining a feature vector for each of the recommended cases (documents) and using a support vector machine (or more generally a learning machine) to determine a score for each of the documents. The support vector machine may include a linear or nonlinear kernel. Exemplary features for feature vectors include:

NumObservations—how many ways to get from source to recommendation

NumSources—how many sources (starter documents) connect to recommendation

NumReasons—how many kinds of paths to recommendation

MaxQuotations—Maximum of numQuotations value in citations

TFIDFScore—Based on text similarity of text (as used by ResultsPlus (RPD))

RPWeightedScore—Based on number of RPD recommendations shared and their scores

NumSharedRPDocs—Same as RPWeightedScore, but not based on score

KNWeightedScore—Based on the number of key numbers (legal classification codes) shared and their importance

NumSharedKeyNumbers—same thing but not based on score

NumSourcesCiting—Number of sources that directly cite a recommendation

NumCitedSources—Number of sources cited by a recommendation

NumCoCitedCases—Number of cases with co-citation between a source and a recommendation

NumCoCitedByCases—Number of cases with bibliographic coupling between source and recommended documents

NumSharedStatutes—Number of statutes in common

SimpleKeyciteCiteCount—Raw Number of times recommended case was cited by any case

Some embodiments use all these features, whereas others use various subsets of the features. Execution proceeds to block 2060.

Block 2060 entails presenting search results. In the exemplary embodiment, this entails displaying a listing of one or more of the top ranked recommended case law documents in results region, such as region 1382 in FIG. A1. In some embodiments, the results may also include one or more non-case law documents that share a metadata relationship with the top-ranked recommended case law documents; legal classification identifiers may also be presented. FIG. A3 shows a detailed example of this type of results presentation. Other embodiments may present a more limited result set including identifiers for the top ranked documents and a set of legal classification codes.

### Exemplary Graphical User Interfaces

FIGS. 1-31 show exemplary graphical user interfaces which may be included or substituted for one or more portions of interface 138 in system 100 (in FIG. A1). In addition to the aesthetics of the interfaces, they each provide user controls and other functionality as described below.

Login/Logoff:

FIG. 1 shows an exemplary login on interface, which includes user name and password fields. The user types in a user name into the user name field and a password (string of numbers and/or letters) that is associated with that user name. The “Sign-On” button is clicked to continue. On any screen in the exemplary embodiment, the user can click on a Sign Off button at the top right to return to the login screen.

Search Box and Pre-Search Filters

FIG. 2 shows an exemplary search interface which includes a single query input field and pre-search filters for limiting the view of search results based on document type, jurisdiction, and/or date. The user navigates this interface by pressing the TAB key or clicking on the search field or pre-search filters to enter an input. When the user completes entering all the inputs he/she desires, the user clicks on the arrow to submit the query and invoke display of the search results. The single query input box allows users to type any query (i.e. search terms, case citation, party name, etc.) without the need to select a database; the system responds by automatically directing the query to the appropriate databases.

In the exemplary embodiment, the pre-search filter type-in boxes include predictive text functionality that give users the freedom to enter what they already know they are looking for (i.e. a particular jurisdiction) rather than forcing them to search through a long list of databases. Predictive text supports users entering their chosen jurisdictions, documents types, and date. In addition, predictive text in pre-search filter entry, and potentially in search term entry, augments and expands the powerful new search paradigm. In the exemplary embodiment, predictive text functionality takes advantage of user preference or usage habits that are stored in subscriber database 123 of system 100.

Additionally, in the exemplary embodiment the query input field automatically detects when the input text reaches the end of the input box and automatically expands the size of the box by, for example, adding an additional text input line or portion thereof, thus providing a complete view of the input query at all times during entry.

Search Result Interface

Another embodiment of the present invention includes a “Search Results” feature that includes three different modes to view and interact with the search results. The three views support users in finding the document(s) they seek, as well as seeing their query results within the broader context of additional document types and conceptually relevant information. Additional embodiments of the present invention could contain identical content in different presentations or a unique result set related to the user's query.

A number of features support users as they conduct tasks on the “Results Summary” page: a categorized summary of search results gives users quick access to the most relevant documents and provides more detailed information on hover; progressively disclosed, detailed information in-line puts important details at the user's fingertips while avoiding information overload; the Encyclopedia Article Summary provides easy answers to legal questions and gives users quick access to more information without obscuring primary law; easy navigation between three views of a single query result categorized documents, a results list, and encyclopedia-like articles with quick answers; and global search box enables users to search from any point in their workflow.

FIG. 3 shows an exemplary “Results Summary” page. The information on this page is presented in sections of related categories such as leading cases, key statutes, secondary sources, encyclopedia, etc, similar to the interface shown in FIG A3. Utilized on any page, the user can place and hold the mouse pointer over hyperlink for a predetermined amount of time (e.g. three seconds) to view a callout window with the holding, jurisdiction, and date of the case. In addition, the scroll bar is used to move up and down the page to see all of the Results Summary content. The user can also click on the Encyclopedia button to view the Encyclopedia screen or click on the Results List button to view the Results List screen.

FIGS. 4-6 show exemplary interfaces which allow the user to quickly and effectively determine how relevant a document is for a legal issue through content summaries. The summaries are accessible from a result list, KeyCite Citing References, citations within a document or at the top of documents.

FIGS. 7-8 illustrate interfaces in which information is provided to the user with the most relevant documents for their query, regardless of document type. This embodiment of the present invention provides a one-stop shop for related information for all documents on Westlaw (no need to check multiple sources separately). In addition, a feature “What Other Users Researched” identifies and brings highly related information to the top of the list by combining and analyzing what others researched, KeyCite, ResultsPlus, and the Key Number System.

The “Results List” tab provides users with powerful tools to expand and limit their results list in real time. Users can activate any of four different filter categories—document type, jurisdiction, date, and area of the law—to refine the revealed set of results. The filters collapse into a dashboard state with summary information about the activated items allowing the user to maintain awareness of the selected options without having the filter information compete for attention with the results. A number of features support users as they navigate the “Results List” page: real-time filtering allows users to drill down quickly into a set of results without needing to run a second search; real-time search results filtering also allows users to expand a set of results that they had previously narrowed, giving them easy access to documents they otherwise might have missed; numbers in the filters actively reflect the results set, giving users an understanding of the distribution of results by category; more precise representation of KeyCite flags Criticized,

Weakened, Bad Law improves understanding of validity information; navigate easily between three views of a single query result categorized documents, a results list, and encyclopedia-like articles with quick answers; global search box enables users to search from any point in their workflow; simple drag and drop functionality allows users quickly to save and organize documents in personalized collections without interrupting their “find” workflow; and additional filters related to case metadata such as citation frequency, criminal or civil, published or unpublished, and judge.

FIG. 9 shows an exemplary Results List interface that is displayed in response to a user selecting the “Results List” page button. As shown, a left pane of this interface includes various filters such as document type, jurisdiction, date, and area of law. In this view, the document type filter is open with cases selected (checked), reflecting pre-query filtering by cases. The user clicks on the checkboxes to add and remove filters and thus changing the result list accordingly. The user can close the document type filter options by clicking on the box immediately to the left of the document type label in the left pane. A case name is hyperlinked so that a user may click the link to go to the Document View screen. The scroll bar is used to move up and down the page to see all of the Results List content.

FIG. 10 shows an interface which includes filtering tools to target the documents most relevant to the research—by judge, specific court, etc. Other embodiments of the present invention include grouping search results by legal topic or citation patterns which isolates the documents most relevant to the legal issues, allowing the user to customize the search results, and providing new ways to view relationships between documents and particular legal issues. Additionally, the Figure shows that the user can filter results to include or exclude content based on whether it is within or without their subscription plan.

FIG. 11 illustrates an interface of an “Encyclopedia” page that provides encyclopedia-like, easy answers to legal questions that could save hours of pouring over primary law and secondary sources. The entries provide concise answers to simple questions, with links to related resources, contextualized primary law, and additional encyclopedia entries within its content hierarchy.

Document View Interface

The exemplary embodiment includes a document view interface for cases which prominently display a validity flag, which offers more detailed validity information in-line, and which highlights bad or invalid law in a way that gives users the information they need to determine the validity of a case. Editorial content, such as headnotes, is separate from court language, making both the case and headnotes easier to read and giving the case the feel of a legal document. Overruled language within a case is indicated with red brackets and a red flag, making it easier to determine which parts of the case are bad law (and which parts are still good law.) Iconic, graphical representations of citing references give an at-a-glance understanding of a document's history and validity. KeyCite information for Headnotes is leveraged to show which Headnotes are most frequently cited. Key

Numbers for Headnotes are displayed in the condensed Reporter format and reveal more details in a callout window. Citation by Jurisdiction and Date (i.e., the map view) overlays the number of citations over a jurisdictional area, allowing users to see where and when cases are frequently cited. The user can also select and drag text clippings from the document into My Collections to save for later viewing. Prominent display of validity flag information with descriptive text and quick access to more detailed information in-line puts important details at the user's fingertips while avoiding information overload. Callout window provides easy answers to the question of validity, enabling the user to determine if the law they are interested in within the case is still valid. In addition, a feature allows users to highlight and annotate documents in-line.

FIG. 12 illustrates an interface in which a user views the validity flag indicator and colored brackets, for example, overruled text in red brackets with red flags for discussion of highlighting bad law within a document. The user can access the Citations Graphical icon, fourth from the left, or Direct History Graphical icon, third from the left, to see the full display. The user clicks on the validity flag indicator to view more information in a callout window and may further click on the case citation to open the document view of the case. To close the callout window, click on the (X) close button.

FIG. 13 shows another interface of an embodiment of the present invention. The user selects lines of text that do not include links from anywhere in the document, clicks on the selected text and drags the clipping to My Collections. Click on the case link in the breadcrumb trail to return to that case's document view or click on Search Results link in the breadcrumb trail to go to the Results List screen.

Currently Yellow Flags are split into two categories—those that weaken the current law in the jurisdiction and those that merely criticize it. FIGS. 14-16 illustrate various interfaces that notify the user, through the use of KeyCite flags, where the weakness or overruled points of law are located within the case. The valid holdings from cases that are only partially invalidated are clearly identified.

Graphical View Interfaces

Leveraging current Westlaw functionality, a case's Direct Graphical History is presented in icon-form, allowing users quickly to get a sense of the case's history without opening the full view. Icon view of current Westlaw Direct Graphical History indicates the existence of case history, replacing and extending the functionality of blue KeyCite H's. A new graphical representation of citations provides a quick sense of validity at a glance by showing the distribution of citing references by number, depth of treatment, nature of treatment, and jurisdiction. Progressively disclosed, detailed information allows users to choose when they want to see more information, thereby avoiding information overload. Four simple categories describe the nature of treatment for citing references positive, criticized, weakened, bad law—while court language descriptions (e.g. “abrogated by”) are reserved for use in the callout window. By simplifying the initial presentation of information, the system appears more accurate and factual. Icon view of Citations Graphical indicates at quick glance the existence of case citations, replacing and extending the functionality of green KeyCite C's.

FIGS. 17-18 illustrate interfaces in which the user can visualize a case's history or citation graphically. A user can click on the Direct History Graphical icon to open the full view or click on the Citations Graphical icon to close the Direct

History Graphical full view and open the Citations Graphical full view. In the discussed, positive treatment region or cell, click on the numbered link, for example 3, to view detailed information on the three citing cases in a callout window. In the discussed, bad law treatment region or cell, click on the numbered link, for example 2, to view detailed information on the two citing cases in a callout window. To close the pull-down and callout windows, click on the (X) close button. Additionally, the “select jurisdiction” feature allows one to filter the results displayed in the view to specific jurisdictions of interest. In some embodiments, this filter can be a negative filter, allowing the user to select one or more jurisdictions to omit from the displayed results.

My Collections Interfaces

One or more of the exemplary interfaces include a My Collections area, which lets users collect, organize, and annotate materials from Westlaw via a drag-and-drop mechanism. In addition to storing documents, users may also perform Share actions such as printing, emailing, and downloading on items they have gathered. The Collections area synthesizes a lot of information into manageable chunks and allows users to work quite closely with others. Other embodiments of the present invention include fleshing out the collections concept in order to implement document management best practices for activities such as moving items between collections, searching within collections, creating new collections and, possibly, nested collections. Another embodiment of the present invention includes collecting throughout the application and allows users to add materials from outside the information retrieval system to the Collections.

A ubiquitous collections module allows users to save and organize documents and text clippings from anywhere in Westlaw. Simple drag and drop functionality allows the user to quickly save and organize documents in personalized collections. Select and drag text clippings from the document into collections to save for later viewing and assist in argument drafting. Inline note-taking on saved documents helps users manage their collections and eases the transition between “find,” “store,” and “draft” user states. Original search information is stored with (logically associated with) saved documents allowing users to retrace their research path and determine whether they should re-run their search to view newly added documents. Document recommendations based on the items in the collections help provide interesting materials that might otherwise have been missed. Additionally, some embodiments include alert functionality keyed to content within their collections. Thus, for example, if a new case issues that negatively treats a case or portion thereof stored in a user collection, the item in the user collection is flagged with an appropriate warning, for example, a KeyCite red or yellow flag. Additionally, the my collections access point may be generally flagged to alert the user that some portion of the collections content has been flagged.

FIG. 19 shows an interface in which a user can create and share comments. The user clicks inside any notes box, and types freely. In this example, on the ADA: Hearing Impairment collected document, move the mouse pointer over the yellow metadata drag area which turns blue to indicate that it can be repositioned. Then click on the drag area and drag the document to the top of the list above Bates v. UPS. The top two documents slide down and the ADA: Hearing Impairment document appears at the top of the list. Clicking on the up arrow at the bottom right closes the My Collections window.

FIG. 20 shows an interface where a user can highlight and make notes on documents and save them in association with his subscriber information for subsequent access. These notes are easily viewed or printed. The user can print documents with comments and highlighting turned on or off. Comments and annotations can be made private to the user, private to the firm, or public to all Westlaw users. This interface of an embodiment of the present invention is a quick and easy way to share thoughts, perspectives, and experience with others and to gain insight from others who have read and analyzed various documents.

Simple drag and drop functionality allows users to save and organize documents quickly in personalized collections without interrupting their “find” workflow. Collected documents have a different appearance so users know which documents they have already saved, even in subsequent searches. Users can create multiple collections, making organization of important documents easier. Integrating document management into Westlaw gives users a single place for conducting legal research, providing a smooth transition between the “find,” “store” and “draft” user states.

FIG. 21 shows an interface which allows the user to locate the case he/she wants to place into My Collections. The user moves the mouse pointer over the yellow metadata drag area which turns blue to indicate that it can be dragged to collections. The user then clicks on the drag area to open the My Collection widget and drags the document to the user-selected collection. The number of documents in the collection increase by 1, the dragged result remains blue to indicate that it has been saved, and the My Collections widget closes. The user can click on the My Collections title bar to open the My Collections widget. Furthermore, the user can click on the user-selected collection to open the full view of My Collections.

FIG. 22 illustrates interfaces of folders that allow users to organize research based on legal issue, client matter or other topic. Folders allow users to save (indefinitely) documents, parts of documents, search results, and KeyCite results. Folders can be used as a shopping cart for printing and downloading—just drag the items into a folder and then print the research at the end of the session. Folders can be updated based on new legal information that has arisen since the newest item in the folder. Folders can be shared and emailed to colleagues or archived on the user's computer. In some embodiments, folders are organized underneath the user's collection. Notably, the exemplary embodiment also enables uses to select one or more folders using for example a check box and direct specific searches to these folders. Generally, items that included in folders or mycollection are also flagged within search results that stem from searches initiated within the legal research interface.

Additional Features, Services, and Displays

FIGS. 23-24 illustrate a reading mode interface where the user can view a selected document in reading mode display. This view shows a clean copy of the full text document, without editorial enhancements or hyperlinks. The screen is optimized for reading online with the feel and navigation of a book, and the font size and typeface are customizable user preferences. Left and right sidebars can be touched or clicked on to respectively to “turn” pages backwards or forwards.

FIG. 25 shows an interface where information about the document is shown in a panel. The background and holding of a case are displayed in a panel on the left side of the screen instead of at the top of a case. In addition, the case topics fit in the Key Number System in a panel on the left side of the screen along with the information associated with the Headnotes.

FIG. 26 shows an exemplary system homepage that has the ability to be customizable by the user. This homepage is a centralized location to start legal research after login. The customization is achieved using simple selection and drag-n-drop tools. A user can add databases from any jurisdiction or topic, clips and current awareness feeds or delete anything from the page by clicking a simple X in the corner of the item. In addition, modules are available that show what the user has recently researched.

FIG. 27 illustrates an interface with statistics about the party type and the outcome. By identifying party types in cases and verdicts and settlements databases and showing which type is favored in certain types of actions, researchers obtain new information pertaining to the likelihood of prevailing in a certain type of matter. Information is shown by jurisdiction, court, and judge for the purposes of judge or forum selection.

FIG. 28 shows an interface that utilizes an improved search algorithm. Key numbers, citation patterns, and what other customers found helpful assist the algorithm in determining highly relevant documents without needing to know what keywords to use.

Instead of running multiple searches or analyzing a trail of citations to find the most important documents regarding legal issue, the improved results provide the user with the most relevant documents at the start of the legal research. The interface shows an overview of search results showing the best documents in each category (cases, statutes, regulations (regs), etc.).

FIGS. 29-30 display interfaces in which the user is notified of other research that may be interest. The exemplary system records which documents the user has found to be of interest, based on activities such as viewing, printing, downloading, emailing, saving in their collections area, or annotating, and in response suggests relevant law based on this observed research activity.

FIG. 31 shows an interface in which a pop-up window appears allowing the user to seek online help. Live chat service allows the user to multitask better—for instance, if an associate comes into the user's office or the user gets a phone call during the live chat session with a Westlaw representative, the user can easily accommodate that. The user receives an e-mail of the live help chat session, so the advice is easily accessible for the user in the future. In addition, billing is suspended during a live chat session but not necessarily during a telephone session. Some embodiments include a click-to-call function that enables the user to enter a telephone number and receive a call from a research or technical assistant. Some variants of this embodiment bill the user account for use of this service.

FIG. 32 shows an exemplary home page interface for use with the system. In one exemplary embodiment, as shown in FIG. 32, the home page includes a global search box for receiving text that is available on all interfaces. The home page is customizable to a user's preferences and interests and includes content that is browsable by category. Any updates that affect recent research are also displayed on a recent research area of the home page interface.

FIG. 33 shows an exemplary interface that allows a user to identify any page in the system as a favorite page. As shown in the FIG. 33 example, “California Cases”, “California Statutes Annotated”, “9^{th} Circuit Cases”, “Berkley Law Journal”, “New York times”, “All Federal Case Law”, and “Federal Statutes (USCA)” have all been identified as favorites. Once a page is identified as a favorite, an option to select the favorite page is displayed on the home page.

FIG. 34 shows an exemplary interface that allows a user to create multiple pages designed for different types of research. As shown in the FIG. 34 example and accessible under the “My Pages” option menu, pages have been created relate to bankruptcy research, tracking clients, nanotechnology and biotechnology.

FIG. 35 shows an exemplary interface that can be used to navigate in the system. The search box can be used for searching citations, party's by name, famous cases, statutes, and regulations, site navigation and commands The search box is preferably configured to expand automatically when a user has entered text exceeding a threshold value. For example, in one embodiment, the search box is configured to expand automatically when text entered in the box extends toward an end of the box.

FIG. 36 shows an exemplary interface that, once a search of documents is performed by the server, displays an overview of the most relevant documents retrieved. For example, as shown in FIG. 36, the top four (4) results of three hundred and two (302) results for “What is plaintiff's burden of proof in a title VII claim” are shown. Further, as shown in FIG. 36, the interface also allows the user to navigate to the full result set for each category, as indicated by the “See All 102 cases”, “See All 9 Statutes” and “See All 21 Secondary Sources” hyperlinks.

FIG. 37 shows an exemplary interface that provides several user options for sorting, grouping, and filtering of retrieved content , as indicated on the left side of the interface. In one embodiment, the exemplary interface also provides information regarding related documents that can be of value to the user. For example, as shown in FIG. 37, the right side of the interface displays the most relevant non-case material.

FIG. 38 shows an exemplary interface that is provided to receive and send queries for searching content sources independently of other content sources.

FIG. 39 shows an exemplary interface showing search results of a Boolean search. In the example shown in FIG. 39, the Boolean search included the terms ‘burden/s proof/4 “Title 7”’. The interface displays only those cases that match those search terms, and displays a number of cases that are relevant but do not meet the search criteria. In the example shown in FIG. 39, the interface displays a message that thirty (30) additional cases have been identified. Optionally, the user can select a hyperlink to view the related cases or add the related cases to the Boolean search results.

FIG. 40 shows an exemplary interface showing search results in which items of the search result list are stored in a user folder. In one embodiment, as shown in FIG. 40, a folder icon is provided in the search results indicating that an item in the search results is stored in a folder. In one embodiment, the item is associated with the same project description used in the search. In another embodiment, the item is associated with a same client identifier.

FIG. 41 shows an exemplary interface showing items returned from searches that have been viewed previously for the same project description or client identifier. As shown in FIG. 41, in one embodiment, for example, the interface displays a glasses icon adjacent a search item viewed by the

FIG. 42 shows an exemplary interface for displaying related documents to a search. As shown in FIG. 42, in one embodiment, the interface provides a topics listing, which combines headnotes and Key Numbers at a higher level and then displays related content in these areas, even if the related content does not cite the document or is not in the same end node of the key number system. In addition, as shown in FIG. 42, the interface displays the number of relevant documents identified for each topic.

FIG. 43 shows an exemplary interface for displaying all legal content (e.g., cases, statutes, regulations, etc.) identified for a user by topic, and provides the user with sorting, grouping, and filtering functionality options for both content stored in a folder as well as content viewed previously.

FIG. 44 shows an exemplary interface for a KeyCite reference. As shown in FIG. 44, in one embodiment, user options for sorting, grouping, and filtering KeyCite references are provided on the left side of the page. In one embodiment, for example, KeyCite data, such as case title, jurisdiction, date, depth, depth of treatment, treatment, number of headnotes, document type, and flag indicators are displayed in a table of the interface that can be sorted by a variety of attributes, as well as downloaded into a CSV/XLS spreadsheet. Further, as shown in FIG. 44, in one embodiment, the interface displays a message of additional related content not cited to the case, and displays a date histogram illustrating spikes of activity in the history of these areas of law.

FIG. 45 shows an exemplary interface for providing a user with control over references identified as being relevant to a search, KeyCite or Topic. In one embodiment, for example, the interface displays attributes of relevance (e.g., date, number of words, customer usage, citation information, and hierarchical information) and allows the user to select what attributes are to be considered most relevant. As shown in the FIG. 45 exemplary interface, in one embodiment, references and attributes are displayed graphically in the interface.

FIG. 46 shows an exemplary interface for displaying a KeyCite display with letter tabs and inline motion information to streamline the display and provide ease in interpretation. Further, as shown in FIG. 46, in one embodiment, the interface includes toggle buttons to select displaying an entire history, previous history or subsequent history of a particular case.

FIG. 47 shows an exemplary interface for copying bluebook citations. As shown in FIG. 47, when a user selects text in a particular document, the interface displays a menu automatically when the selection is complete. In one embodiment, options in the menu include copying with bluebook citation, sending the document to a particular folder or research cart for pricing, adding a note to the document that references the selected text, or highlighting the text so that it is highlighted when the document is viewed again. Optionally, the interface allows a user to turn highlighting on or off for printing or displaying the document.

FIG. 48 illustrates an exemplary interface for allowing a user to set permissions on user annotations. As shown in the FIG. 48 example, in one embodiment, the interface permissions to annotations are set by the user and can include only allowing the user to view the annotation, allowing a group associated with user to view the user annotation, allow an entity, such as a firm associated with the user to view the user annotation, as well as allowing all users of the system to view the user annotation.

Referring now to FIGS. 49 and 50, an exemplary interface is illustrated for allowing a user to alternate between varying reading modes. As shown in FIG. 48, in one embodiment, the exemplary interface includes a hyperlink that, once selected, allows a document currently being viewed in a display area of a first viewer, to be displayed in a display area of a second viewer. As shown in FIG. 49, in one embodiment, the display area of the second viewer displays the document as in a book form. Further, the display area of the second viewer is optimized for reading as well as adding, modifying, and deleting user annotations and markups.

FIGS. 51 and 52 illustrate an exemplary interface that includes a menu option for a user to access previous research. For example, as shown in FIG. 52, in one embodiment, upon a user selecting a “My Research” menu option on the interface, a history of past documents accessed by the user are displayed in the interface. As shown in the FIG. 52 example, in one embodiment, one or more filters are also provided that allow a user to view and access past research by date or date ranges. Further, as shown in FIG. 52, access to content stored in folders is also provided through the interface.

Turning now to FIG. 53, in one embodiment, an exemplary interface is shown that allows a user to drag-n-drop or click-n-store whole documents or selected portions of text into folders. The exemplary interface allows a user to name one or more folders, add or delete folders, as well as create sub-folders. As shown in the FIG. 53 example, folder content is displayed in a tabular format, which can be sorted by column The interface allows users to search all folders or selected folders, and provides sorting, grouping, and filtering capabilities for folders.

Referring now to FIGS. 54, 55 and 56, exemplary interfaces are shown that include a research cart function. As shown in the FIG. 55 example, for example, single documents, selected documents, as well as snippets of text can be sent or dragged to the cart. As items are stored in the research cart, the interface transmits a query to the server to find related content. Any related content identified is then displayed to the user through one or more interfaces. As shown in the FIG. 56 example, in one embodiment, one interface allows individual content sets to be browsed and searched. In addition, the interface is configured to display at least one of the most popular and most cited materials by date (e.g., see right side of the interface),and material in the news. Advantageously, the interface also provides sorting, grouping, and filtering capabilities of matter displayed.

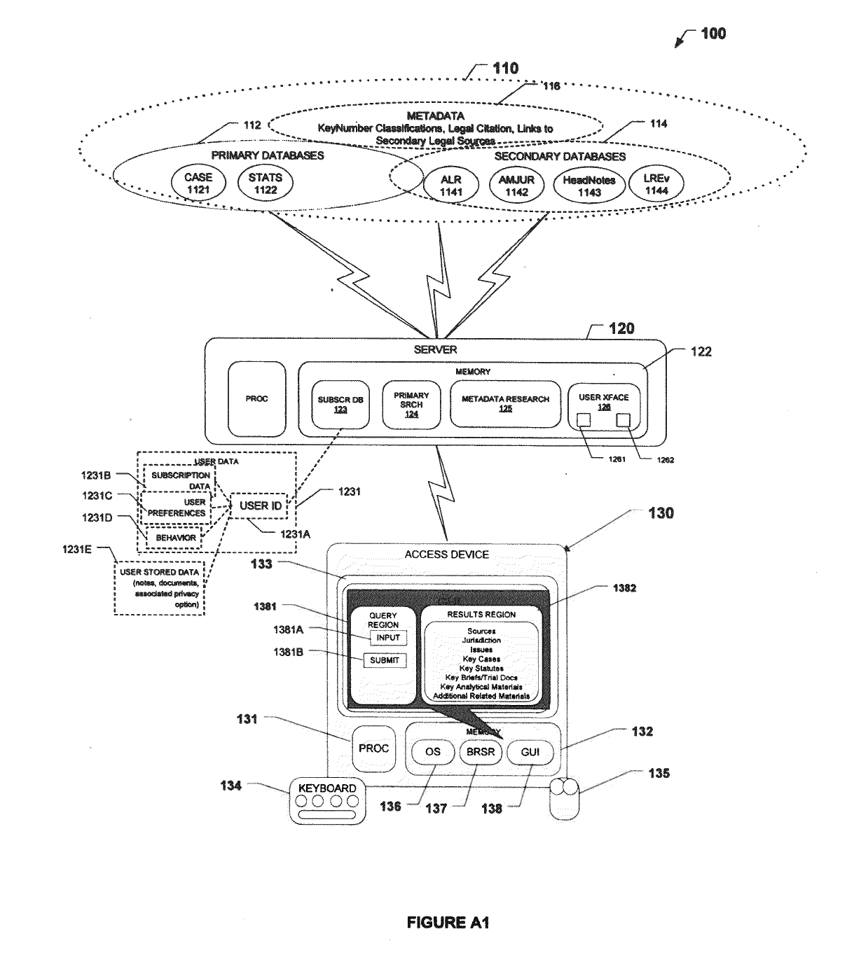

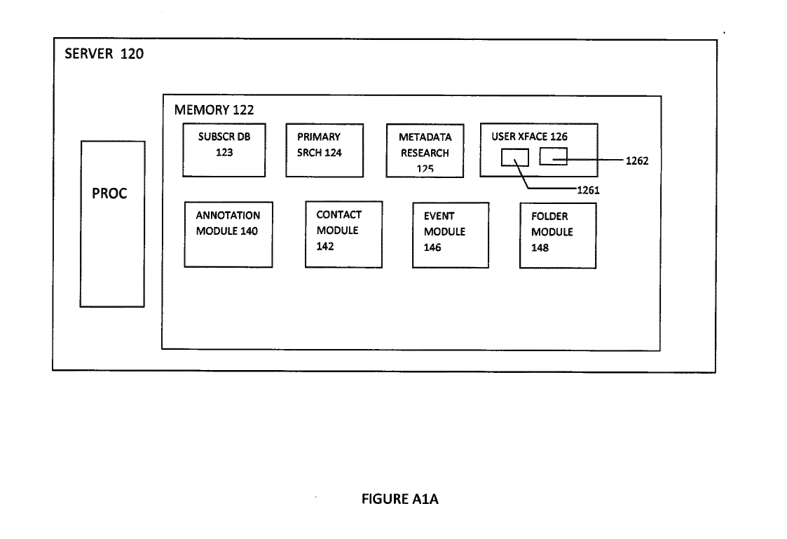

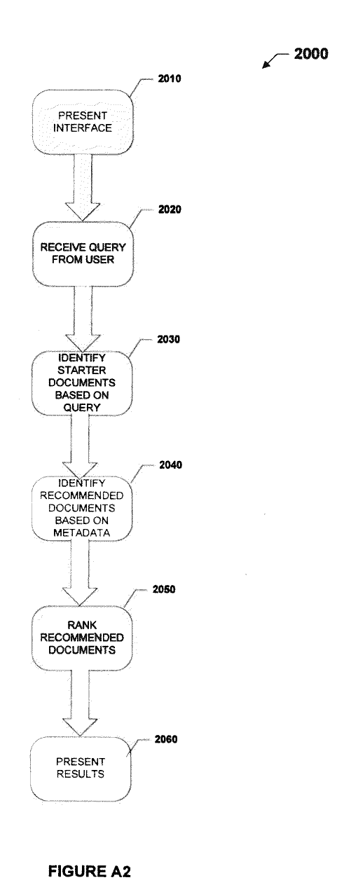

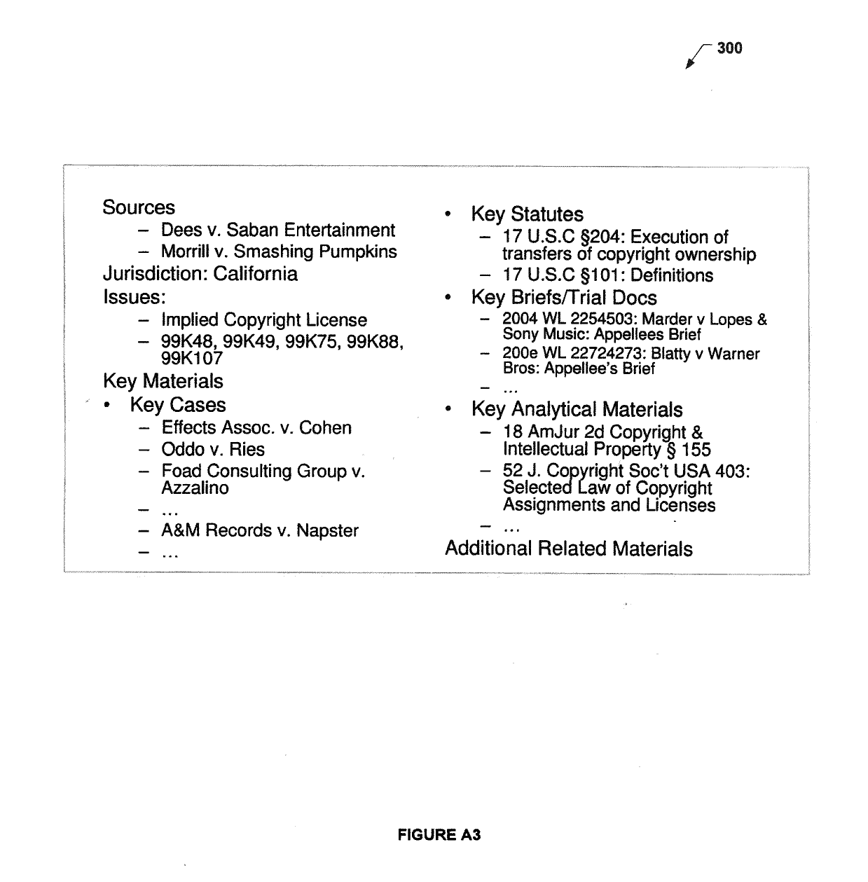

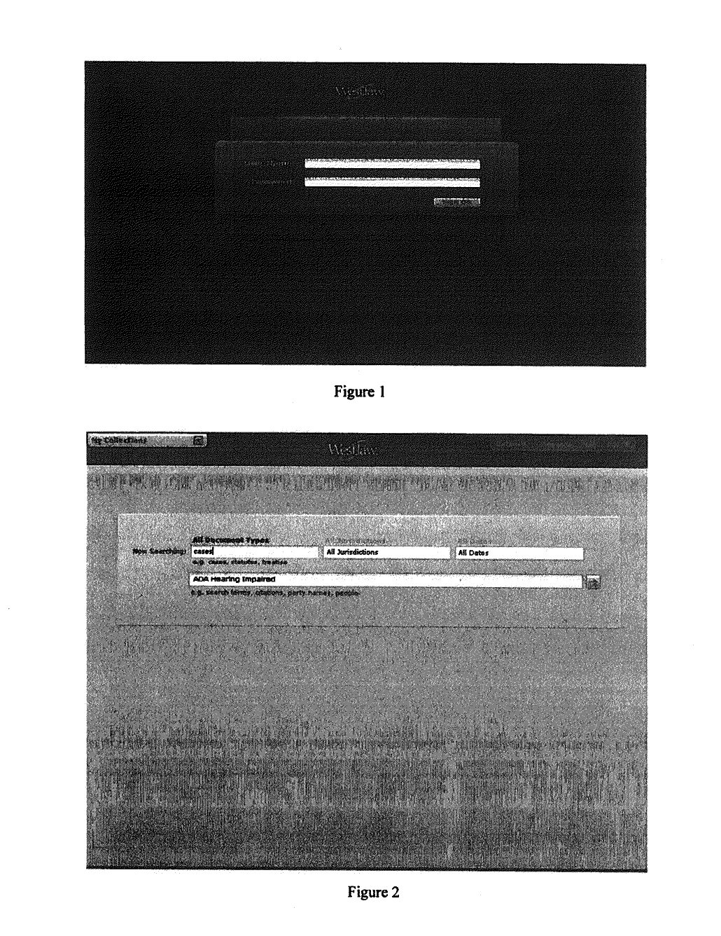

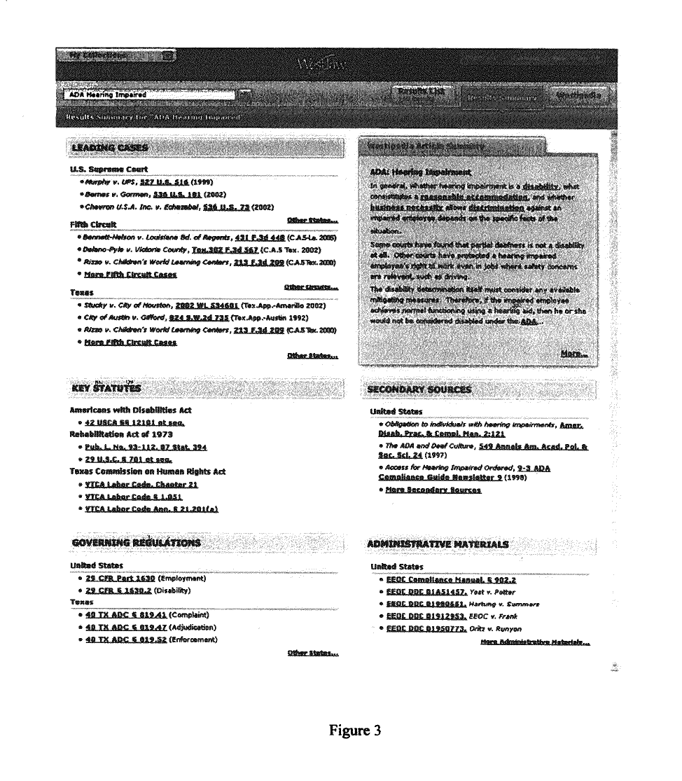

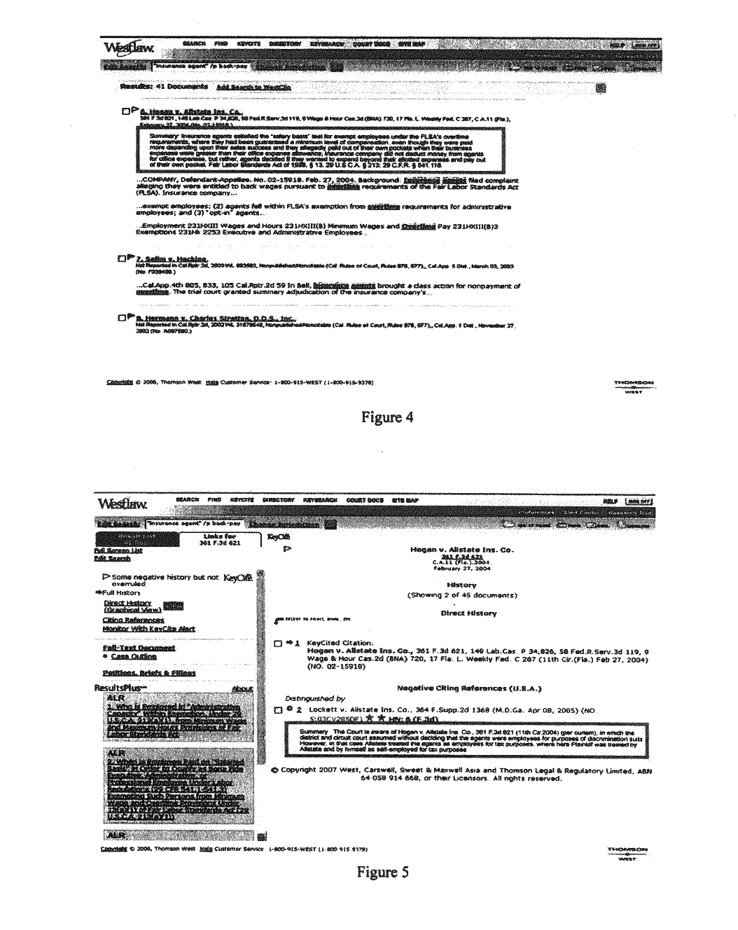

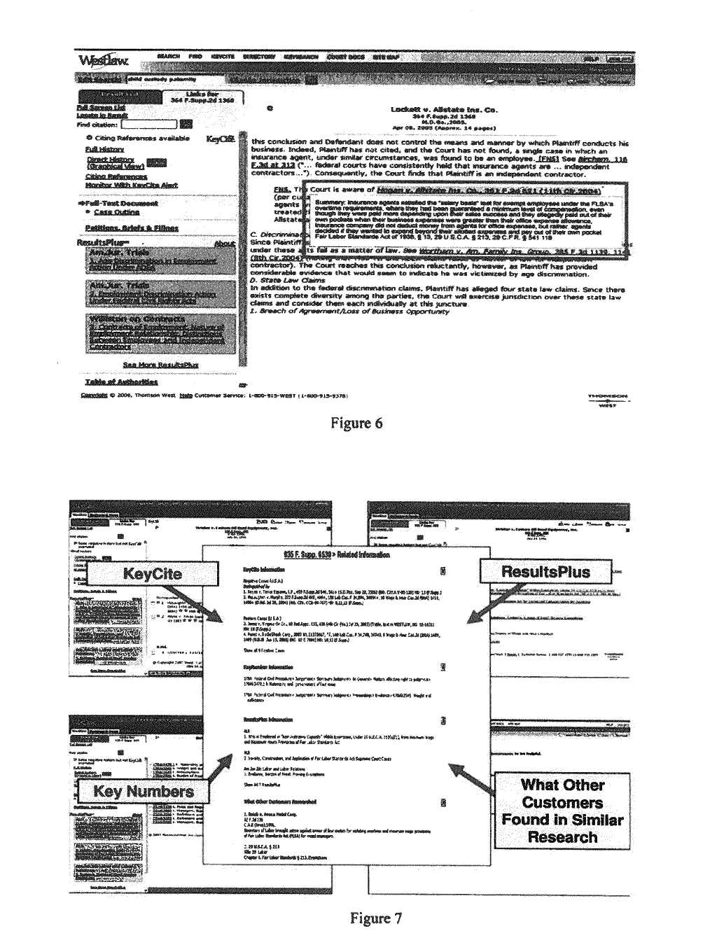

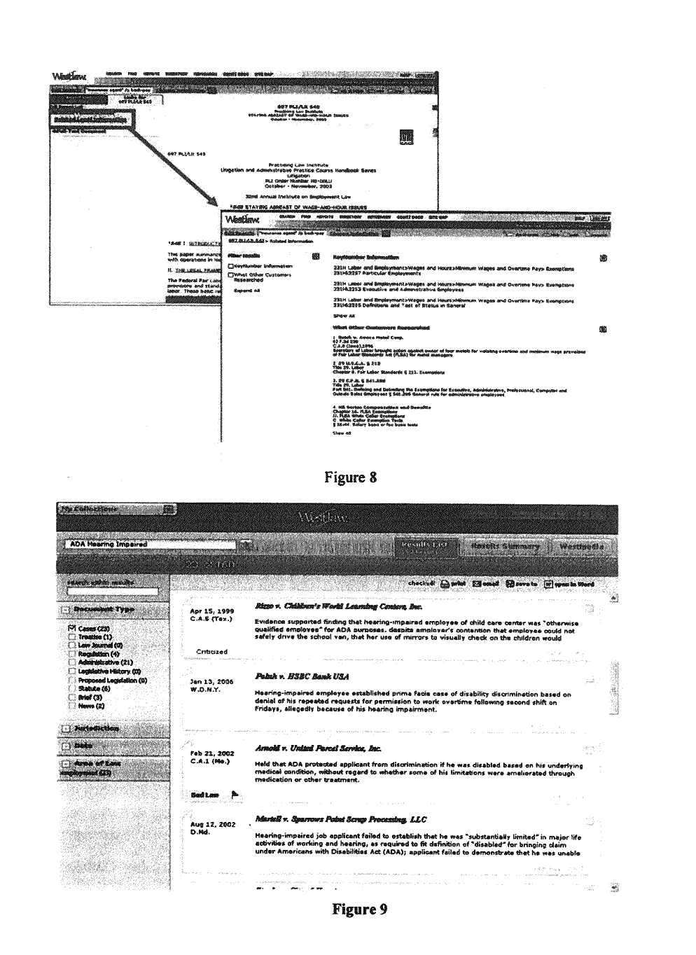

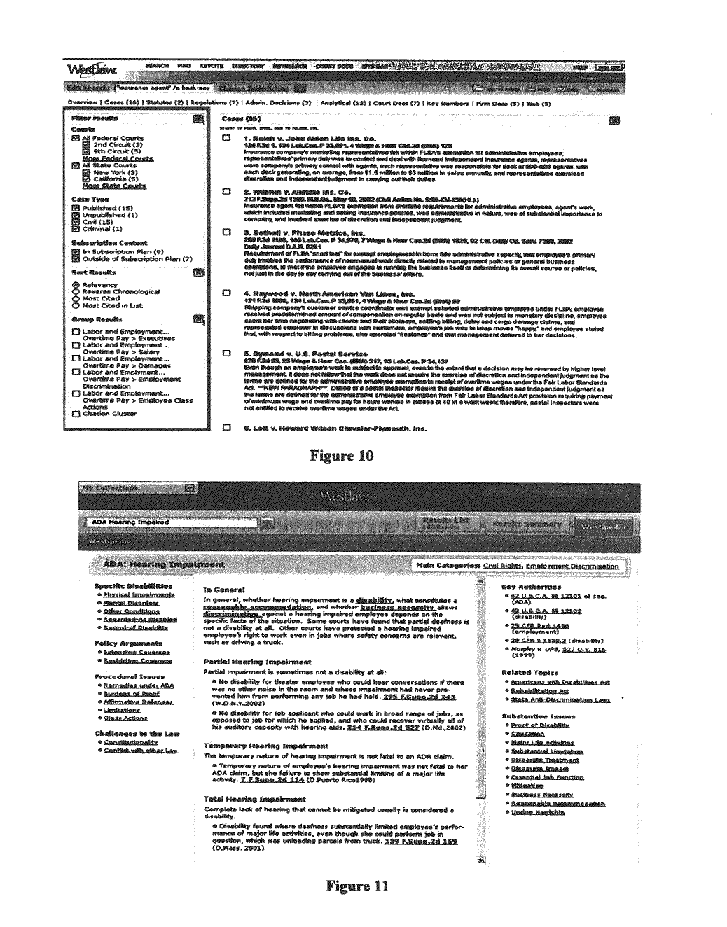

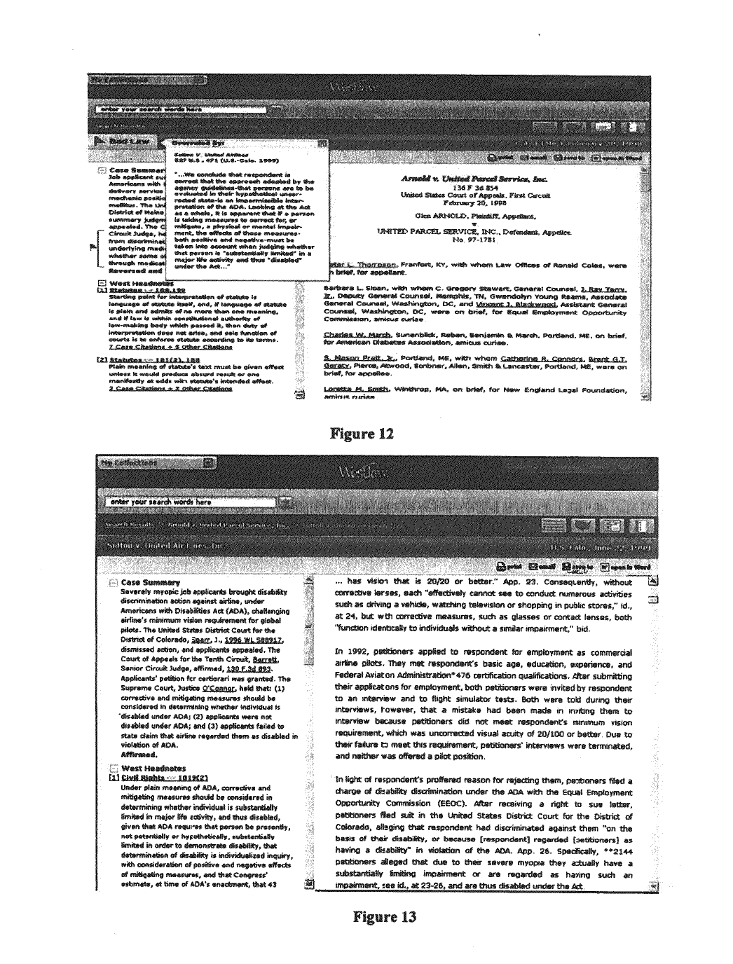

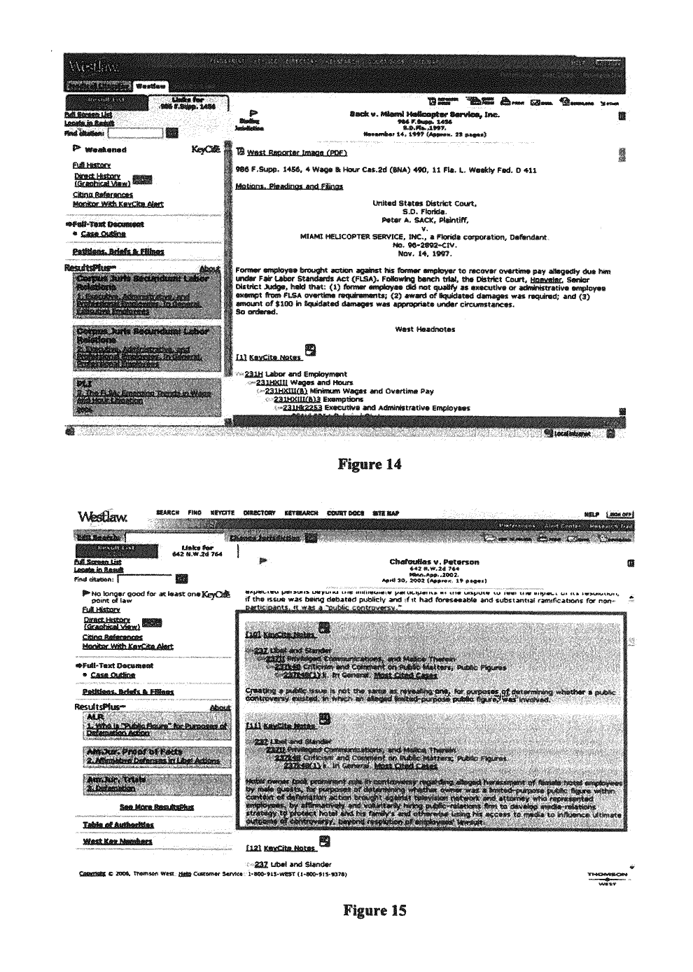

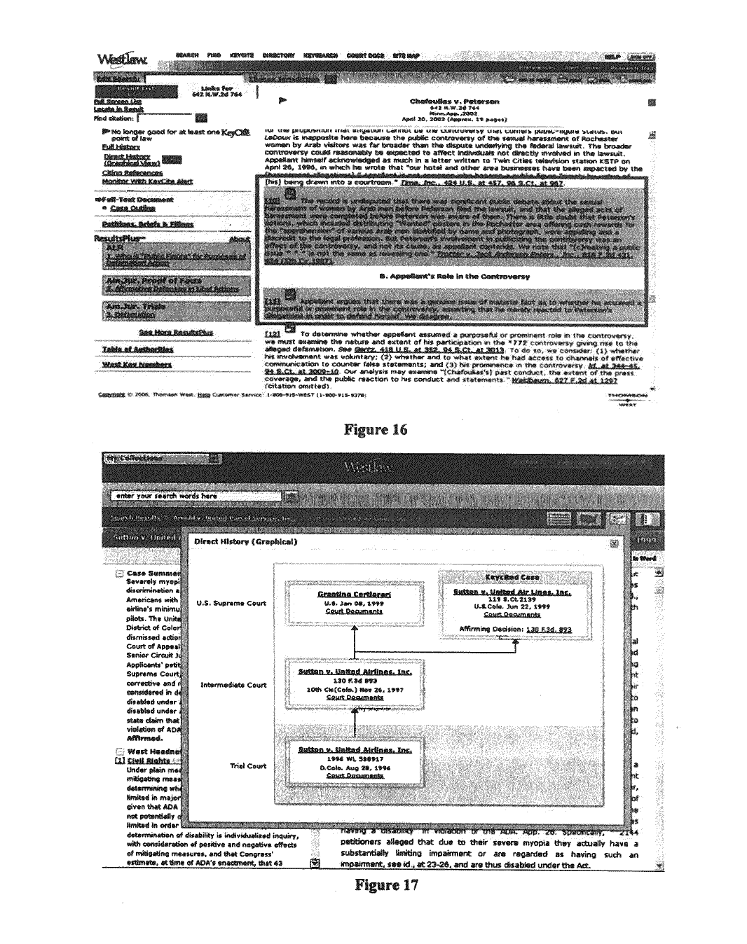

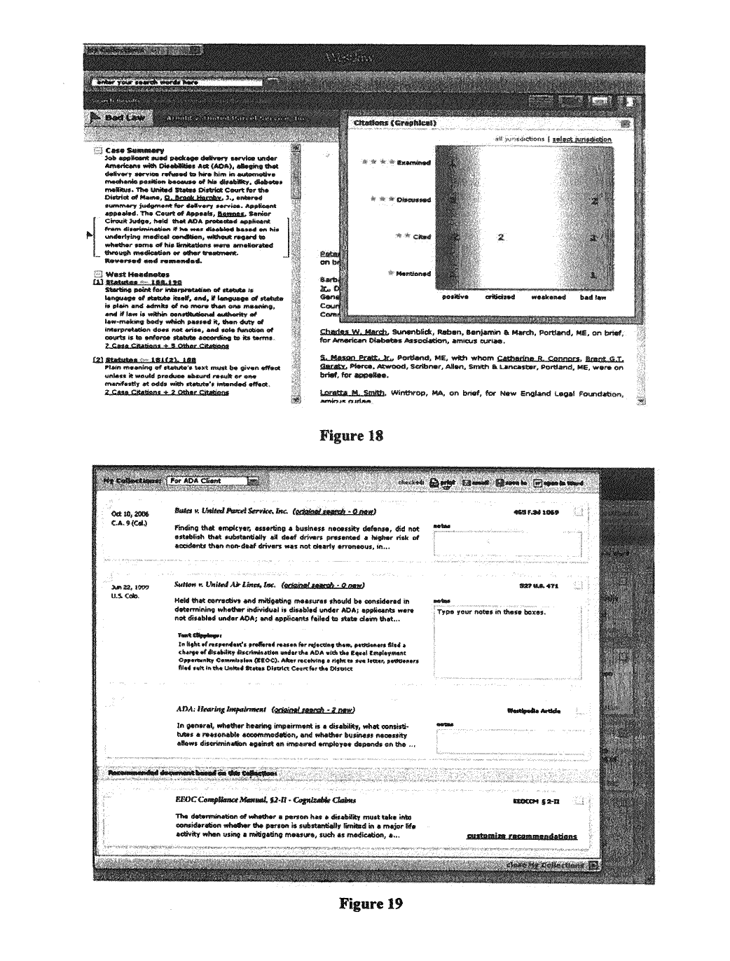

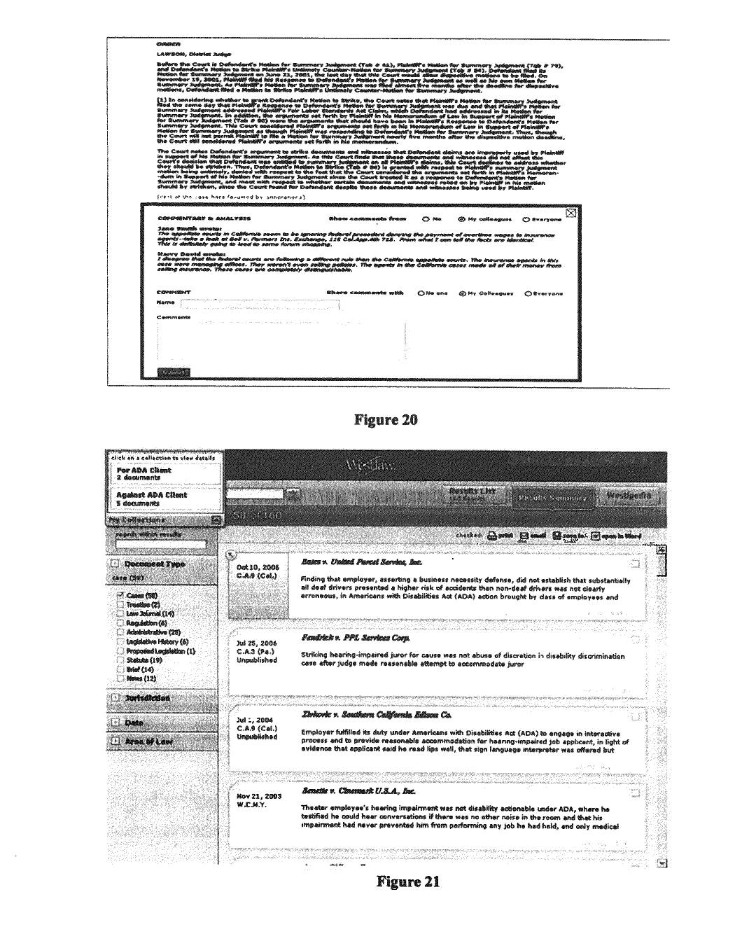

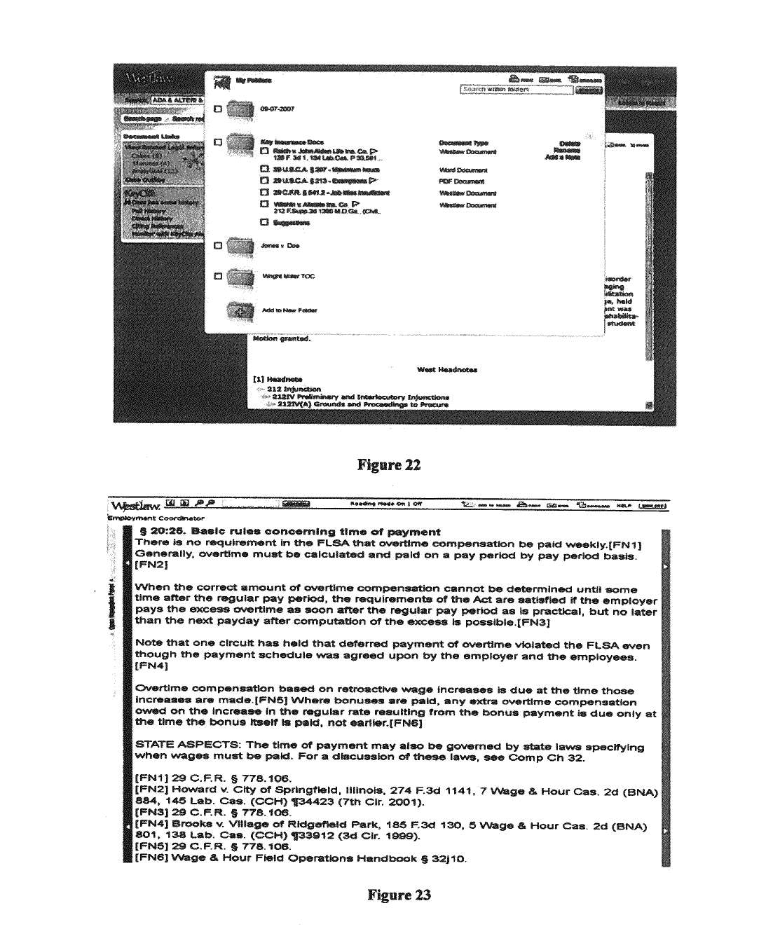

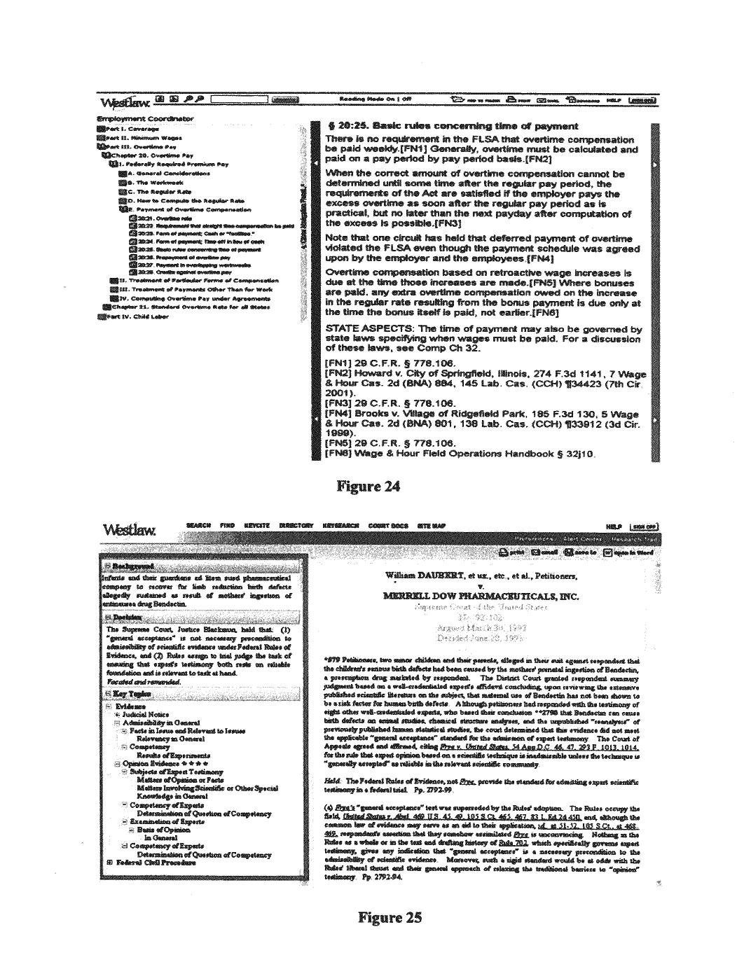

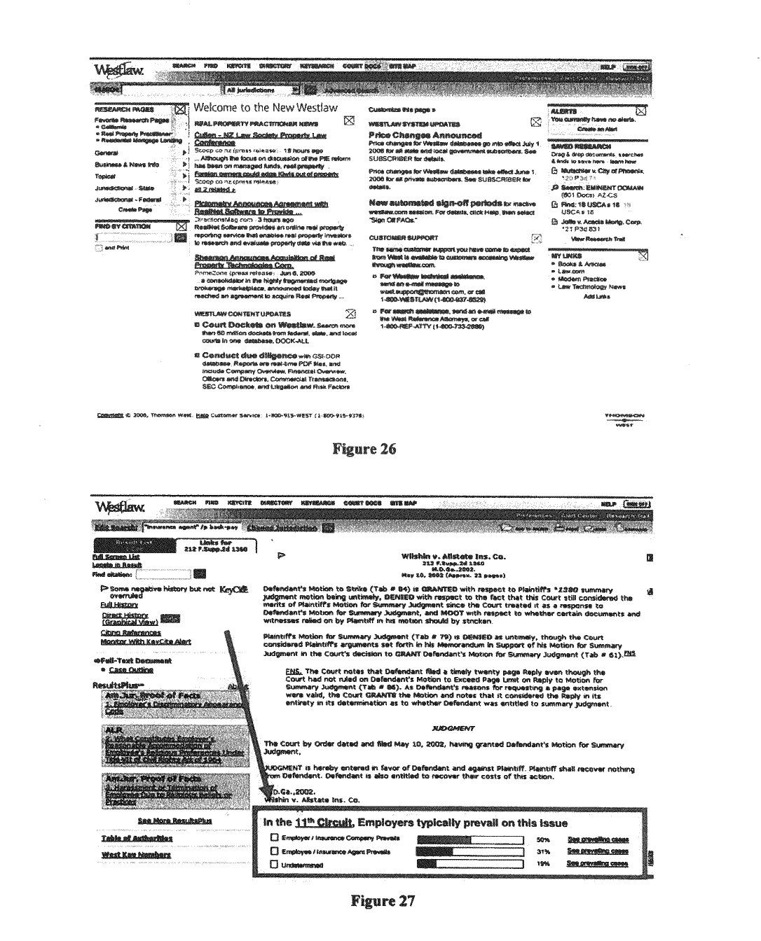

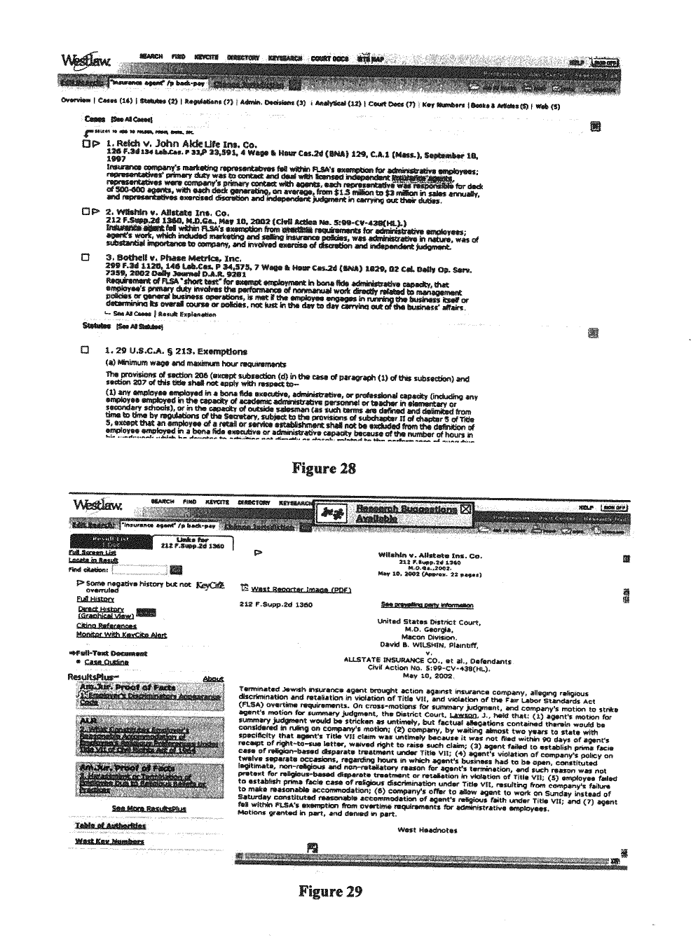

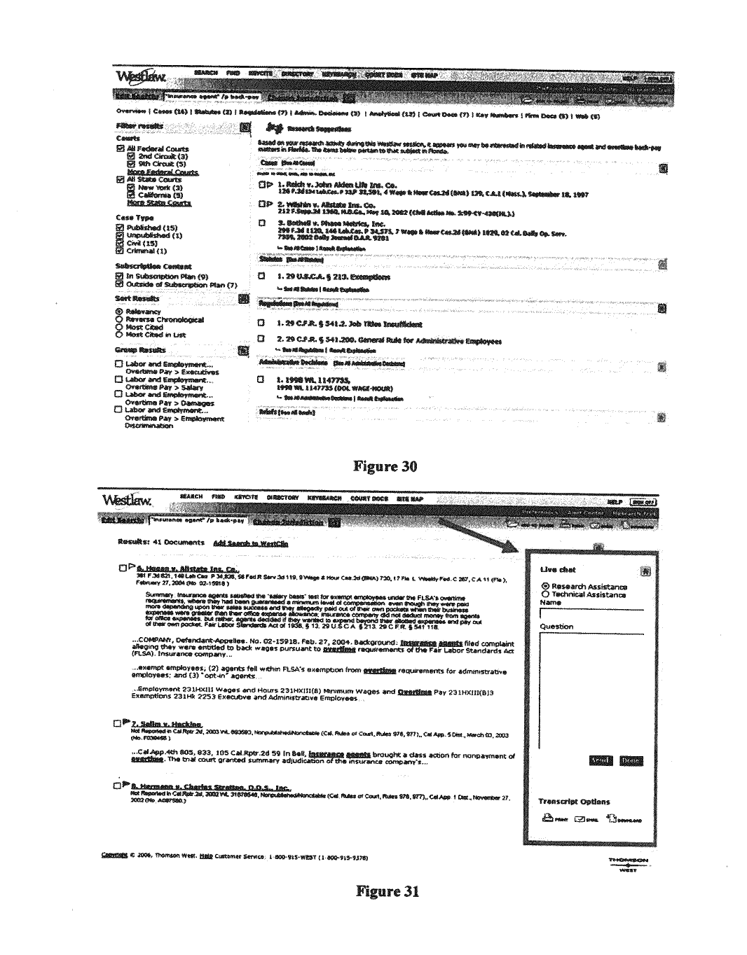

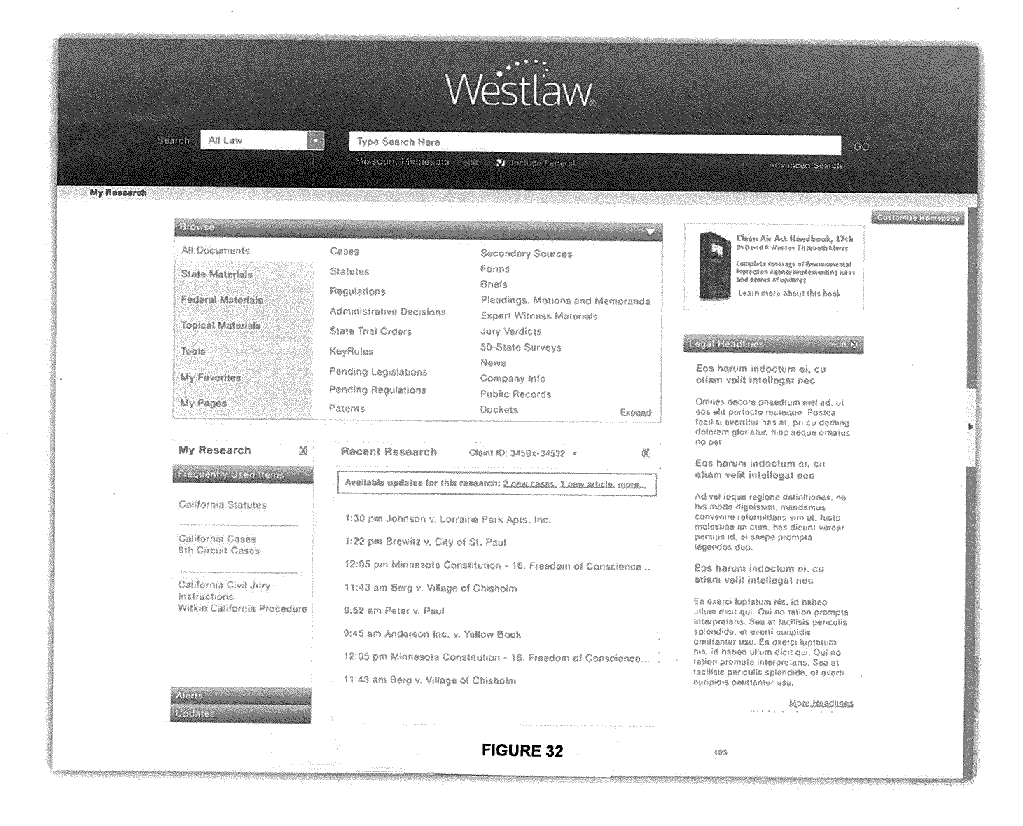

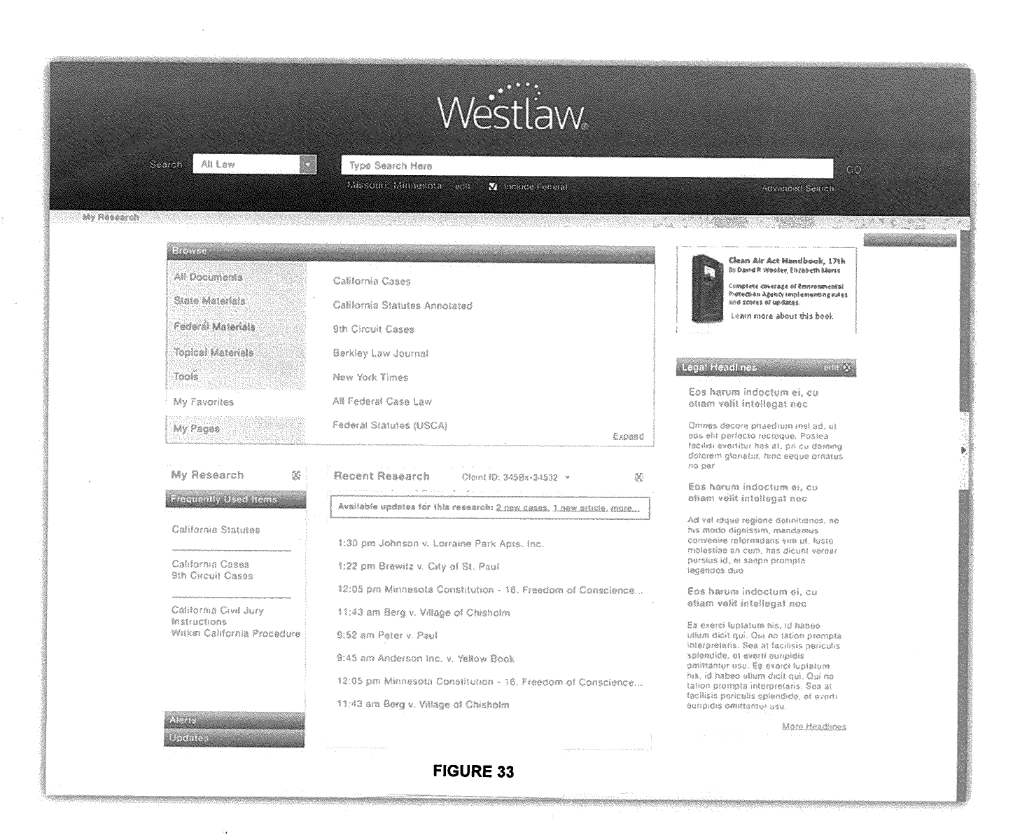

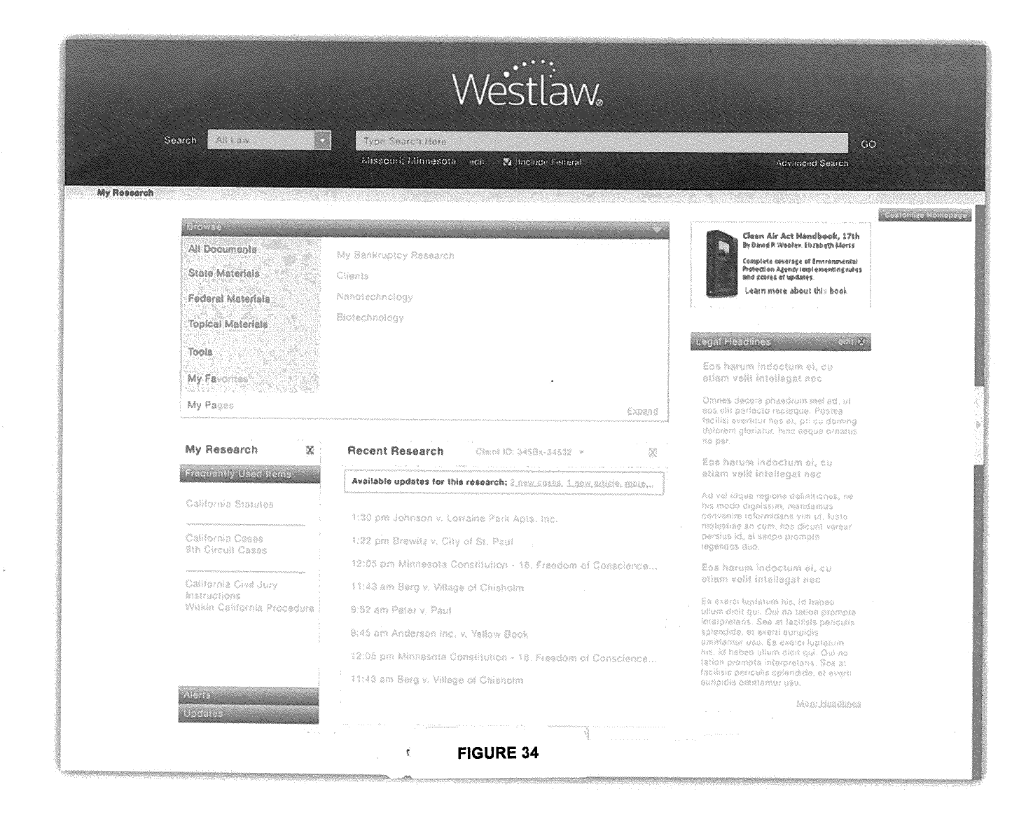

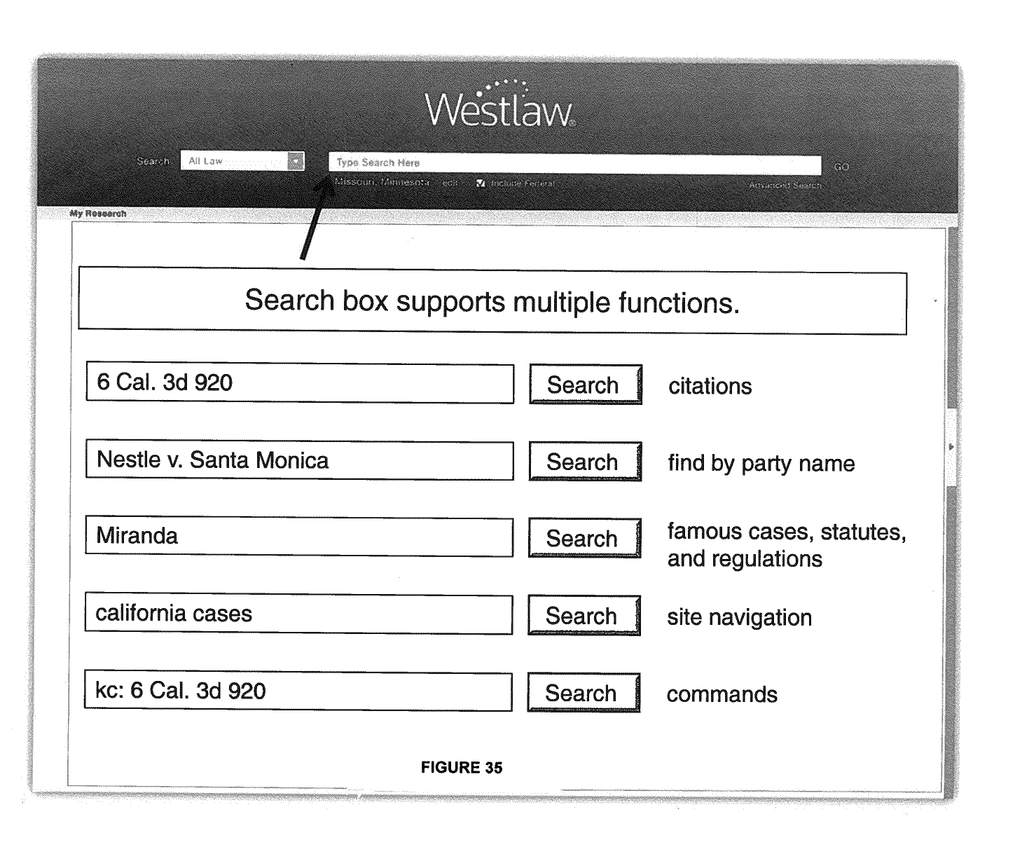

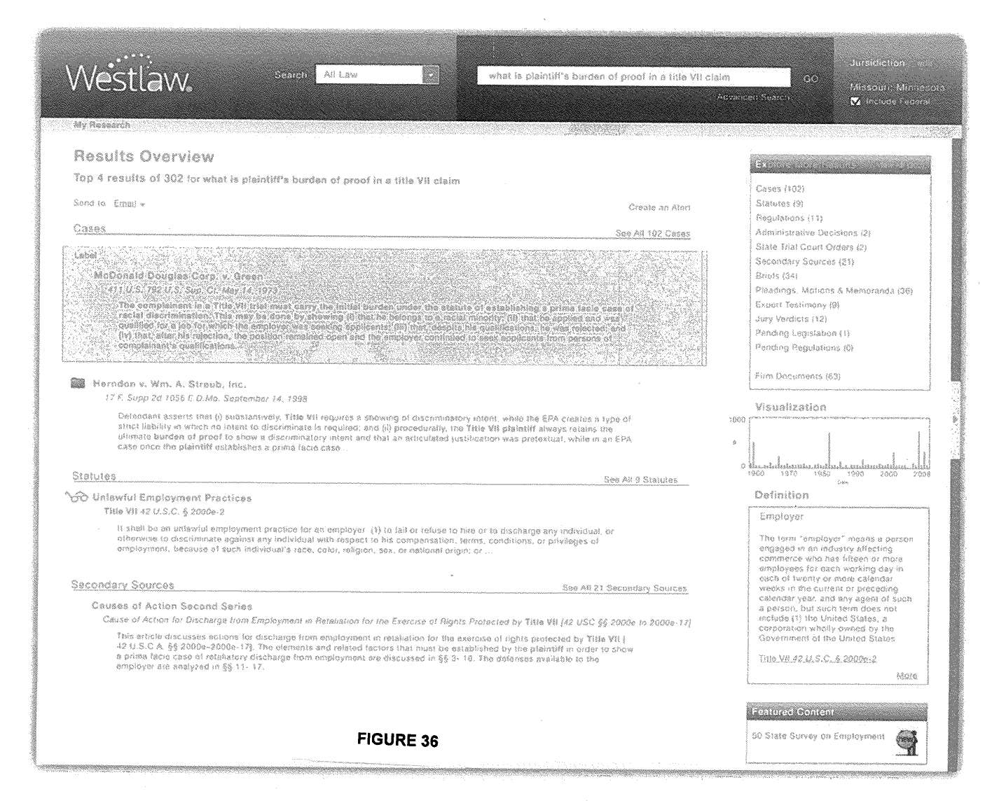

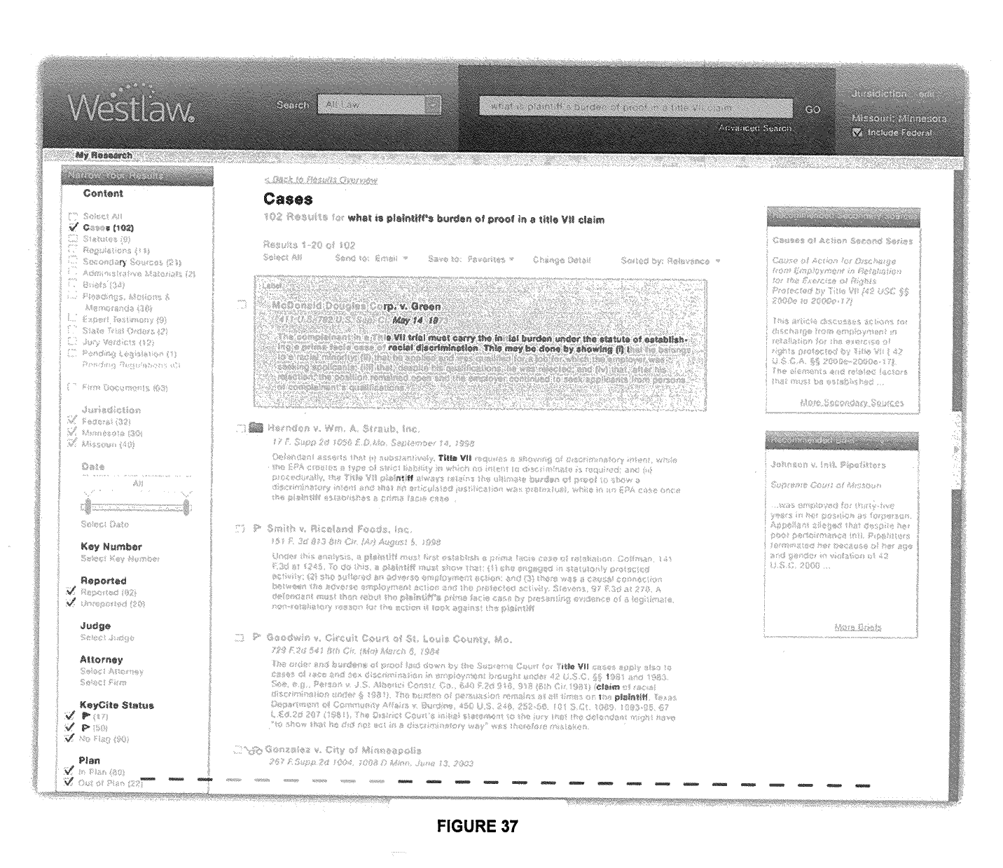

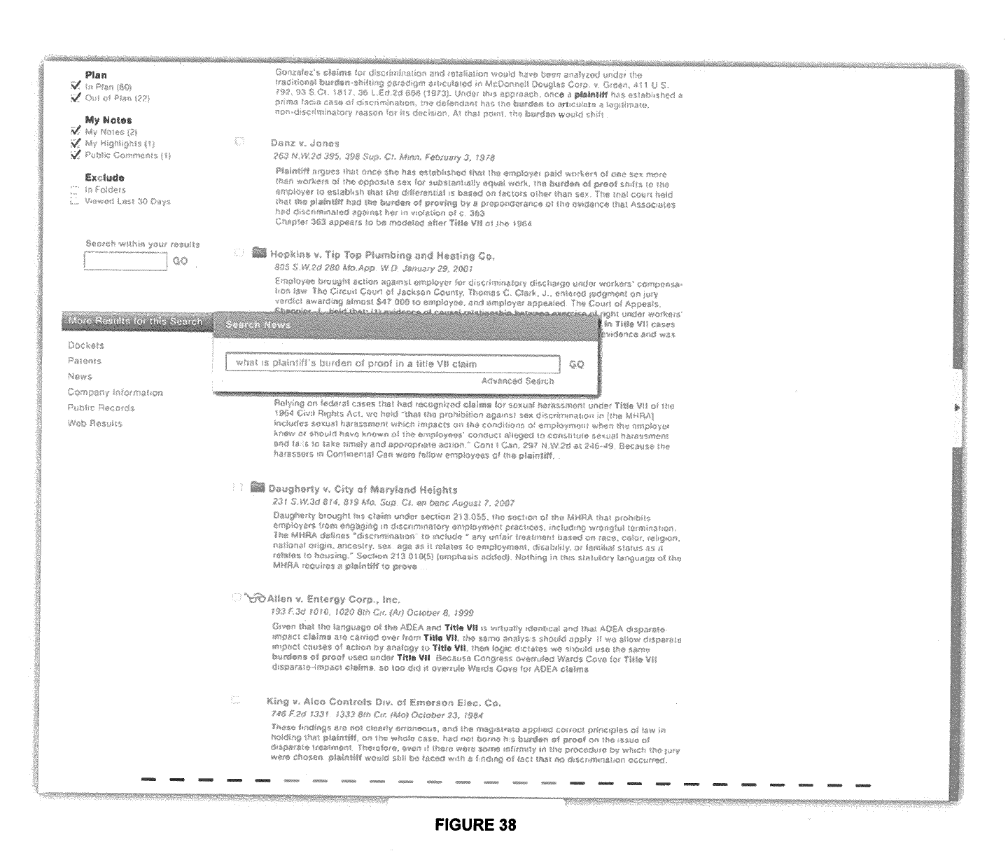

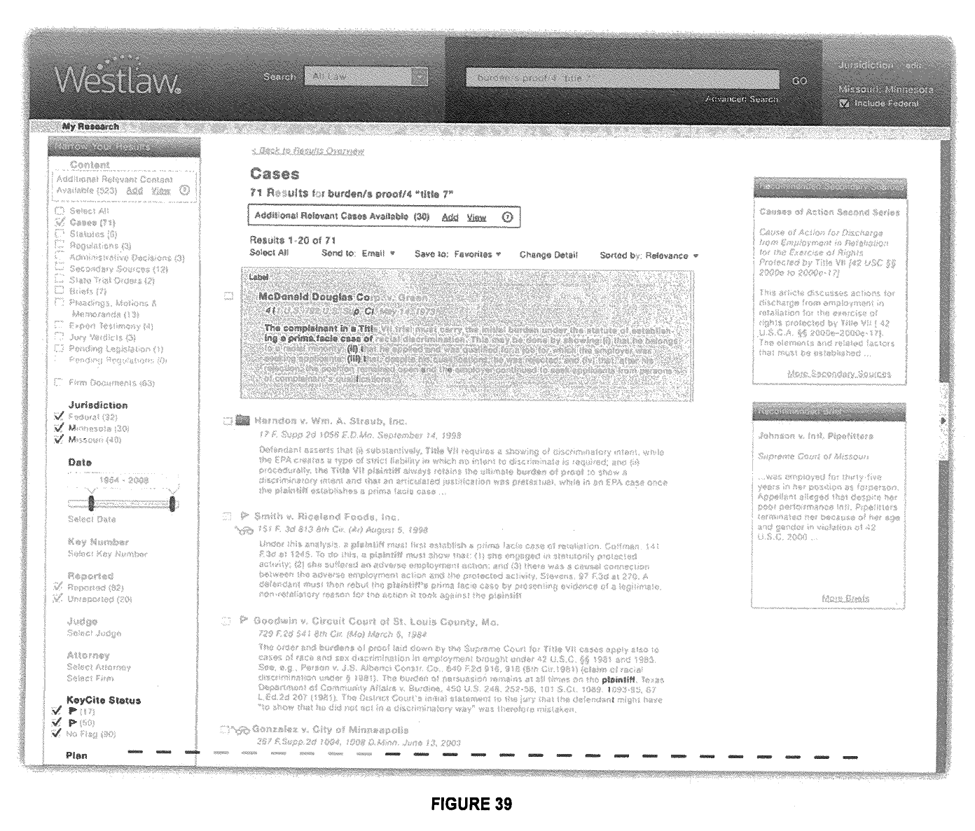

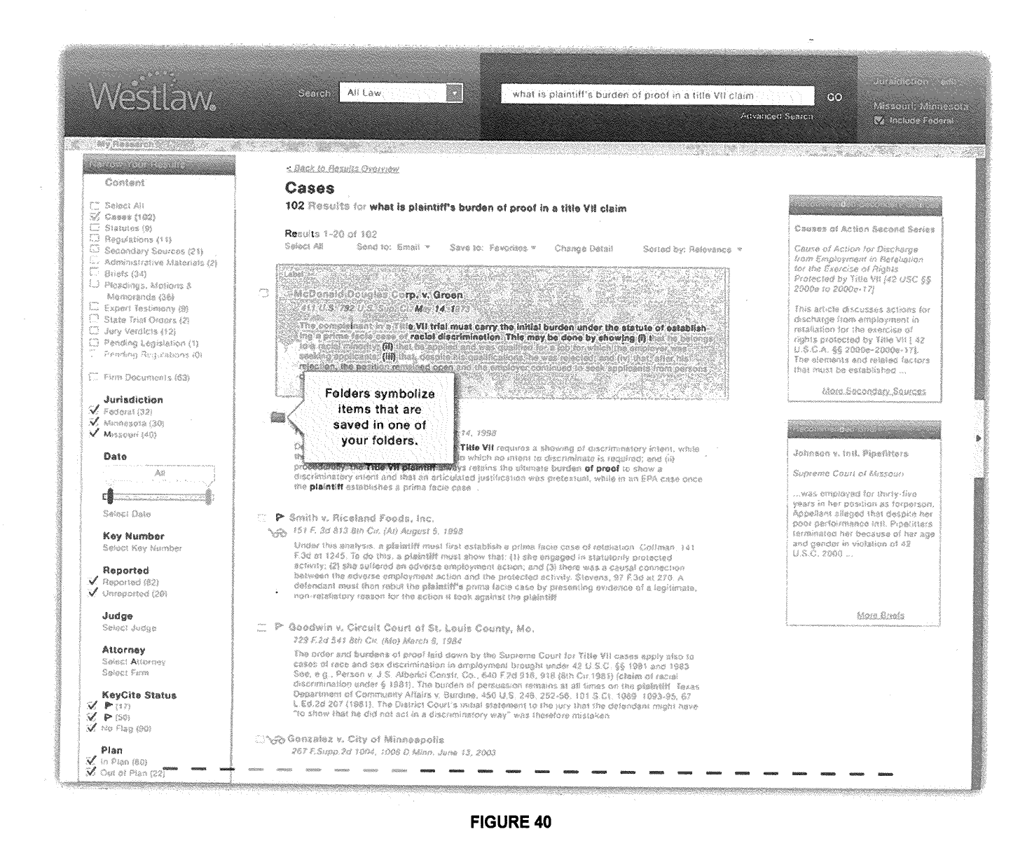

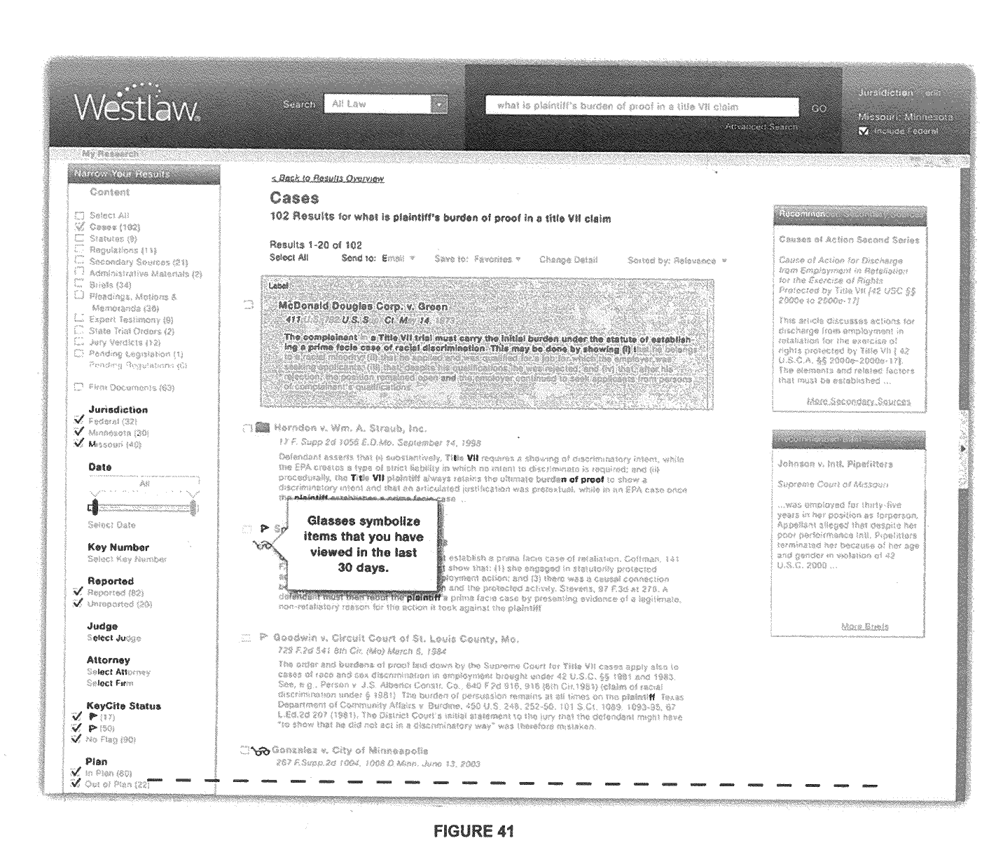

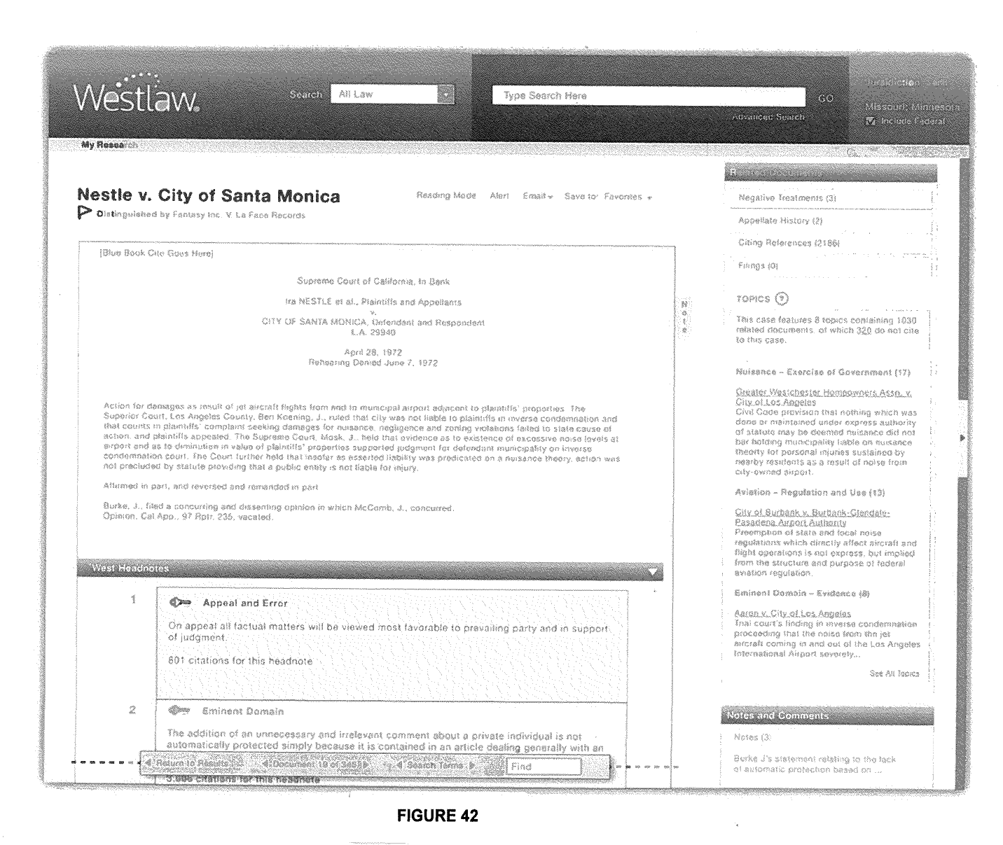

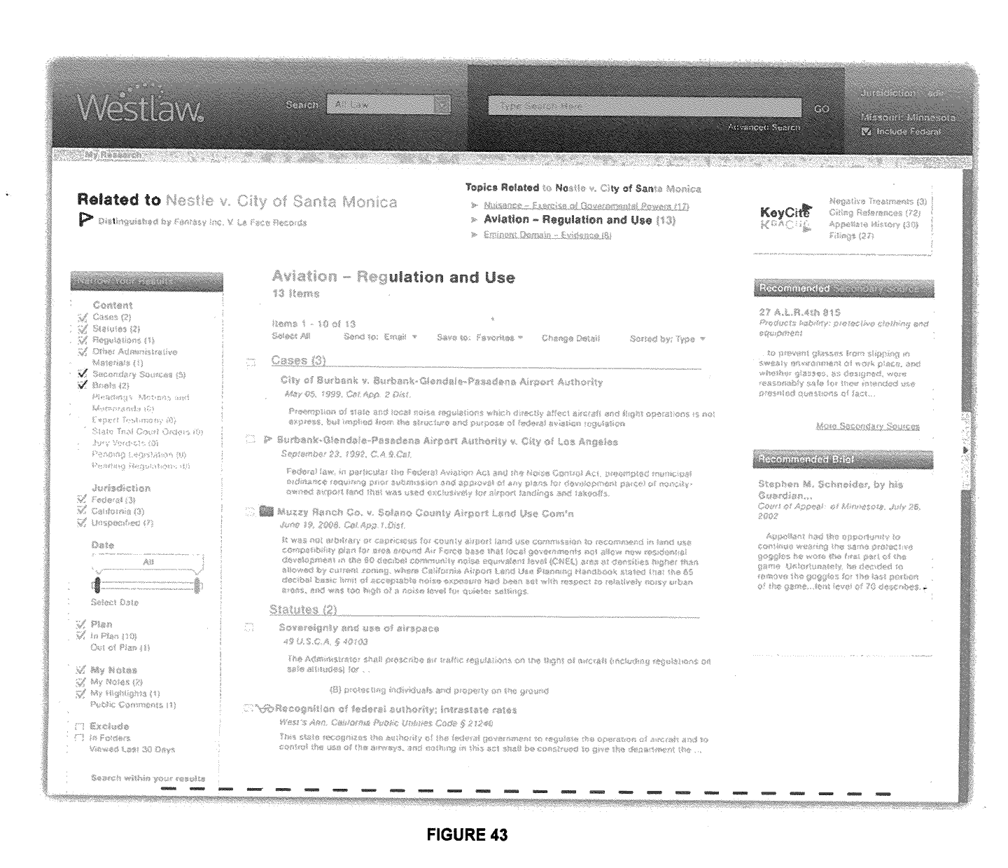

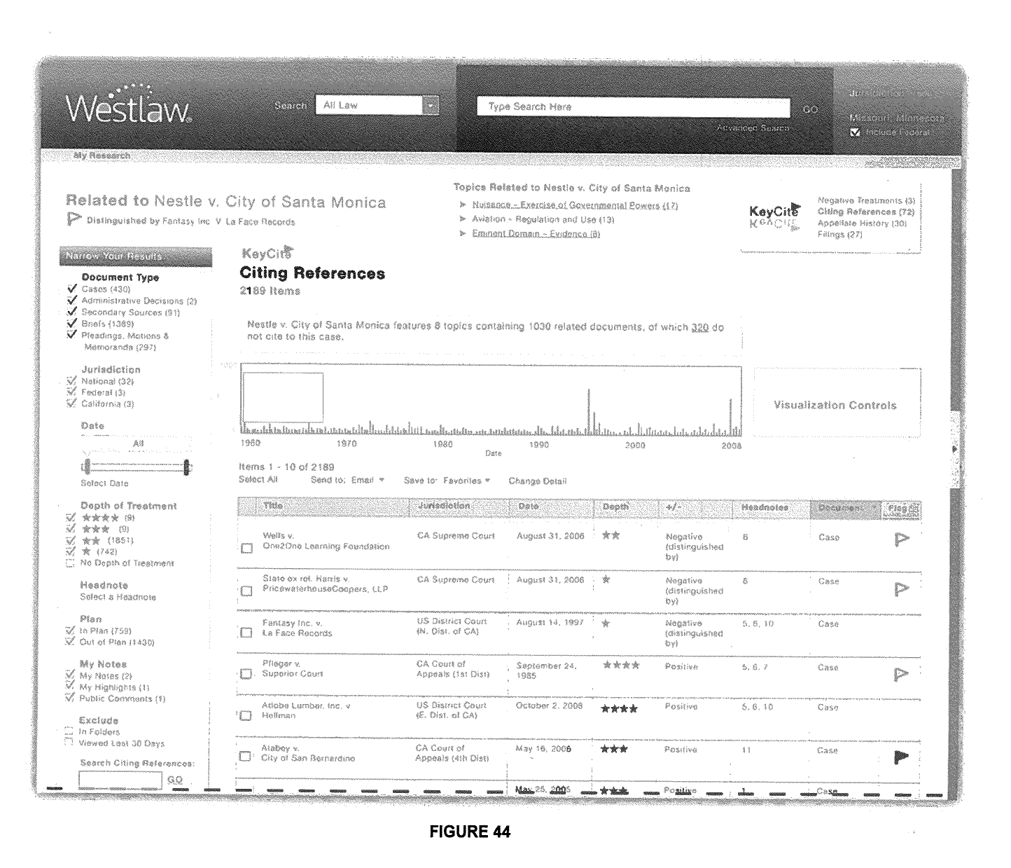

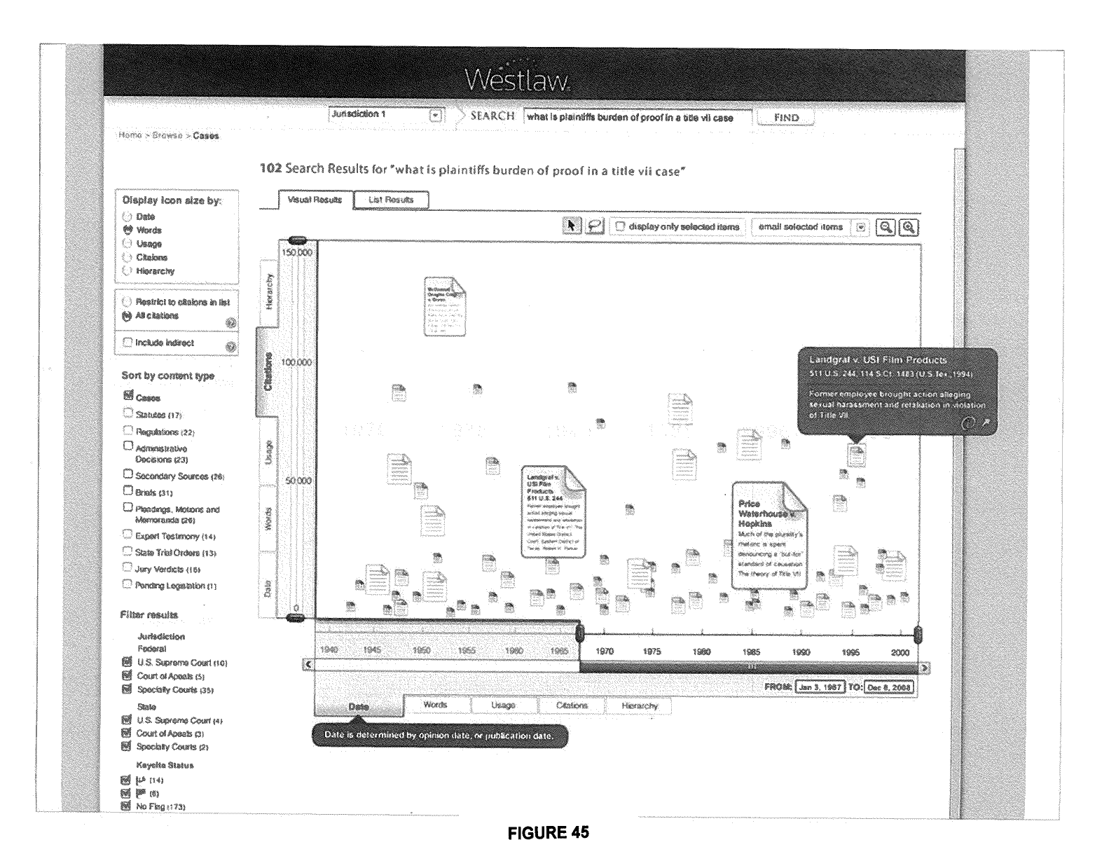

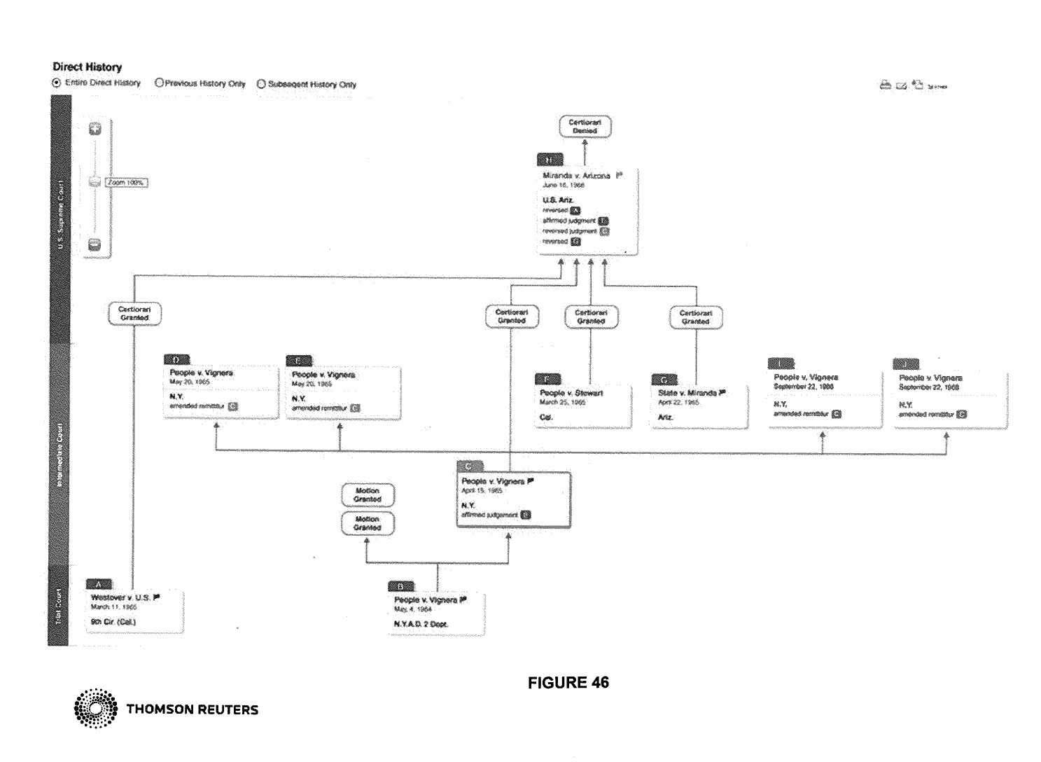

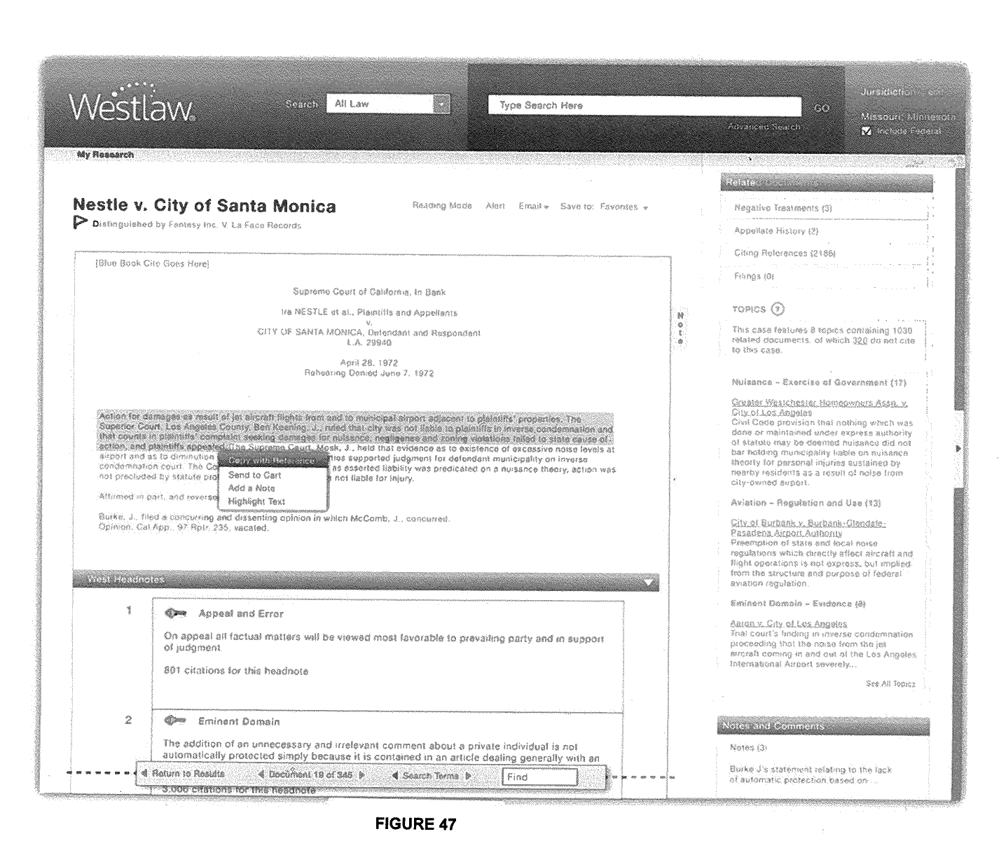

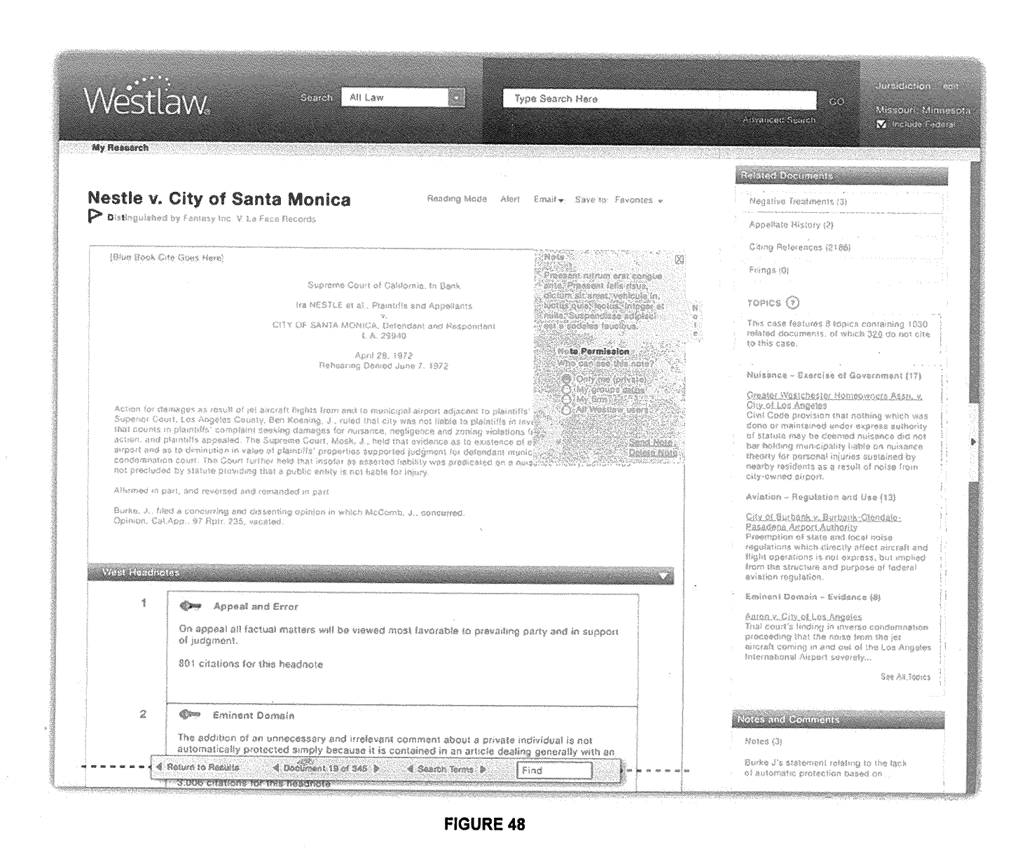

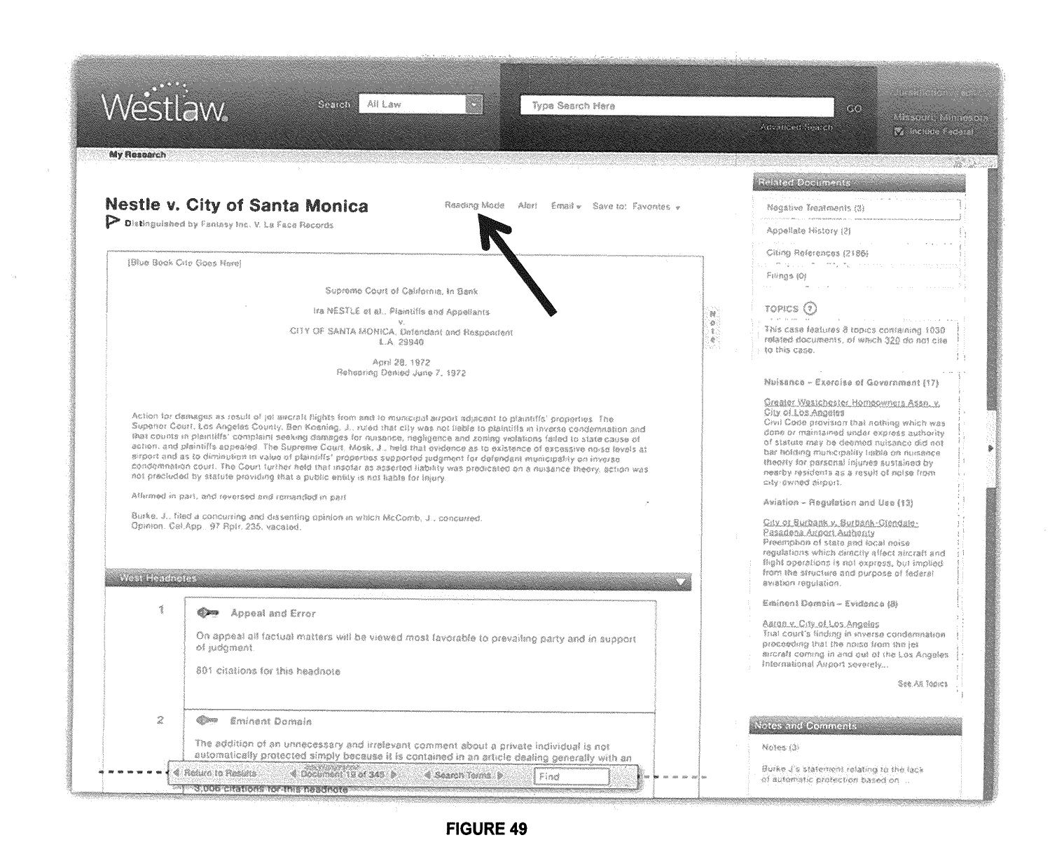

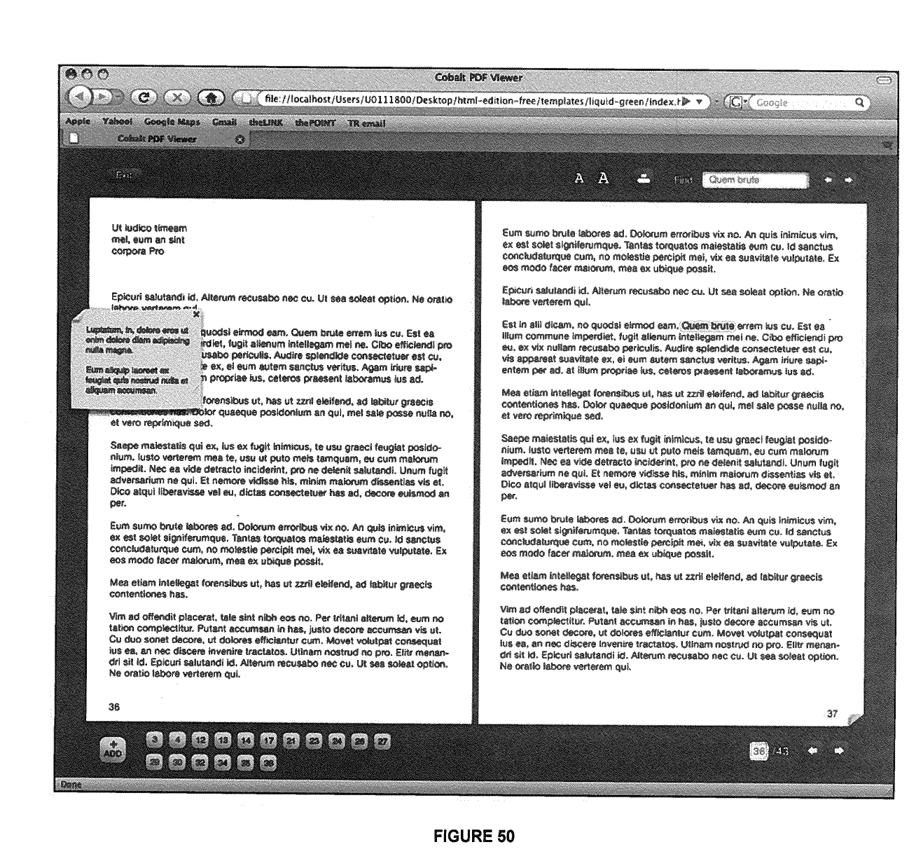

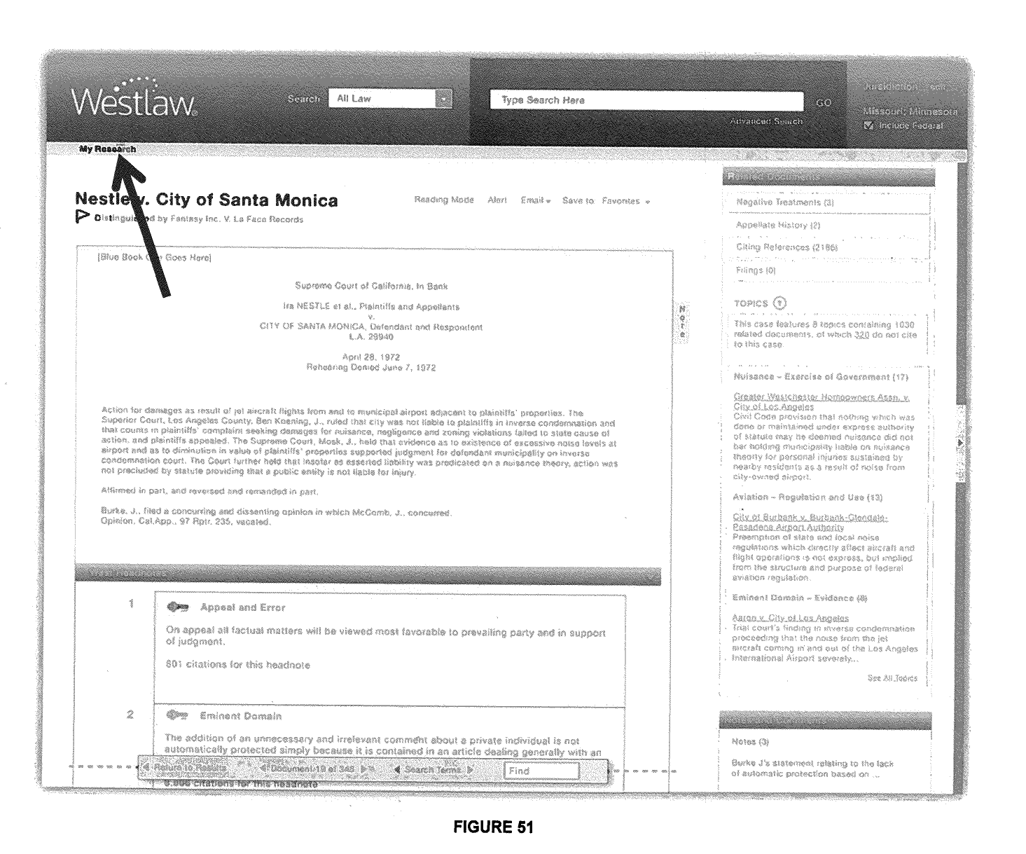

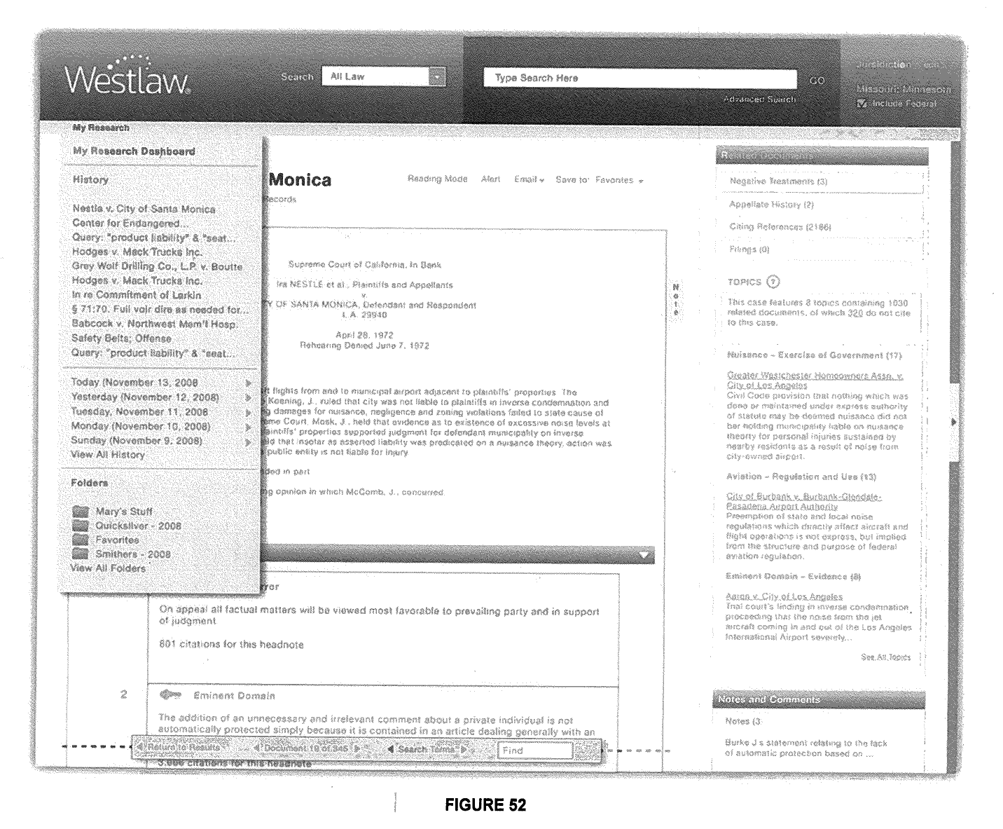

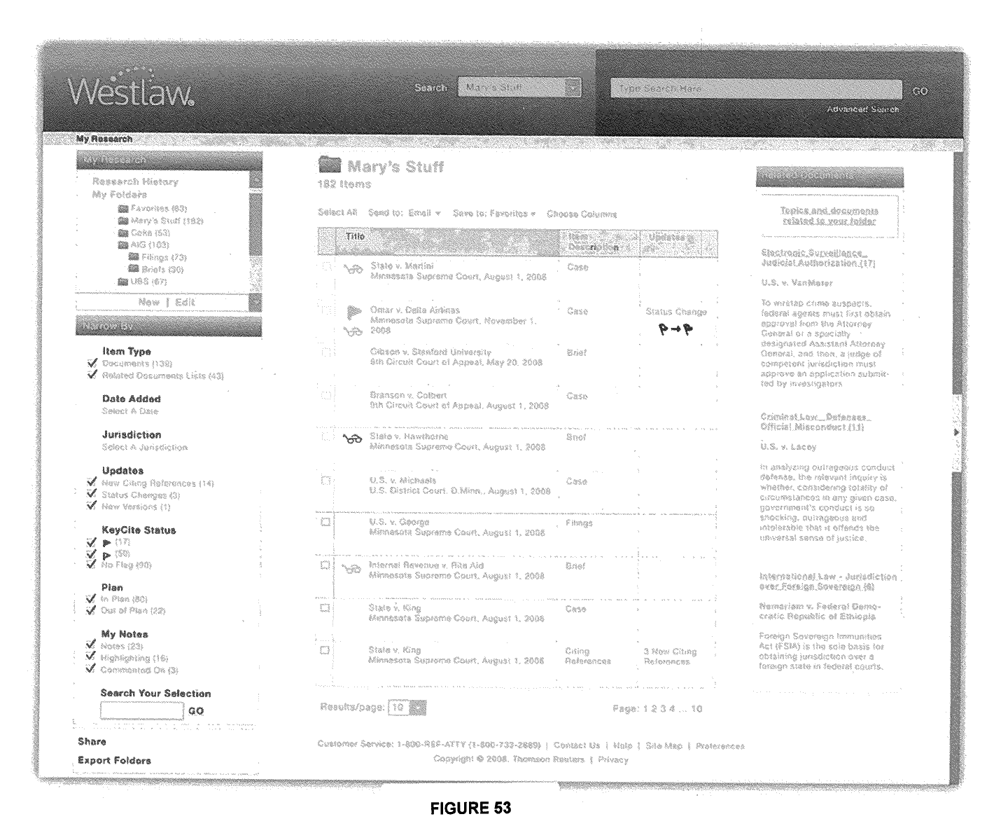

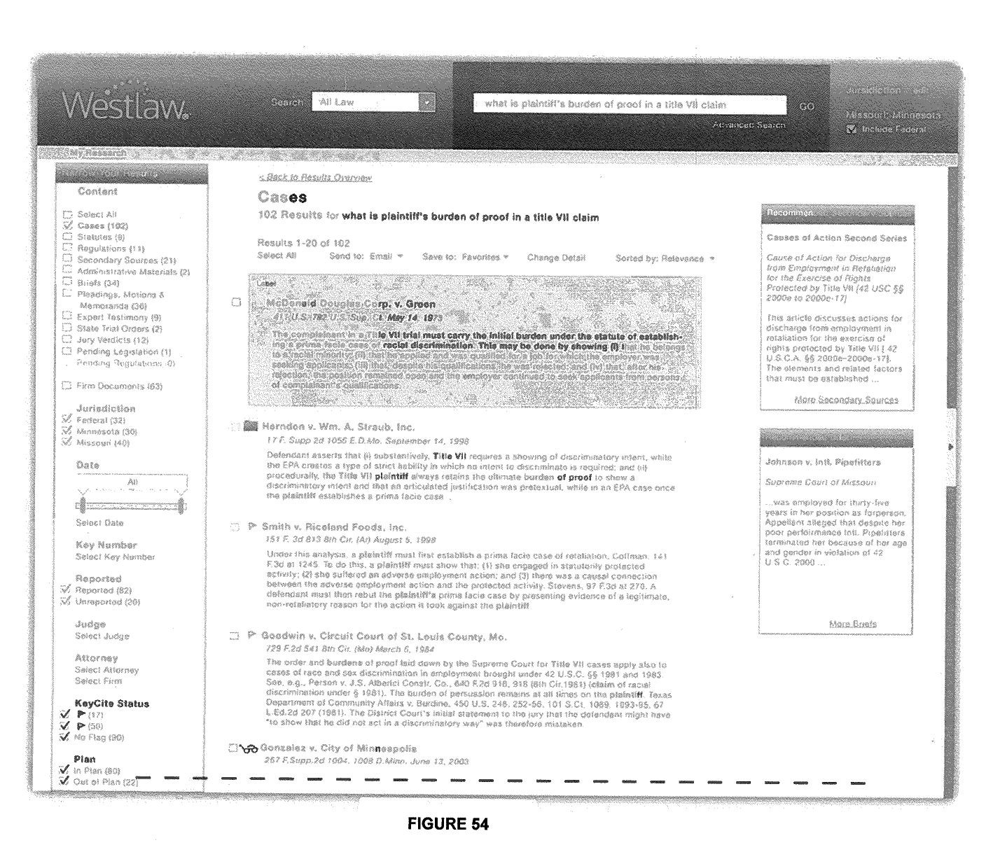

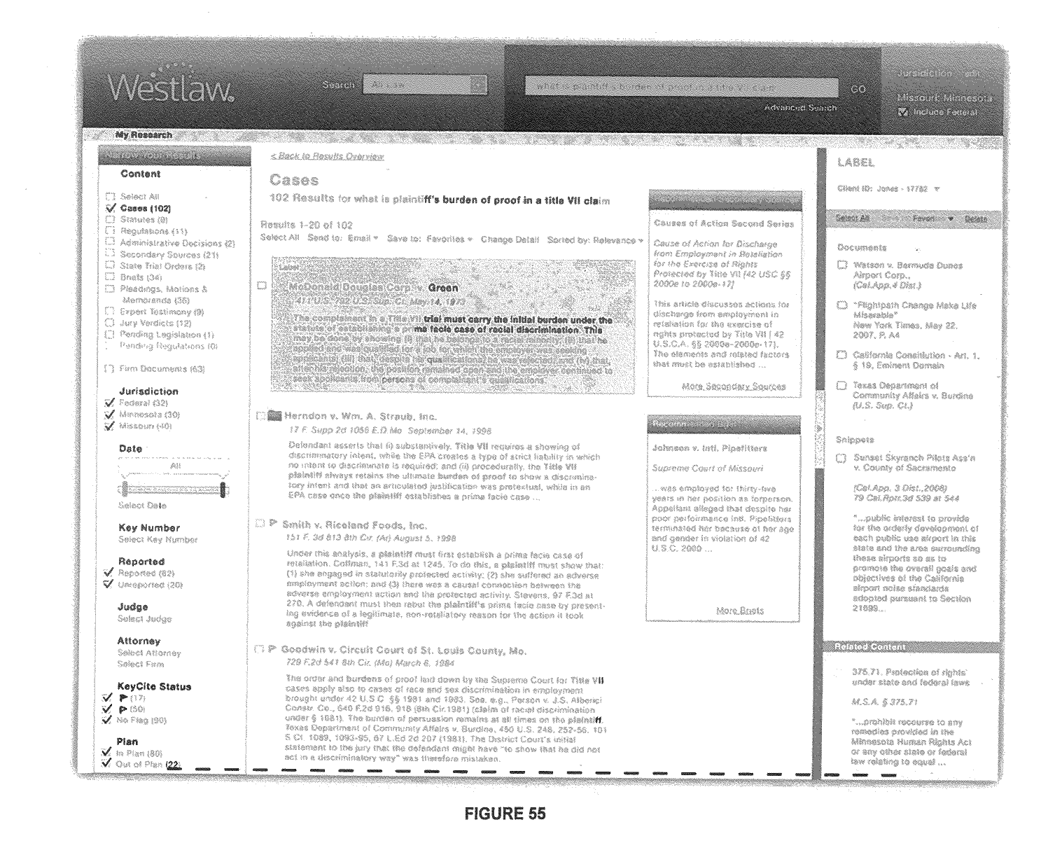

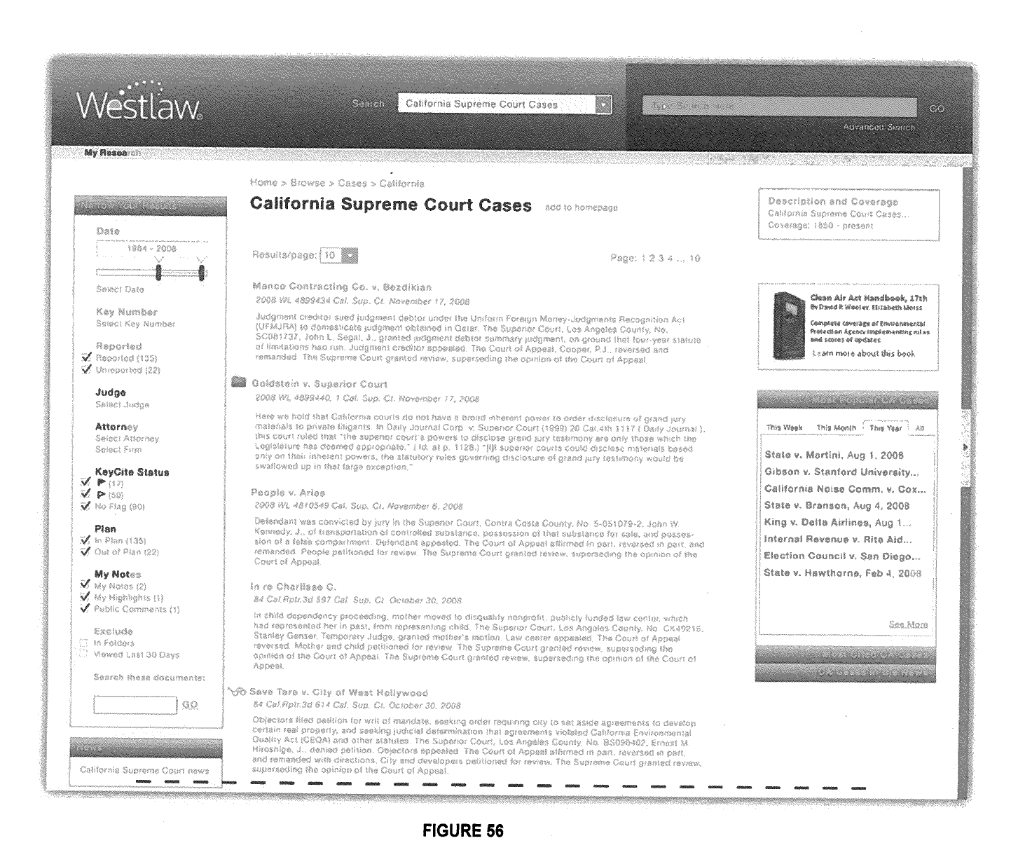

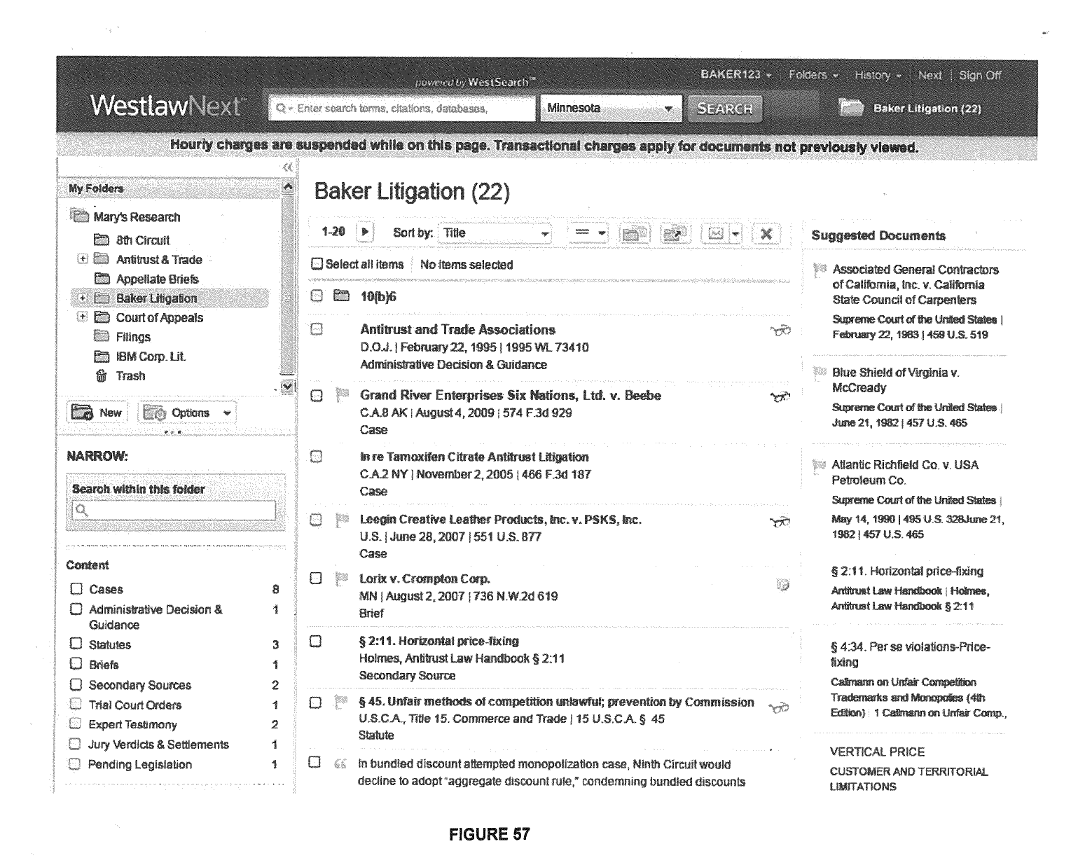

FIGS. 57-63 illustrate an exemplary interface for viewing and sharing folders. As shown in FIG. 57, in one embodiment, the exemplary interface displays a selectable folder list including one or more folder name(s) and subfolders created in the folder and associated with the user. The folder name(s) and subfolders are provided to the exemplary interface by the folder module 148 in response to a request. Upon selection of a folder name, a signal request is sent to the folder module 148, which identifies the content of the selected folder and transmits the content to the exemplary interface for display. For example, as shown in the FIG. 57 example, upon selection of the folder “Baker Litigation”, a subfolder entitled “10(b)6” as well as documents associated with that folder are displayed in the results area.

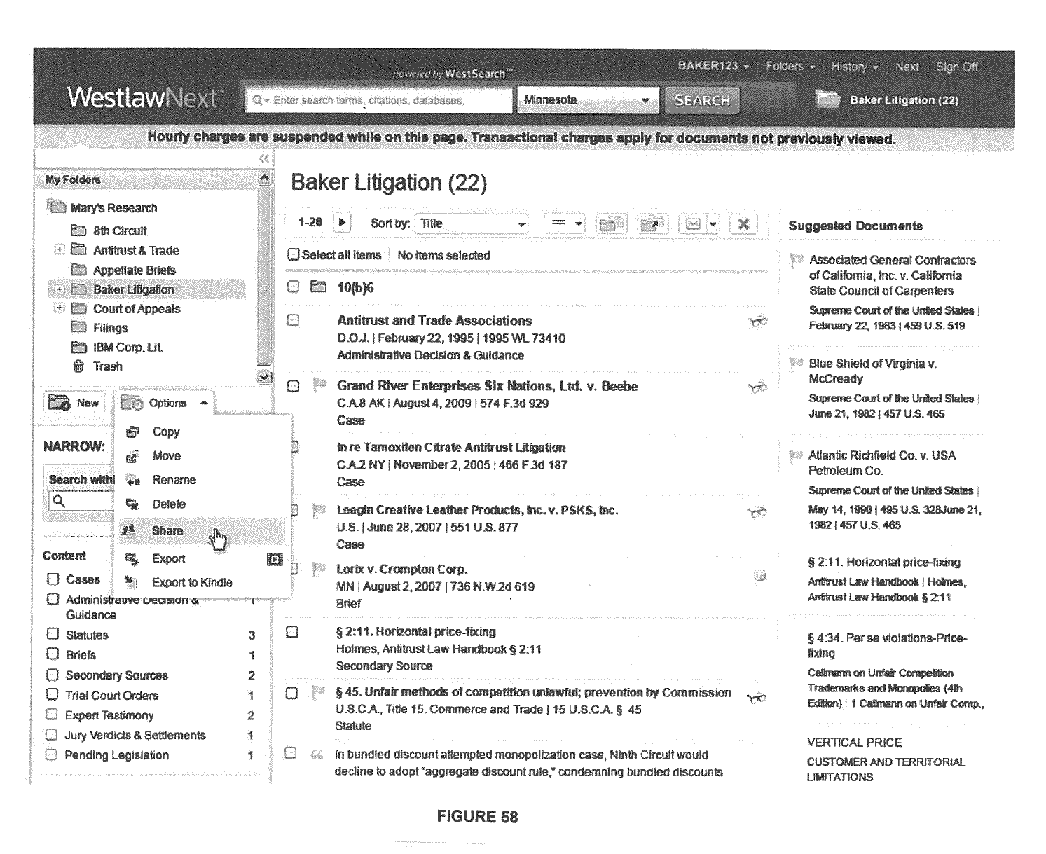

Turning now to FIG. 58, in one embodiment, for example, the exemplary interface provides a plurality of user selectable options to manage and control folders. As shown in the FIG. 58 example, in one embodiment, a user can select a “New” button to create a folder, which would send a signal to the folder module 148 to create a new folder associated with the user. An option menu is also provided that includes selectable options such as “Copy” to copy a folder to another folder, “Move” to move a folder to another folder, “Rename” to rename a folder a different name, “Delete” to delete a folder, “Share” to share contents of the folder with other users, “Export” to export contents of the folder to a different electronic medium, and “Export to Kindle,” to export contents of a folder to a software and hardware platform for the rendering and displaying of documents.

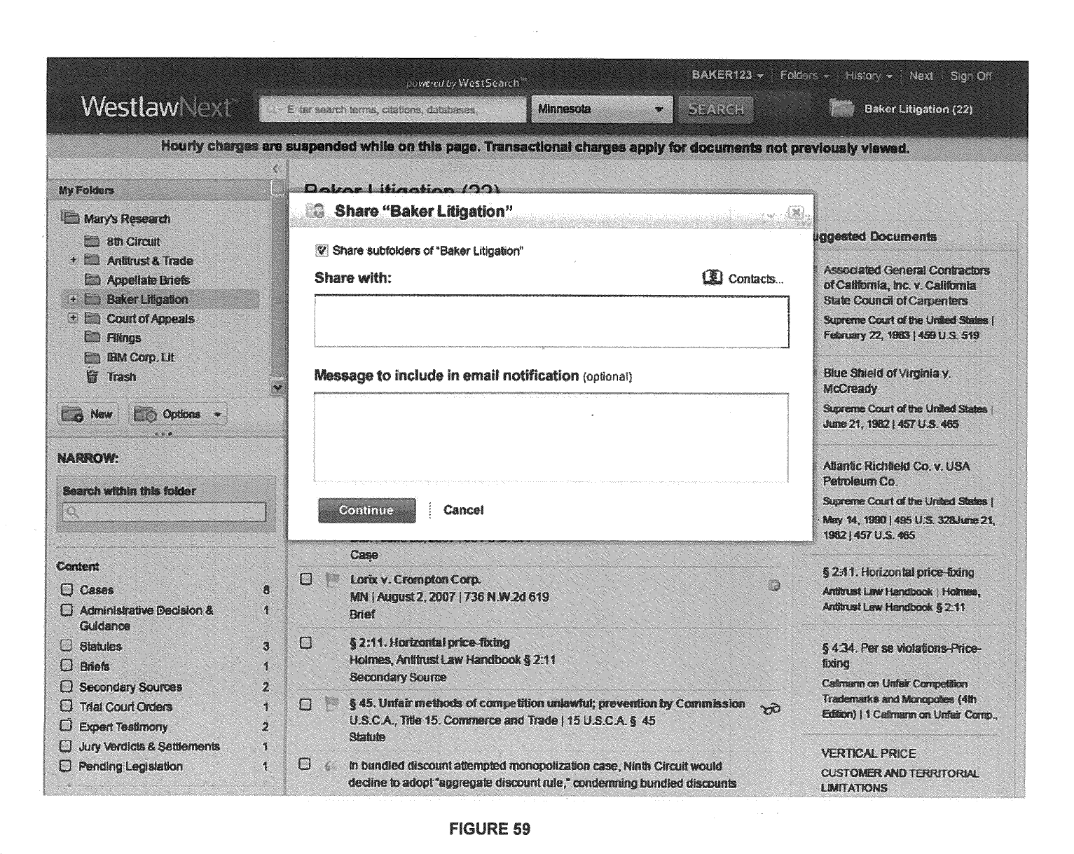

FIG. 59 is an exemplary interface that is displayed to a user upon selection of the “Share” menu option. As shown in the FIG. 59 example, a toggle option is provided to select whether subfolders of the selected folder are to be shared. A share area is also provided to identify users allowed access to the folder or subfolders. As shown in FIG. 59, an optional notification area is also provided to specify a user defined message to be emailed to identified users once the folder has been made shareable. In one embodiment, a “Contacts” option is also provided that displays a list of users defined in the system. The list of users is received from the contact module 142 in response to a request.

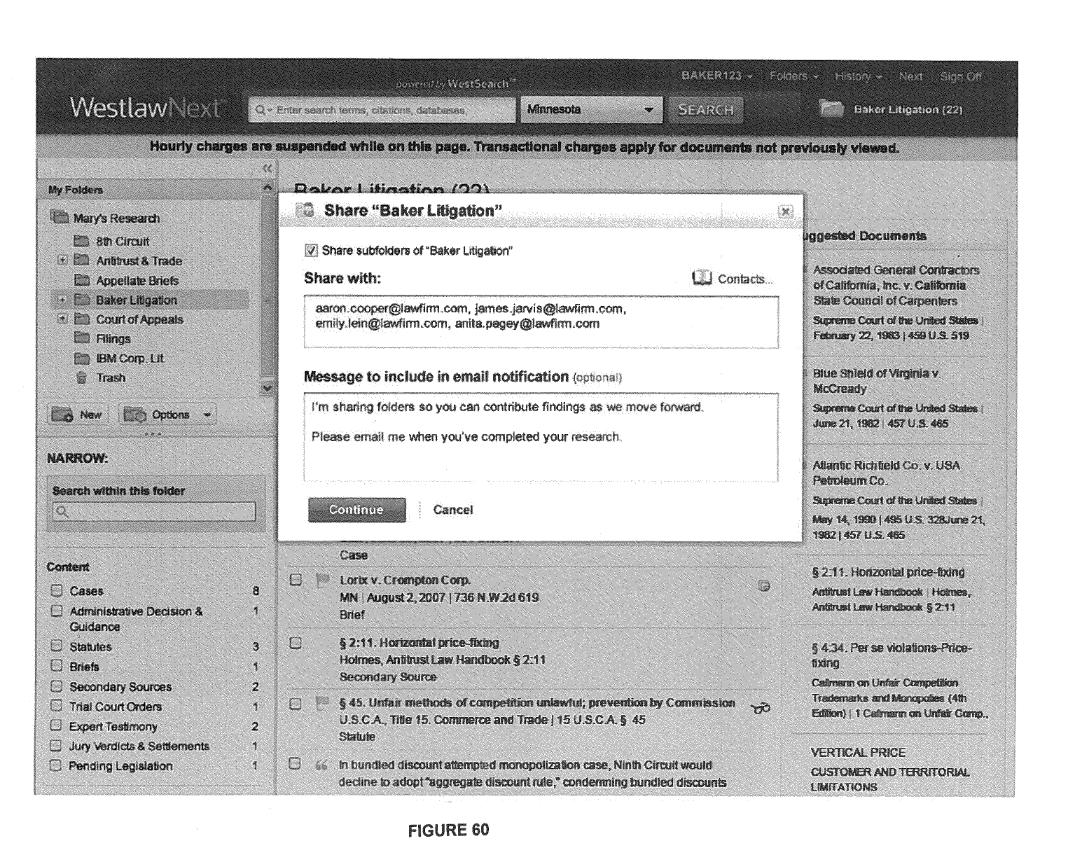

For example, referring now to FIG. 60, the exemplary interface allows a user to specify that the subfolder “Baker Litigation” is to be shared. Users are identified that are allowed to share the “Baker Litigation ” folder, and an example e-mail notification is specified to be sent to identified users upon sharing the folder.

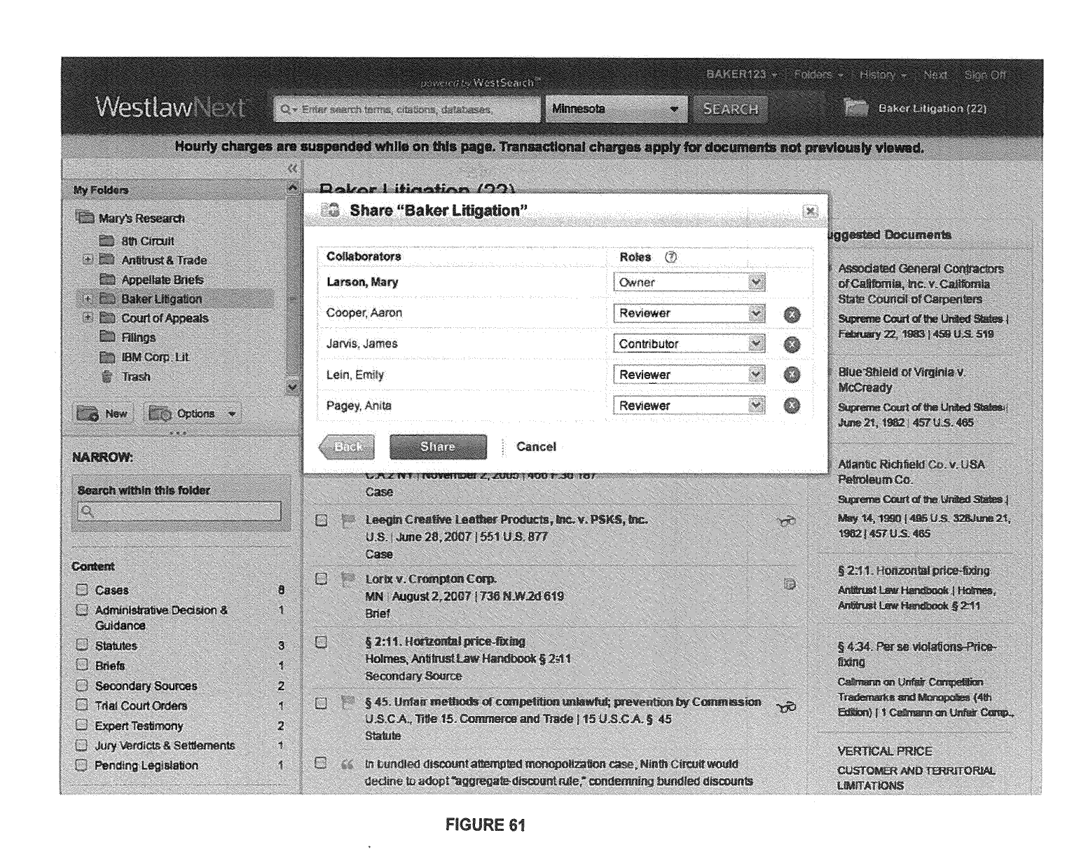

Turning now to FIG. 61, in one embodiment, upon selection of a “Continue” button provided on the interface, an example collaboration interface is displayed to the user. As shown in FIG. 61, the collaboration interface includes a list of users identified as being allowed to share the “Baker Litigation” folder (e.g., collaborators), and user selectable roles that are associated with permissions regarding the shareable folder. For example, as shown in FIG. 61, the user “Larson, Mary” is identified as an owner of the folder. The “Owner” role indicates that user “Larson, Mary” is to have read, write, modify, and delete permission on the “Baker Litigation” folder. The “Contributor” role indicates that a user, such as “Jarvis, James”, is allowed to add content to the shareable folder. The “Reviewer” role indicates that a user is to have read-only access to the folder.

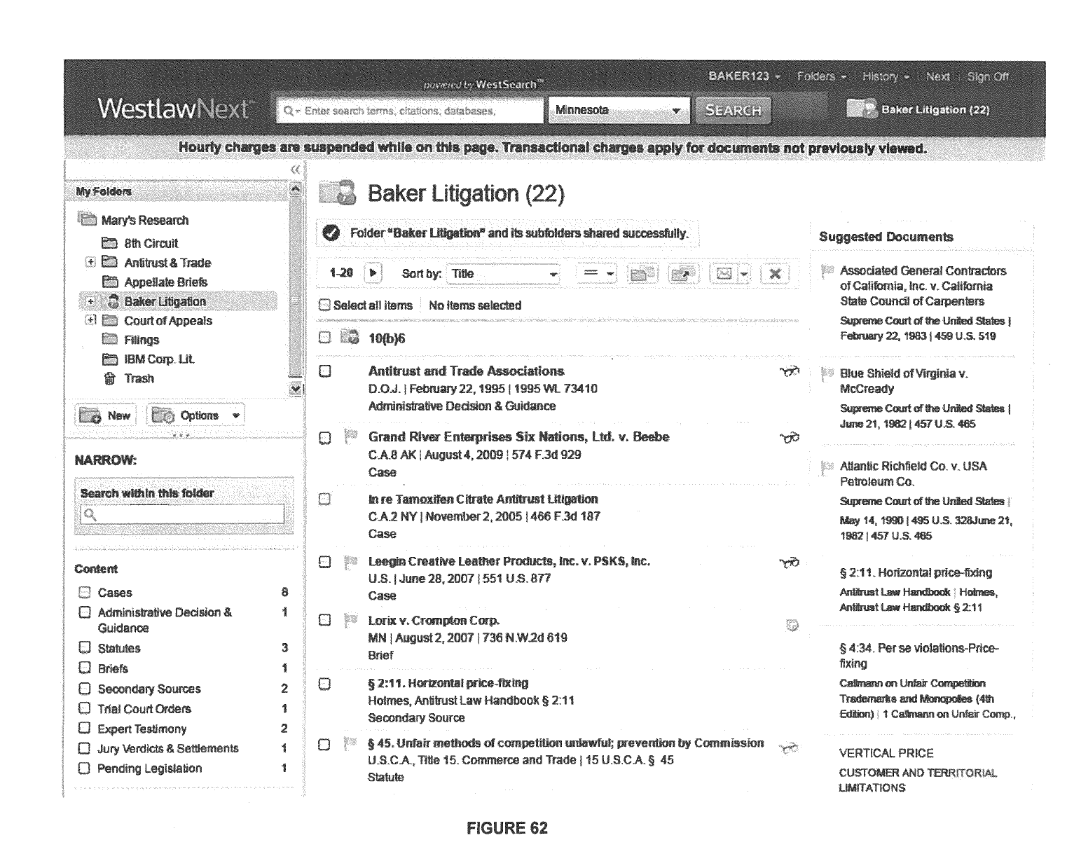

Once a user selects a “Share” button provided on the interface, the interface transmits the user and role information to the folder module 148. The folder module 148 receives the identified information and sets the appropriate permission on the folder for each user's role identified. The folder module 148 then transmits a message back to the interface indicating that the folder and any related folders affected by the user selection are shared successfully, as shown in FIG. 62.

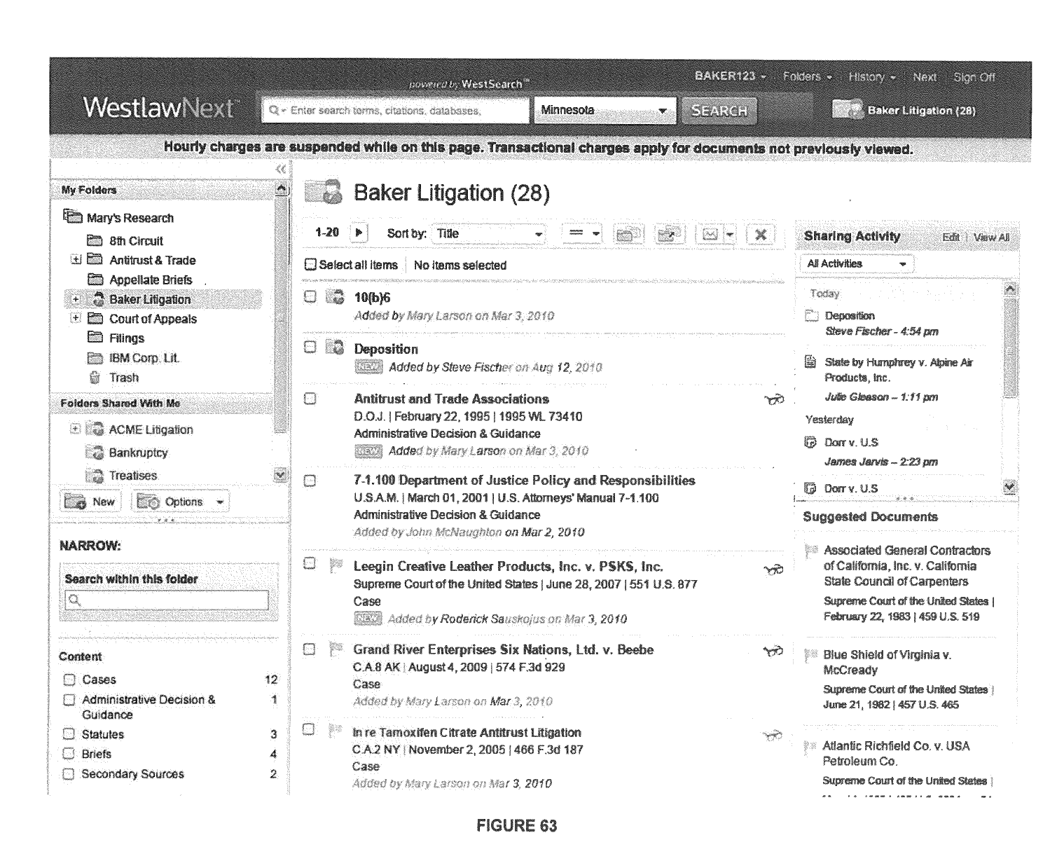

FIG. 63 illustrates an exemplary interface for displaying content of a shared folder. As shown in FIG. 63, in one embodiment, upon selection of a shared folder by a user, a request in the form of a signal is sent to the folder module 148. The folder module 148 identifies content of the folder and the user responsible for each item of content, and transmits the same to the interface for display to the user. For example, as shown in the FIG. 63 example, the subfolder “Deposition” was added by the user “Steve Fisher” on Aug. 12, 2010. In one embodiment, as shown in FIG. 63, any content added to the shareable folder not previously viewed by the user is indicated as being “New.”

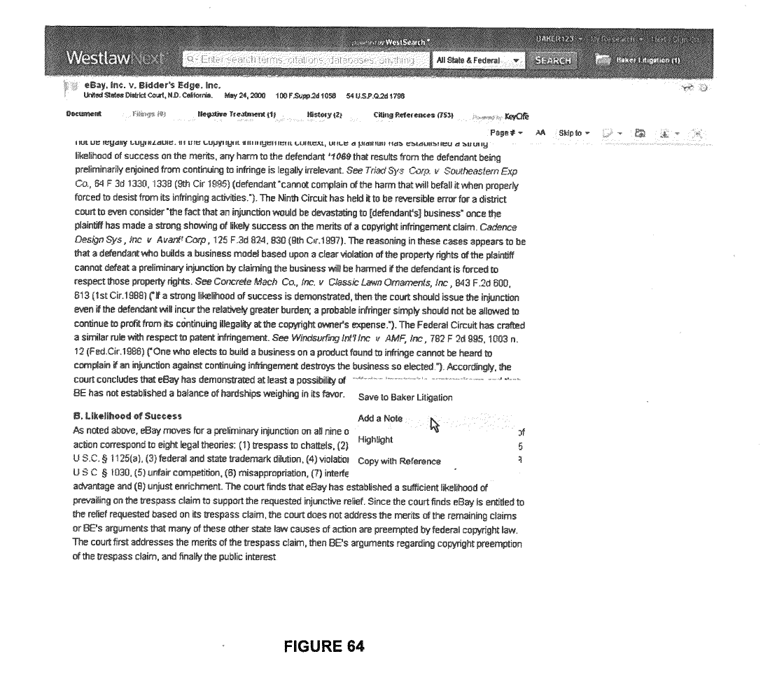

FIG. 64 illustrates an exemplary interface for adding a user annotation to a particular document. As shown in FIG. 64, in one embodiment, the exemplary interface includes a document display area in which content of a particular document is displayed. A floating-menu is also provided that allows a user to save the displayed document to a particular folder, add a user annotation to the displayed document, highlight text in the particular document, as well as copy portions of the particular document to another document with legal citations of the copied portion included therein.

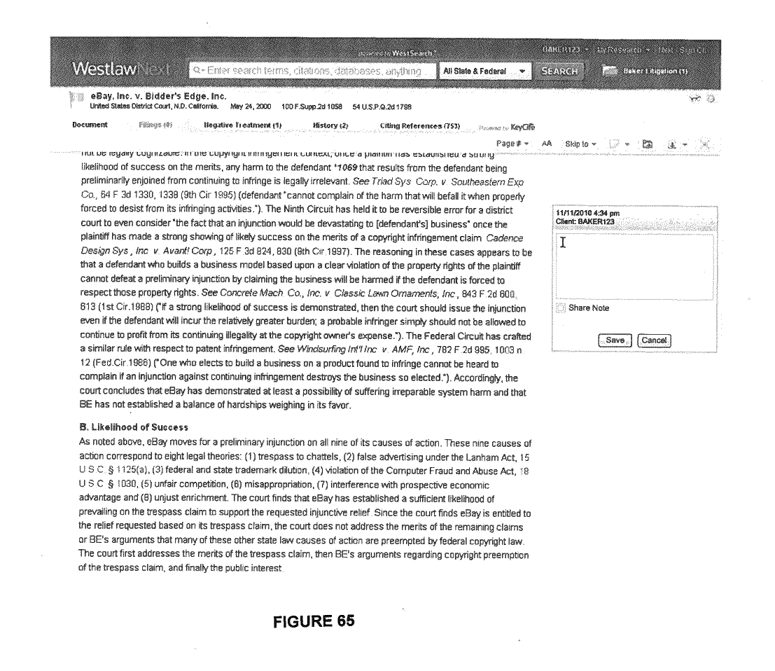

An example of adding a user annotation to a document is shown in connection with FIG. 65. In one embodiment, upon selecting an “Add a Note” menu option from the floating menu shown in FIG. 64, a secondary exemplary interface is displayed that includes, in part, a date and time value, a client identifier associated with the user, a text input box for typing a user note or comment, and a selectable share-note toggle button for indicating whether the user annotation being added is to be shared.

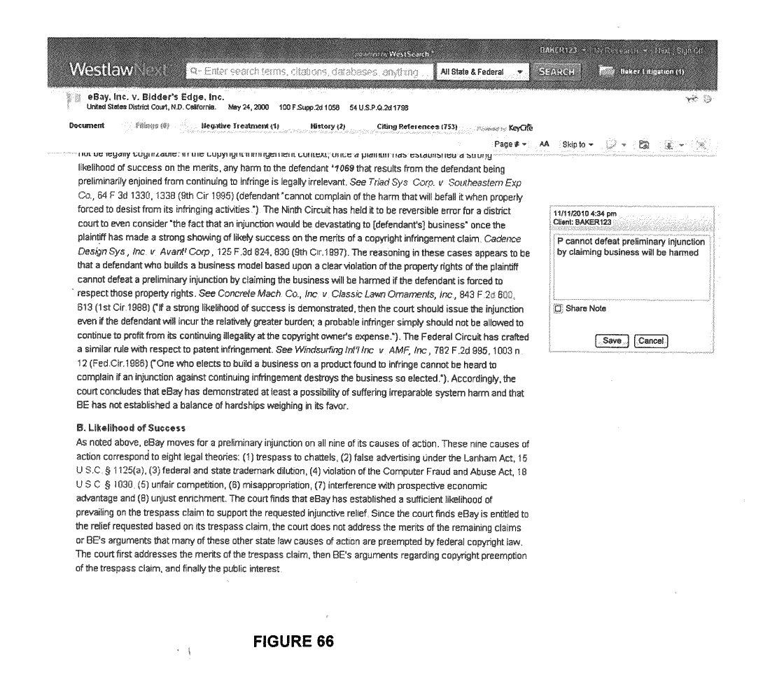

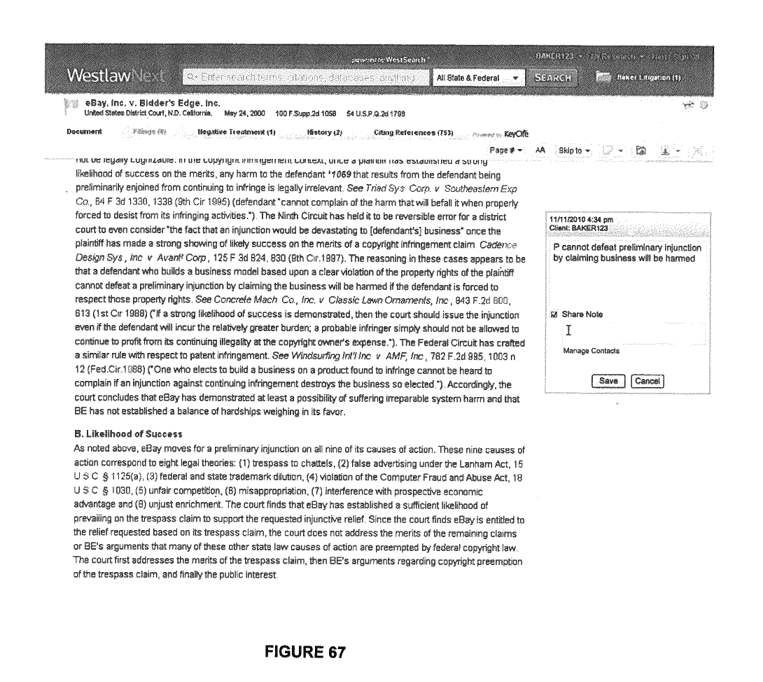

An example user annotation created by a user through the secondary interface is shown in connection with FIG. 66-69. FIG. 66 illustrates example text entered into the text input box of the secondary interface. FIG. 67 illustrates the share-note toggle button selected to the share position. As shown in FIG. 67, once the share-note-toggle button is selected, a contact area of the secondary interface is activated to allow data entry of one or more user names or groups of users allowed to share the annotation.

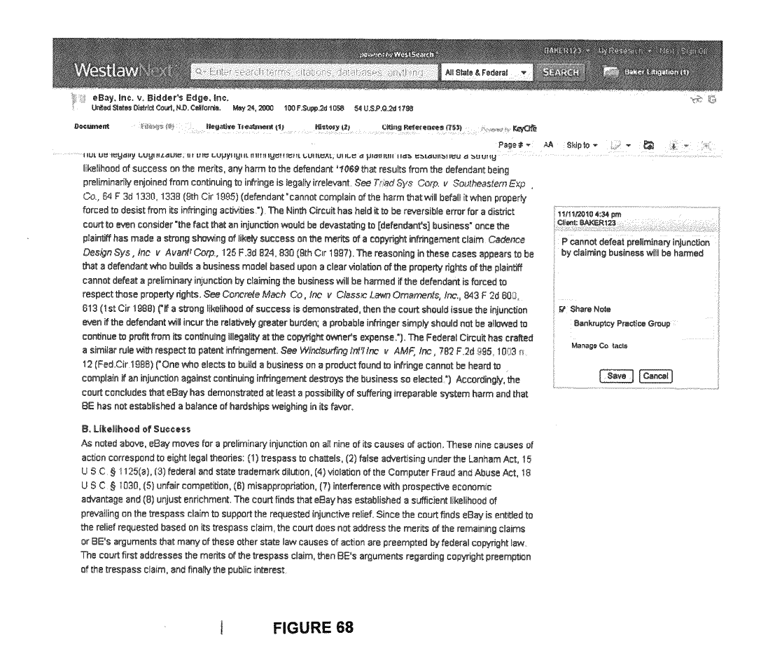

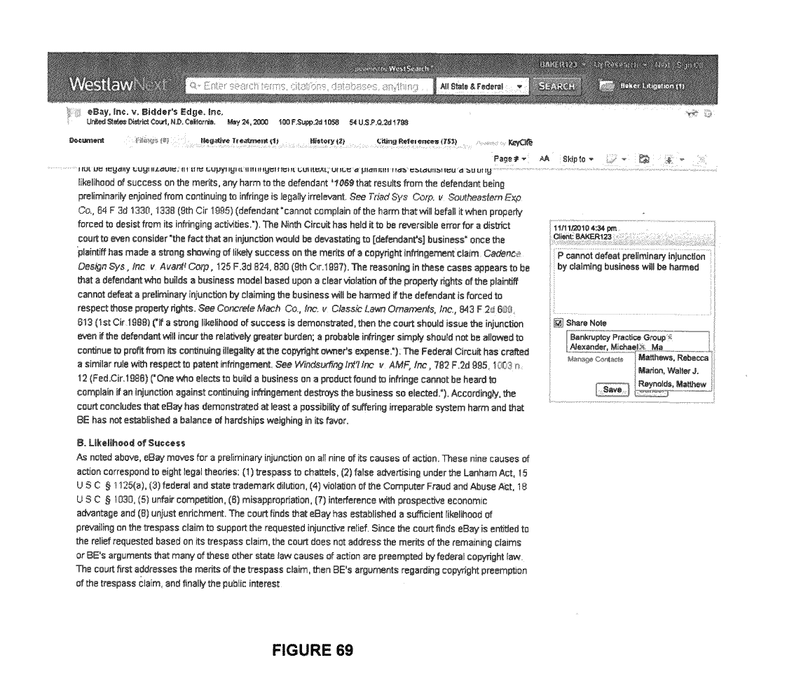

For example, turning now to FIG. 68, users associated with a “Bankruptcy Practice Group” are identified as users allowed to share the annotation. In some embodiments, as shown in FIG. 69, a “Manage Contents” option is also provided that allows users and groups of users to be identified based on information received from the contact module 142.

In one embodiment, once one or more users or groups of users are identified in the contact area, the user selects a “Save” button that causes a signal to be transmitted to the annotation module 140. Upon receiving the signal, the annotation module 140 associates the user annotation with the particular document displayed in the document display area. In one embodiment, an identifier of the document rather than the document itself is associated with the user annotation and stored in a data store, such as the shareable folder. The information indicated by the signal can include, but is not limited to, a username, a client identifier, a project identifier, and a date/time value. The annotation module 140 then associates and stores the information indicated by the signal to a data store, such as the shareable folder identified by the user.

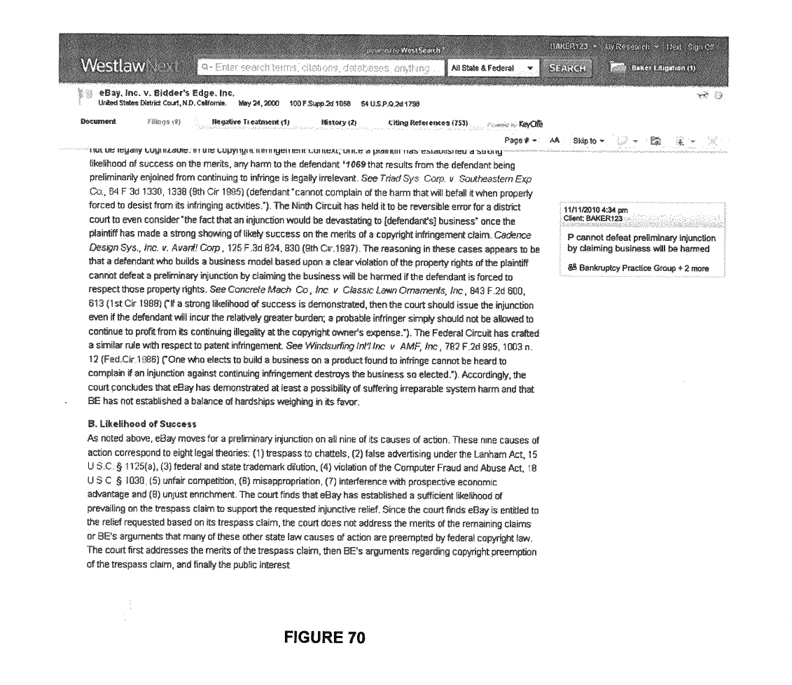

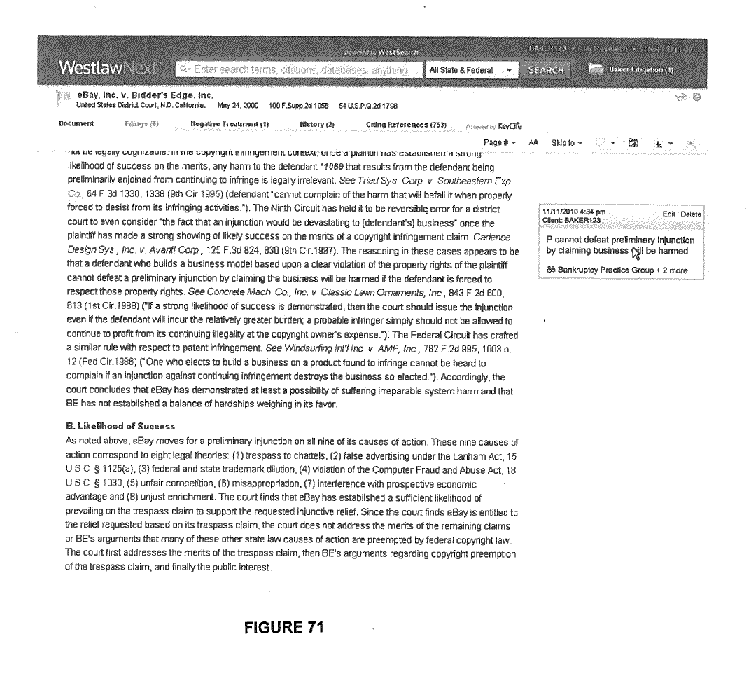

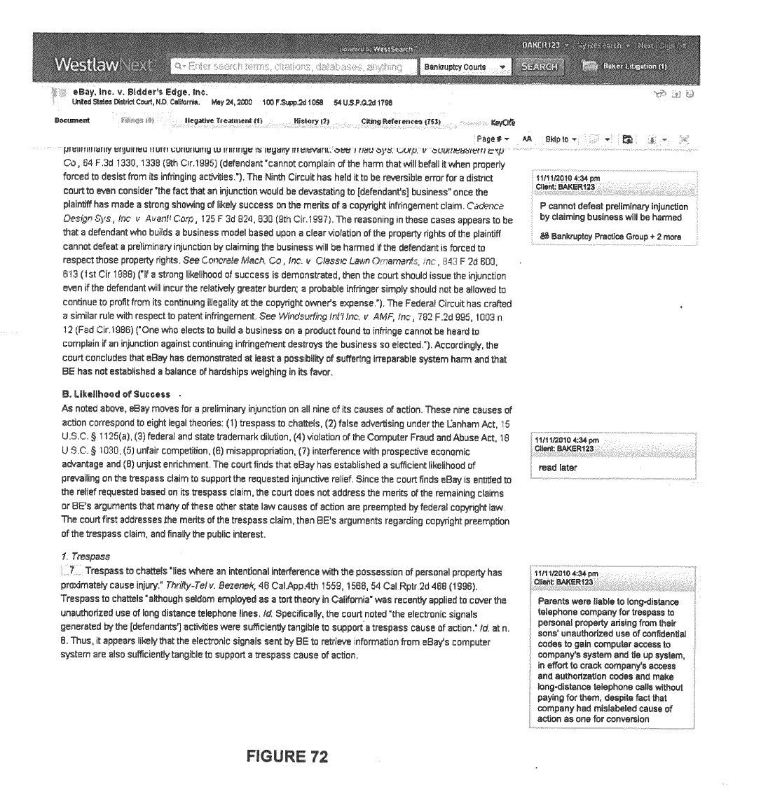

In one embodiment, the signal transmitted to the annotation module 140 indicates location information identifying a portion of a particular document the user annotation relates to. For example, upon a user adding a user annotation to a particular document and selecting the “Save’ button, location information describing a position of the annotation relative to the document (context position) is provided to the annotation module 140 for storage in the folder. Upon a subsequent request to retrieve the document by a user allowed access to the user annotation, the annotation module 140 accesses and transmits the context position, which is used by the exemplary interface to position and display the user annotation. Exemplary interfaces illustrating one or more user annotations displayed in a context position are shown in connection with FIGS. 70-72.

In one embodiment, if subsequent changes to the particular document affect the context position of the user annotation, the annotation module 140 estimates a context position within the changed document to reposition the user annotation. If estimation of the position is not possible, for example, due to significant changes in the document, a default position value is provided by the annotation module 140 for display to the user. For example, in one embodiment, if repositioning the user annotation is not successful, the user annotation is displayed at a top portion of the changed document.

Further, if a document having user annotations and/or markups is no longer accessible by the annotation module 140, in one example embodiment, the annotation module 140 provides a message indicating document unavailability and a list of user annotations and/or markups previously associated with the unavailable document. The exemplary interface then displays the message and the list of user annotations and markups to the user.

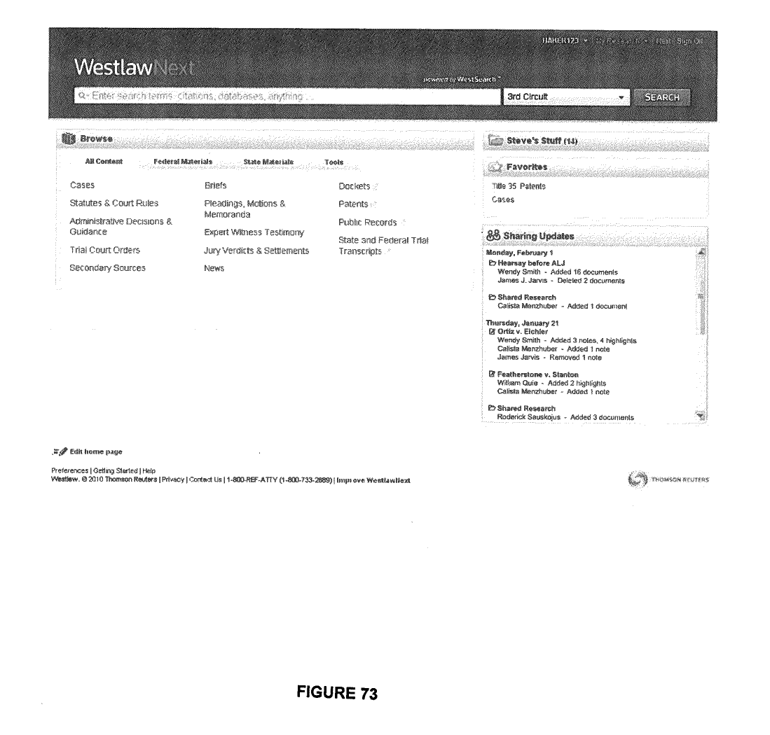

FIG. 73 illustrates an exemplary interface for displaying updates made to shareable folders, shared user annotations, and shared markups. In one embodiment, as updates to folders, users annotations, and markups are performed, the annotation module 140 stores information associated with the update in a data store. The annotation module 140 then provides the stored update information in response to a request. For example, as shown in the FIG. 73 example, in one embodiment, the annotation module 140 provides a user selectable list of updates affecting folders and documents that is sorted by date and displayed by the exemplary interface to a user.

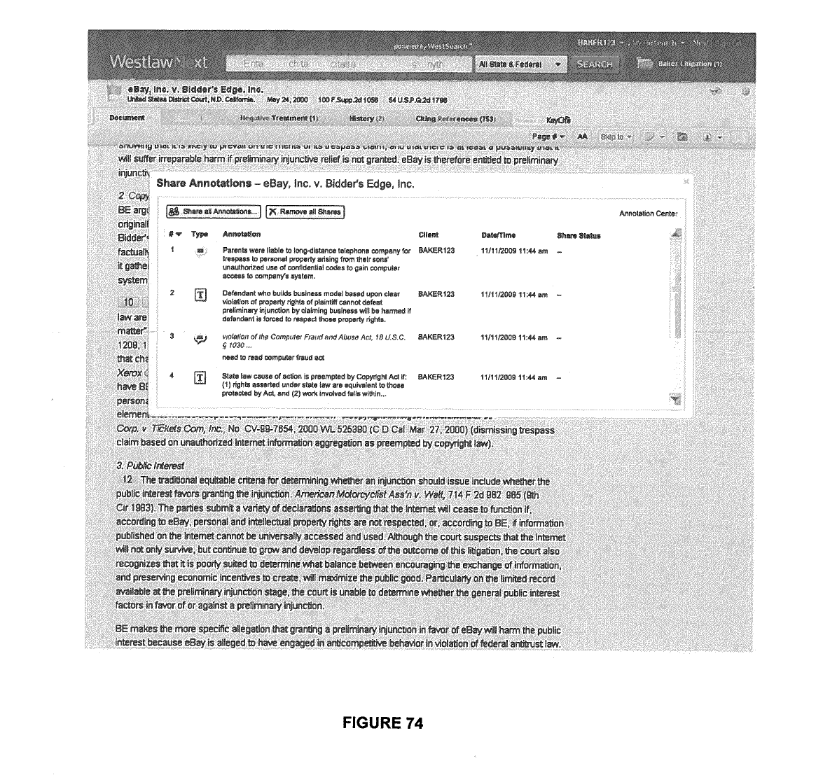

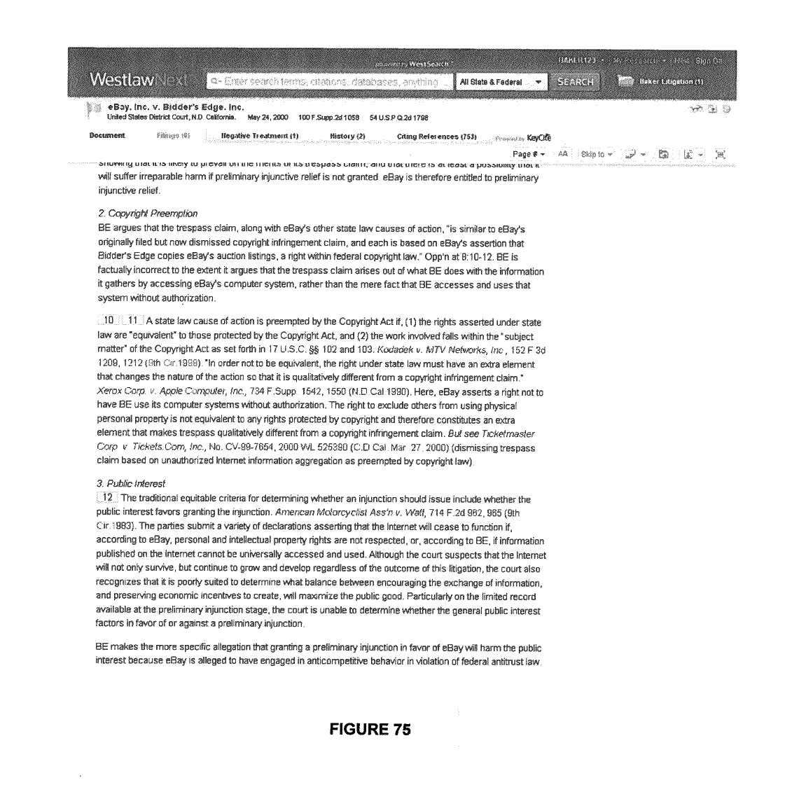

In one embodiment, user selection of one of the list of updates displays a summary annotation interface that allows a user to specify that one or more annotations and markups associated with a document are to be shared. The summary annotation interface also allows a user to specify that one or more shared annotations and markups associated with a document are to be deleted from the system. An example of the summary annotation interface is shown in connection with FIGS. 74-75.

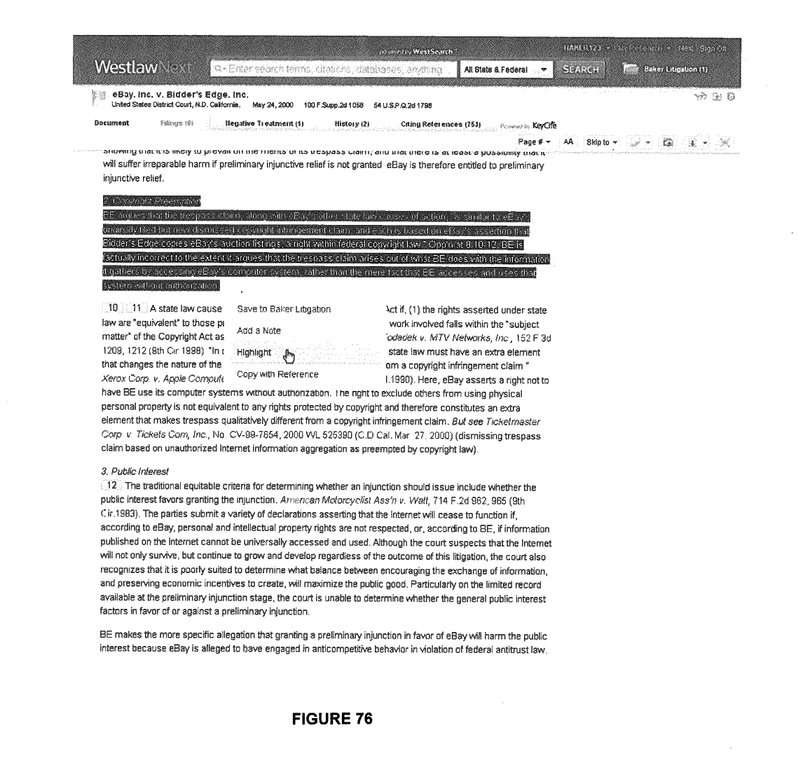

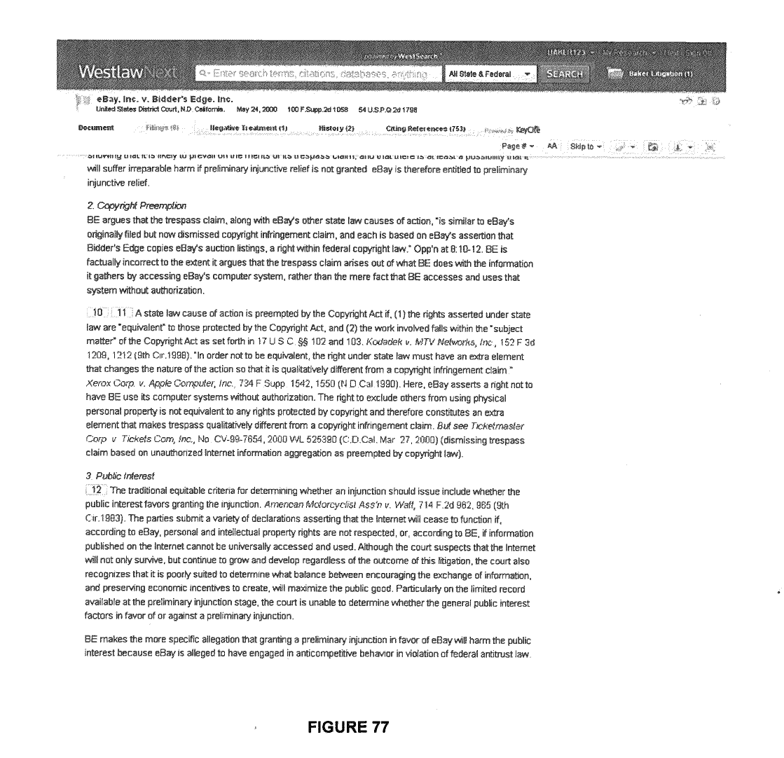

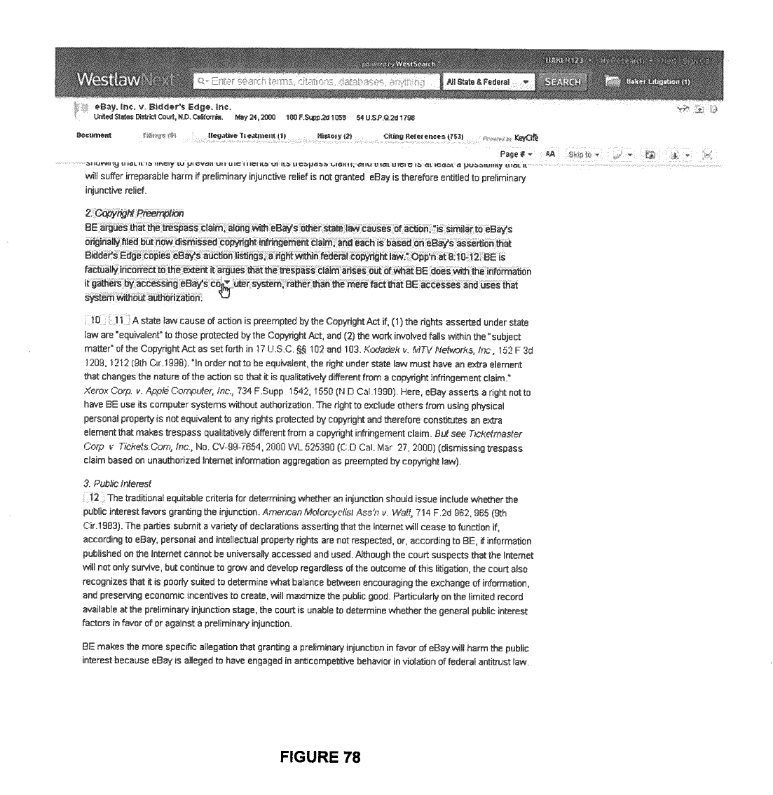

Turning now to FIGS. 76-82, exemplary interfaces for adding a multimedia indicator (e.g., markup) to a document, such as a highlight, are shown. As shown in the FIG. 76-77 example, in one embodiment, the exemplary interface provides a floating menu that includes a “Highlight” option. Upon a user selecting the “Highlight” option and a portion of text displayed in the document, location information associated with that portion of highlighted text is provided to the annotation module 140 for storage in a folder. In one embodiment, for example, the exemplary interface generates a Cascading Style Sheet (CSS) that describes the presentation semantics (e.g., the look and formatting) of the document including the multimedia indicator. The exemplary interface then transmits the CSS to the annotation module 140 for storage in the folder. Upon subsequent retrieval of the document by a user allowed access to the markup, the markup is displayed on the document at the selected portion using the location information provided by the annotation module 140. An example of highlighted text in a document is shown in connection with FIG. 78.

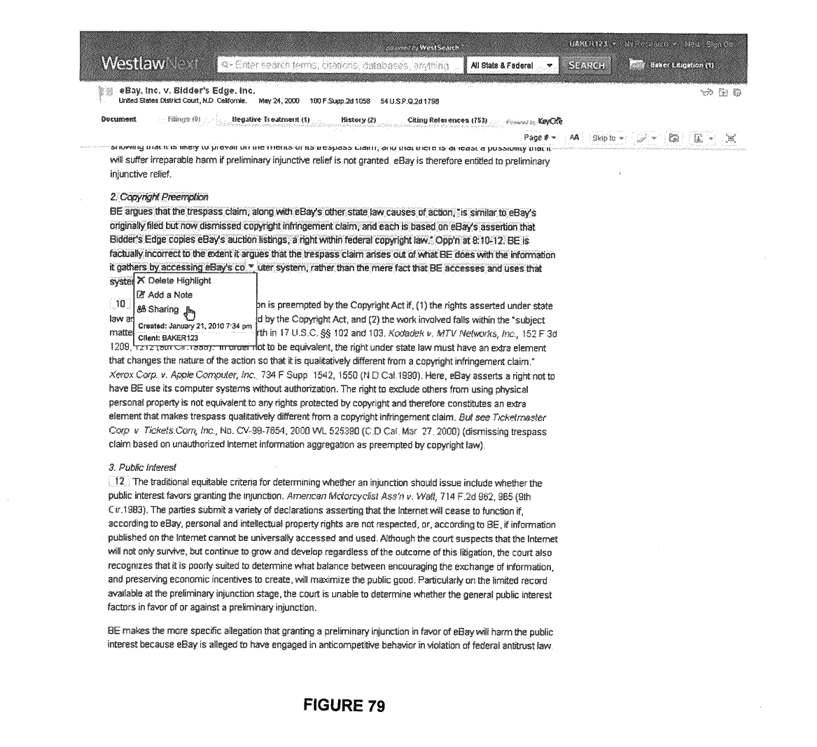

FIG. 79 illustrates an exemplary interface for sharing a highlight. As shown in the FIG. 79 example, in one embodiment, by placing a pointing device over a portion of highlighted text, the exemplary interface displays a second floating menu that includes a “Delete Highlight” option, an “Add a Note” option, and a “Sharing” option. As also shown in the FIG. 79 example, the second floating menu also displays a date and time value of when the highlight was created, as well as a client identifier associated with the highlight. The date and time value of the highlight as well as the client identifier are displayed in the second floating menu based on information received from the annotation module 140.

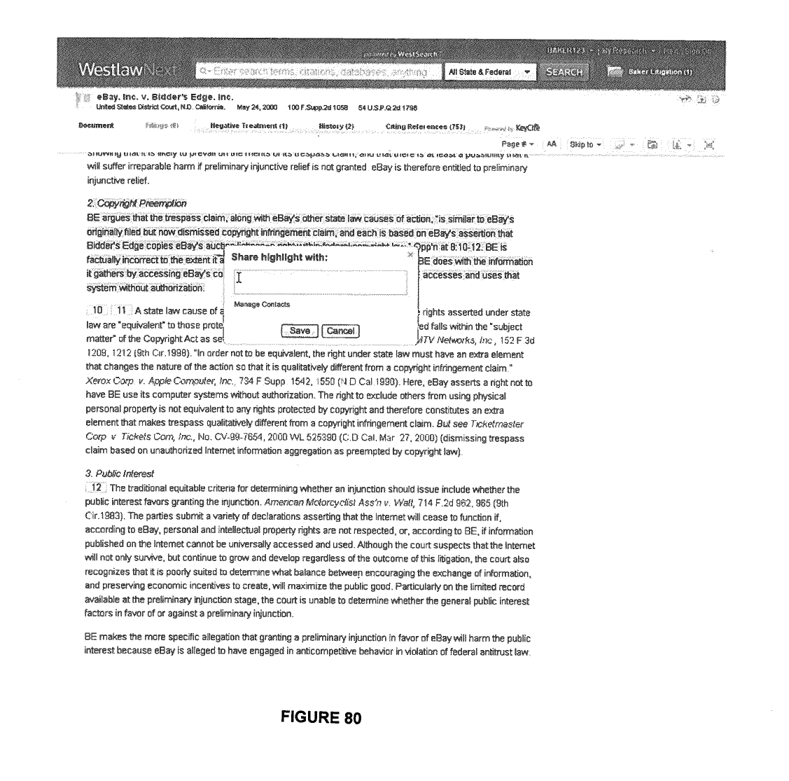

Referring now to FIG. 80, upon selecting the “Sharing” option of the second floating menu, the exemplary interface displays a share highlight interface. As shown in FIG. 80, the share highlight interface includes a text box for specifying one or more users or groups of users allowed to share the highlight.

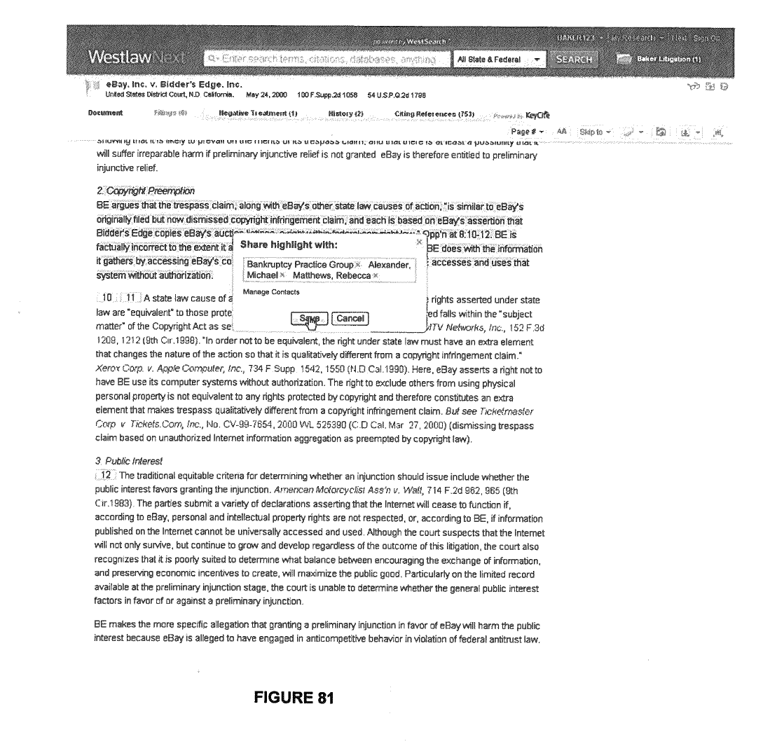

For example, as shown in the FIG. 81 example, users associated with a “Bankruptcy Practice Group”, as well as users “Alexander, Michael” and “Matthews, Rebecca” are identified as being allowed to share the highlight. In some embodiments, as shown in FIG. 81, a “Manage Contents” option is also provided that allows users and groups of users to be identified based on information received from the contact module 142.

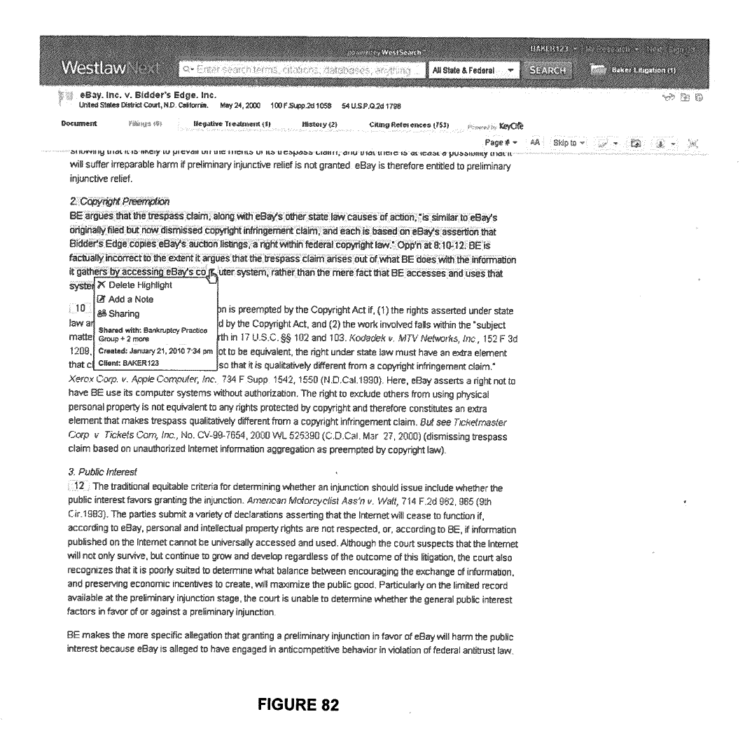

In one embodiment, once one or more users or groups of users are identified in the exemplary interface and the user selects a “save” button, the interface transmits a signal to the annotation module 140. Upon receiving the signal, the annotation module 140 set permissions on the highlight allowing it to be shared by the identified one or more users or groups of users. Once a highlight has been shared, as shown in FIG. 82, the second floating menu displays summary information relating to the highlight being shared (e.g., Bankruptcy Practice Group +2 more) received from the annotation module 140.

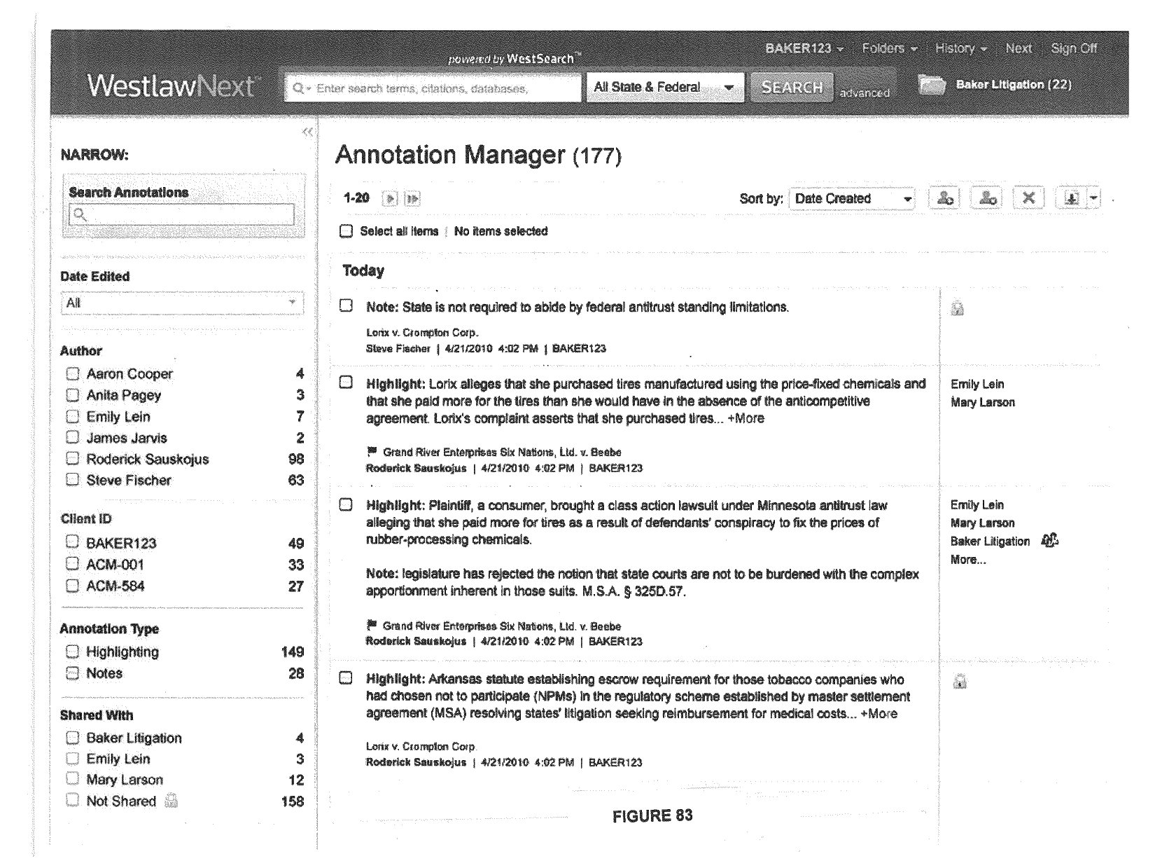

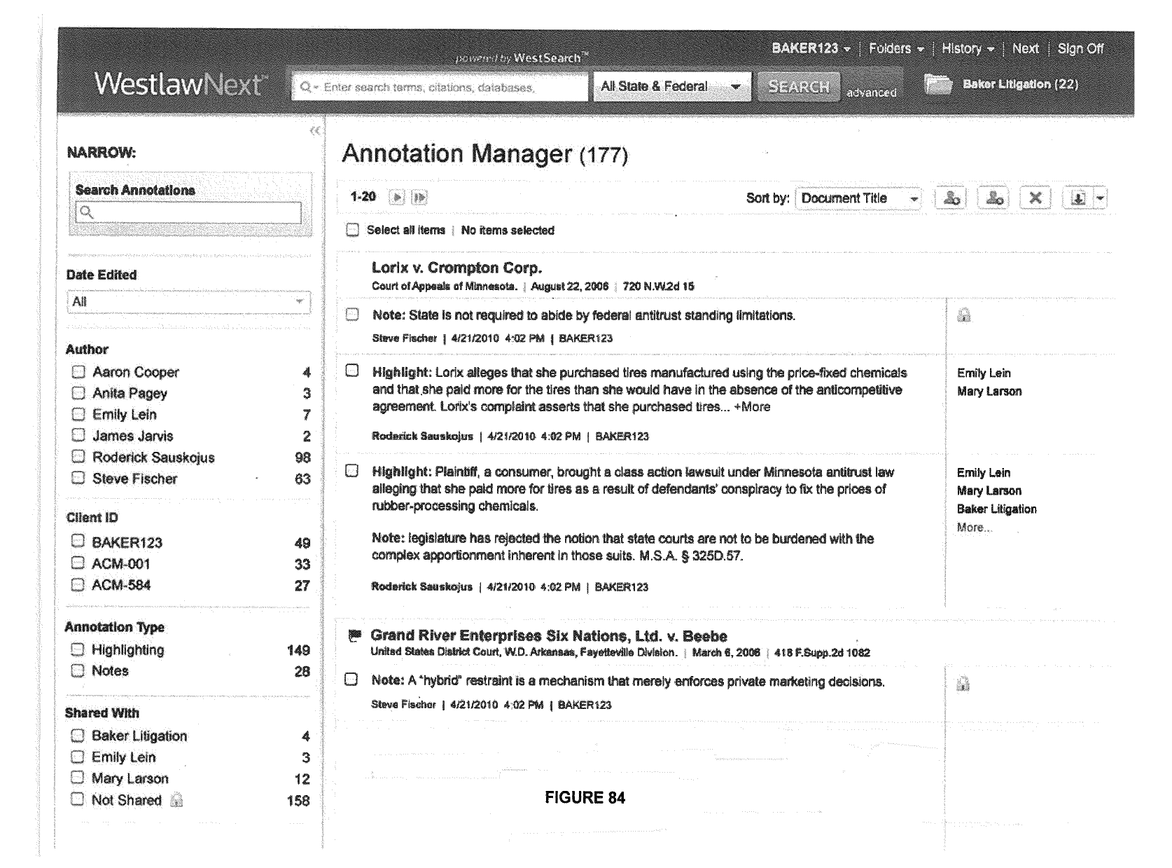

FIGS. 83-84 illustrate an exemplary interface for managing user annotations and markups. As shown in FIGS. 83 and 84, in one embodiment, the exemplary interface includes a display area for displaying user annotations and markups, a search annotation data entry field for entering search terms, and a plurality of user selectable filters for narrowing displayed results. Content of the display area, in one embodiment, can be displayed in date created order or document date order.

In one embodiment, upon initiation of the exemplary interface, the exemplary interface transmits a signal to the annotation module 140 that includes a username and/or client identifier. Upon receiving the signal, the annotation module 140 accesses one or more data stores storing user annotations and markups, and identifies which of the user annotations and markups the user or client identifier is authorized to access. The annotation module 140 then transmits a signal indicative of the identified user annotations and markups to the exemplary interface, which displays the same in the display area.

As shown in the display area of FIG. 83, in one embodiment, search results are displayed in a table format. A first column of the table displays whether the item is a user annotation or markup, contents or partial contents of the user annotation or markup, the name of the underlying document associated with the user annotation or markup, as well author, a date and time value, and client identifier (e.g., an identifier associated with a business entity registered to the user the system) associated with the user annotation or markup.

The second column of the table displays whether the user annotation is shared or not shared. For example, as shown in FIG. 83, the first item displayed in the search results is not shared, which is indicated by the “lock” icon displayed in the second column, whereas the third item in the search results is shared, which is indicated by individual usernames and a group name shown in the second column.

As shown in the FIG. 83 example, in one embodiment, the plurality of filters provided includes a dated edited filter, an author filter, an annotation type filter, and a shared filter. Each of the plurality of filters are user selectable and are displayed with data values determined during interface initialization. As shown in FIG. 83, each data value is displayed with a toggle button. For example, as indicated in FIG. 83, eight (8) data values representing authors are displayed in the author filter. Upon selection of one or more toggle buttons associated with author data values, only those user annotations and markups associated with the selected data vales are displayed in the display area. Other filters shown in FIG. 83 operate similarly. Further, any combination of selected filter data values can operate to narrow or expand search results shown in the display area.

The search annotation data entry field allows a user to specify search terms which are transmitted to the annotation module 140. Once the signal is received, the annotation module 140 compares the search terms to content of user annotations and text in documents highlighted, and transmits a signal to the exemplary interface indicative of user annotations and markups that include the search terms. The exemplary interface then displays the user annotations and markups in the display area.

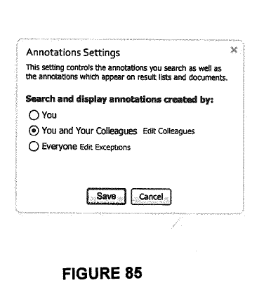

In one embodiment, referring now to FIG. 85, an exemplary interface for setting annotation preferences is shown. The exemplary interface provides a plurality of selectable radio buttons that allow a user to specify whether annotations searched, as well as annotations that appear on documents, are to be restricted to only those annotations and markups created by the user, created by the user and colleagues, or all other users. Once a radio button is selected and a “Save” button is selected, the selection is transmitted to the annotation module 140. In one embodiment, the annotation module 140 uses these options in determining which user annotations and markups are to be transmitted for display.

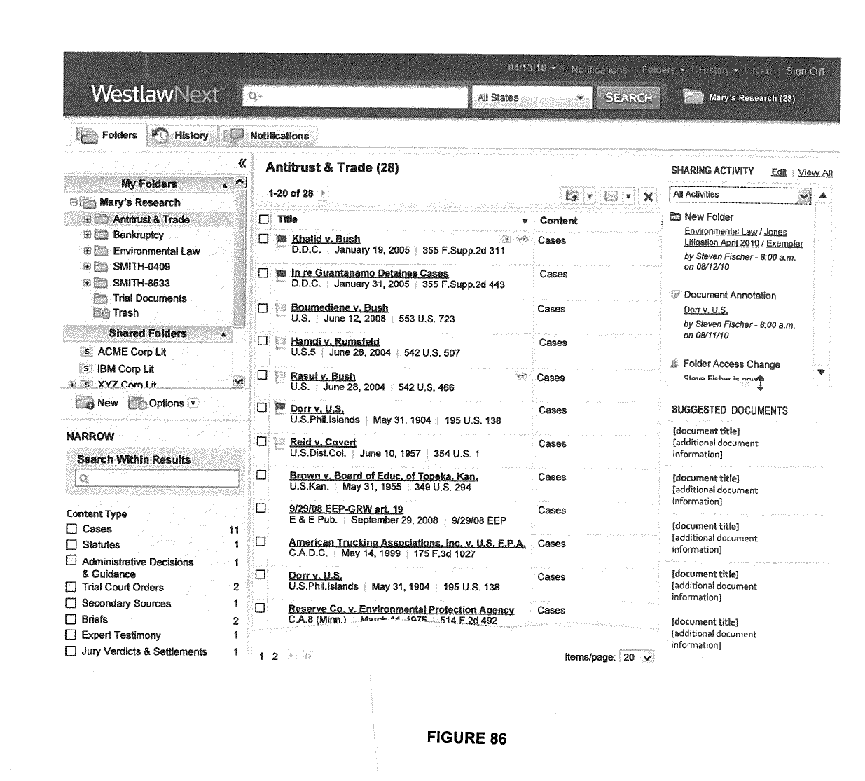

Turning now to FIG. 86, an exemplary interface for folder notifications is disclosed. As shown in FIG. 86, in one embodiment, the exemplary interface includes a sharing activity area. The sharing activity area displays a notification list of one or more events particular to folders in which the user is allowed to access. Example folder events include, but are not limited to, folder creation, folder comments, folder content changes, folder structure changes, folder access changes, as well as document changes. The event module 146 monitors any change made to folders or documents and stores a description of the change in a data store, which is then accessed and provided to the exemplary interface for display in the shared activity area in response to a request. In one embodiment, as shown in FIG. 86, the sharing activity area also includes a pull down menu allowing items in the notification list to be displayed based on event type.

In one embodiment, upon a user hovering over a list item using a pointing device, such as a mouse, the exemplary interface displays a menu allowing editing of notifications and data display settings for the particular item selected (e.g.

specific document or folder). The user is then provided with an interface to enter text that is to be transmitted to one or more selected users upon an event occurring. Once the text is entered and a “Save” option is selected, the text is transmitted to the event module 146. The event module 146 associates the text with an event type. In one embodiment, upon the event occurring, the event module 146 encapsulates the text in an email and transits the email to one or more selected users. For example, in one embodiment, the email message is an invitation to one or more users to view a particular document and associated users annotations and/or markups.

Advantageously, by displaying notifications and providing notification functionality, users of the system are able to made aware of events occurring in the system much more effectively.

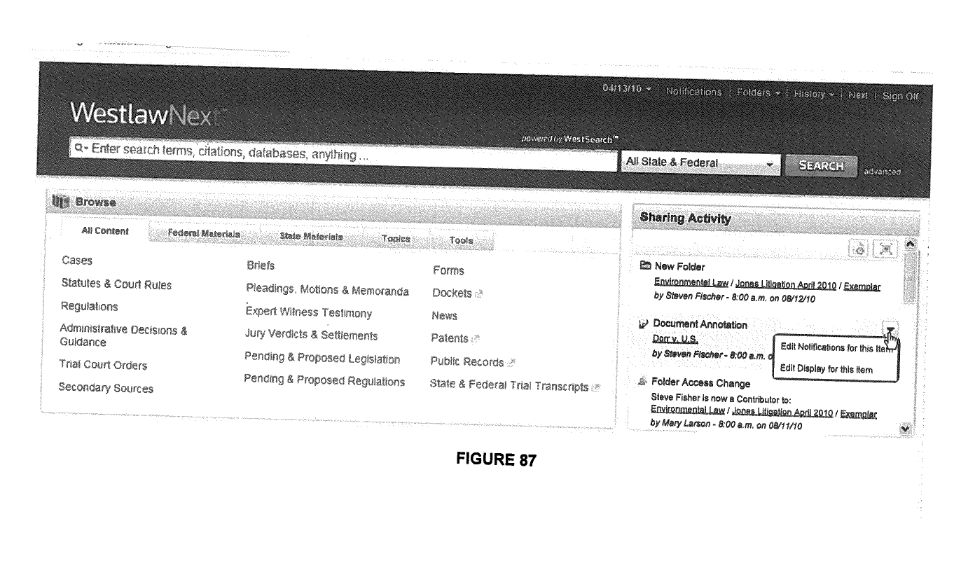

FIG. 87 illustrates that the sharing activity area is not limited to being displayed in the exemplary interface of FIG. 86. For example, as shown in FIG. 87, in one embodiment, the sharing activity area is included in a home page of the system and displays activities across the system.

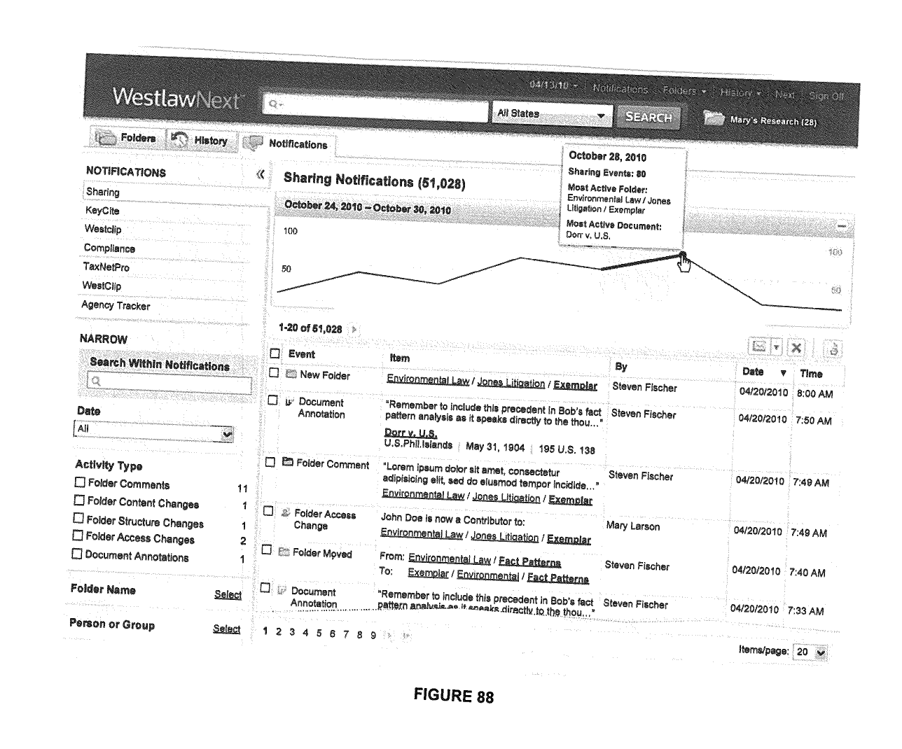

FIG. 88 illustrates an exemplary interface for displaying summary and detail events that have occurred in the system. As shown in FIG. 88, in one embodiment, the exemplary interface includes a graph area displaying cumulative events identified by the event module 146 over a user-configurable time period. In one embodiment, the graph area is interactive such that, upon a selection of a point along the graph representing a time value, the exemplary interface displays summary information transmitted by the event module 146 for events that occurred at that time value. For example, as shown in FIG. 88, upon selection of a point of the graph representing “Oct. 28, 2010”, the exemplary interface displays a listing showing the date selected, the number of events on the date selected, the most active folder in the system on the date selected, as well as the most active document in the system on the date selected.

In one embodiment, the exemplary interface also includes a detail area that lists each event that occurred in the system over the user-configurable time period. As shown in FIG. 88, in one embodiment, multiple events instantiated by different collaborators of the user are sorted first by date and time value, then by last name of collaborator. Further, as shown in FIG. 88, various filters are also provided to narrow or widen the amount of items displayed in both the graph area as well as the detail area. Data populated in the exemplary interface is provided by the event module 146 in response to a request.

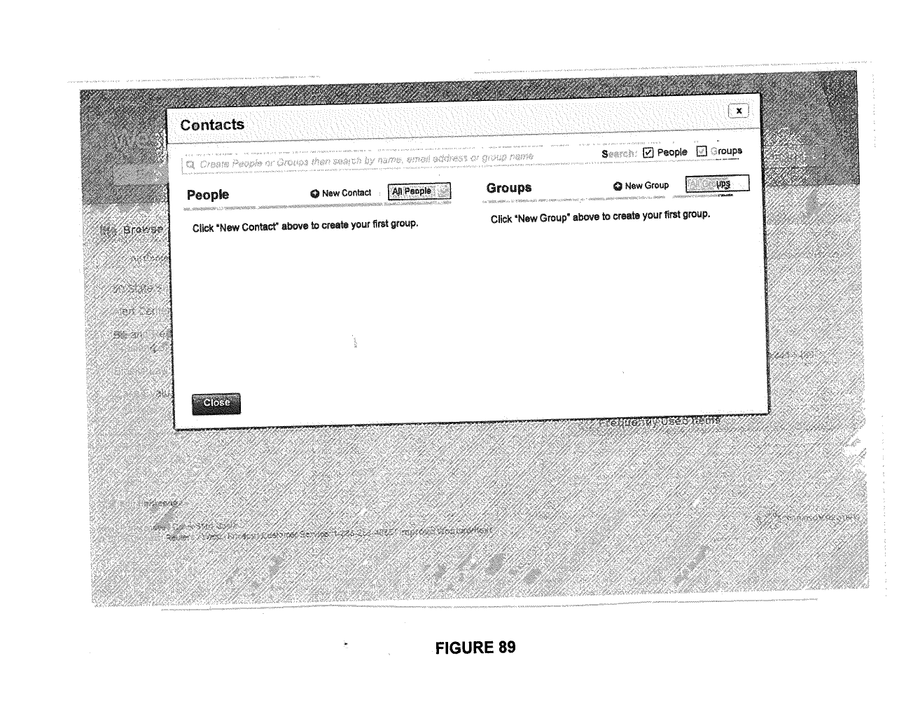

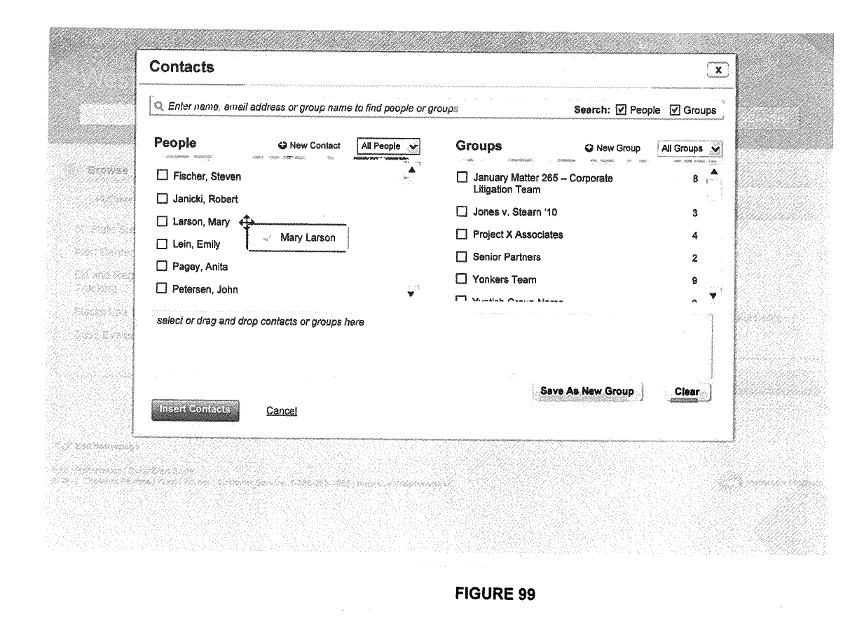

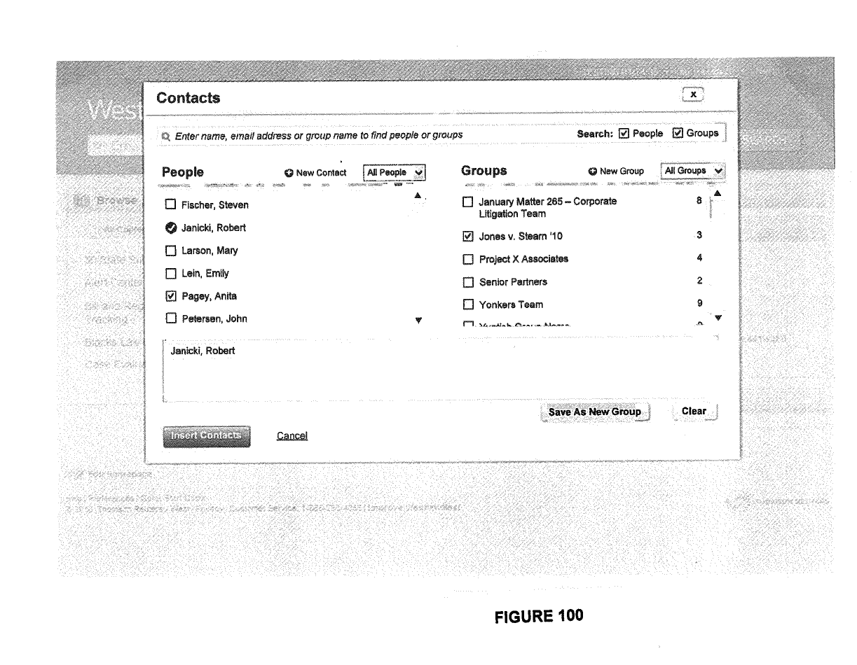

FIGS. 89-100 illustrate exemplary interfaces for identifying and adding users and groups to the system. FIG. 89 illustrates a default stated for the interface when no users or groups have been defined in the system. As shown in FIG. 89, in one embodiment, the interface includes a search field for allowing a user to search either users or groups, a people and group toggle button to specify whether information entered into the search field relates to a user or group, a user list area for adding and identifying users in the system, and a group area for adding and identifying groups (e.g., a collection of users referenced by a common identifier) in the system.

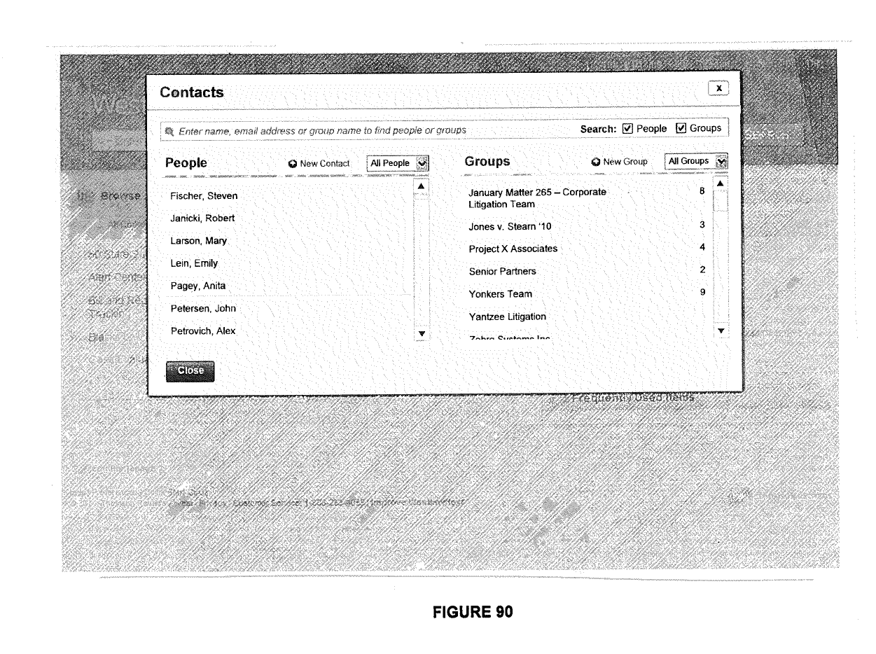

FIG. 90 illustrates the exemplary interface when both users and groups are defined in the system. As shown in the FIG. 90 example, in one embodiment, both the user and group areas include a drop down menu that defaults to “All People” and “All Groups”. The user area displays a list of users sorted alphabetically by last name and is scrollable of the user list items exceed a threshold value. Likewise, the group area displays a list of groups sorted alphabetically and scrolling is also provided when the group list items exceed a threshold value. List items for both the user list and group list are provided by the contact module 142 in response to a request.

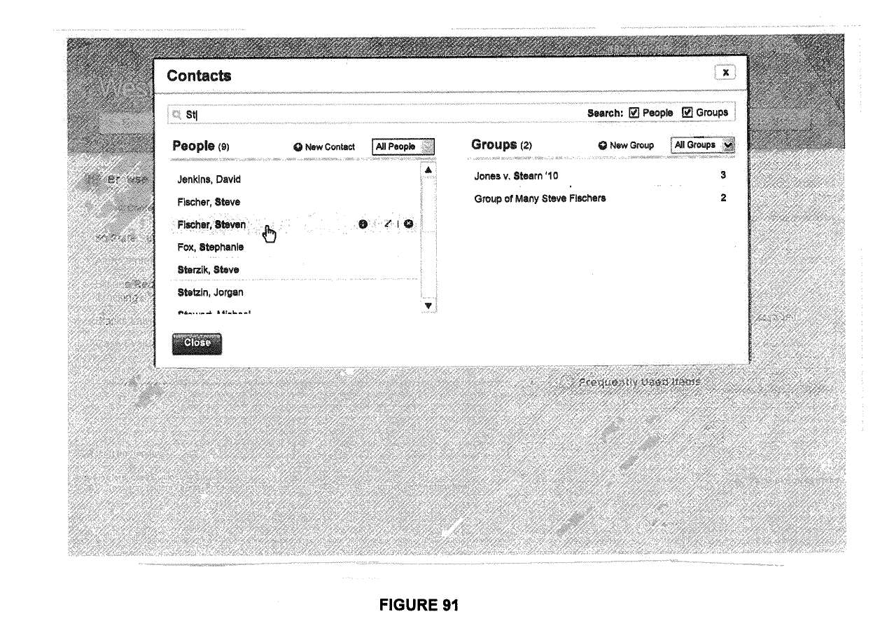

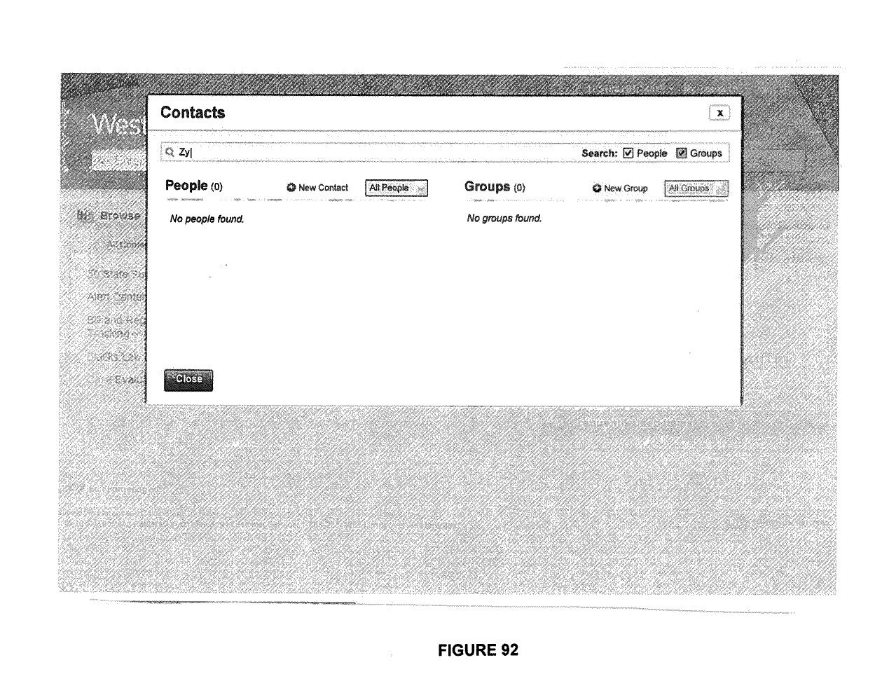

FIG. 91 illustrates a search of users and groups upon entering data in the search field of the interface. As shown in FIG. 91, in one embodiment, once a user has typed at least two characters in the search field, each of the user and group lists are narrowed to items that match the text entered. Further, upon a user selecting an item from the user list, in one embodiment, a plurality of action icons are provided that allow a user, to access additional information of the selected user, edit contact information of the selected user, as well as delete contact information of the selected user, if allowed. Likewise, for group items, upon selection of a group, a plurality of action icons are provided that allow a user, if permitted, to access additional information of the group, edit membership of users in the group, as well as delete the group. Upon selection of any of the icons and allowed permission, a signal request is sent to the contact module 142 to affect the action. FIG. 92 illustrates a state of the exemplary interface if no users or groups match information entered in the search field.

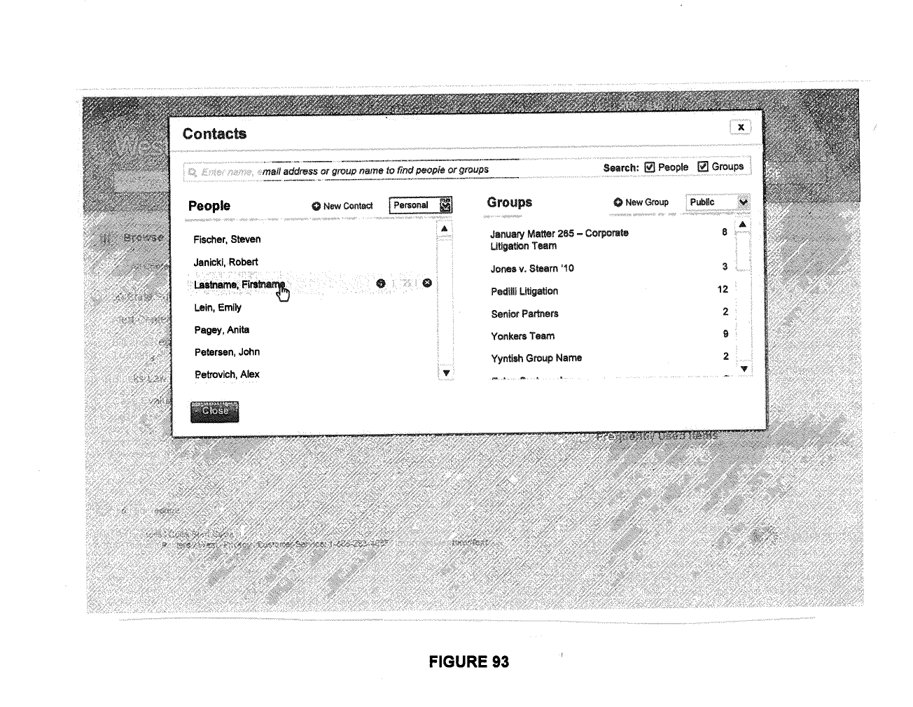

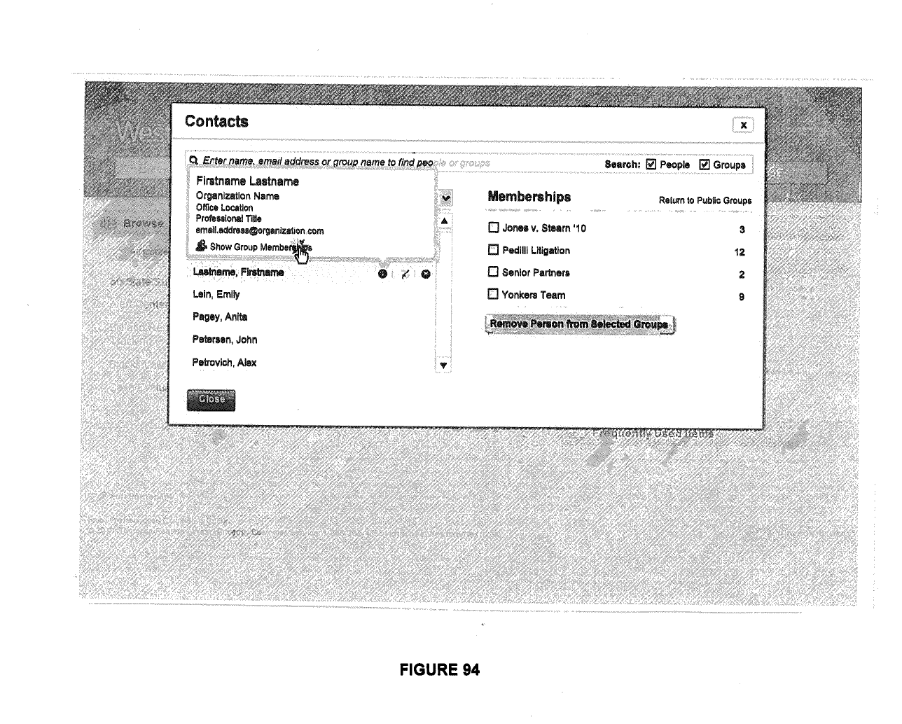

FIGS. 93 and 94 illustrate the exemplary interface of FIG. 91 wherein a users selects an item in the user list and hovers over an “Information” icon. In one embodiment, as shown in FIG. 94, upon a user hovering over the “Information” icon with a pointing device, such as a mouse, personal information for the selected user, such as organization affiliation, office location, professional title, and email address are displayed to the user. Further, as shown in FIG. 94, a show group membership option is also provided that, once selected, displays what groups the selected user is associated with. In one embodiment, the contact module 142 provides the personal information as well as group membership information by querying a data store of user and group information, and sending the same to the interface for display.

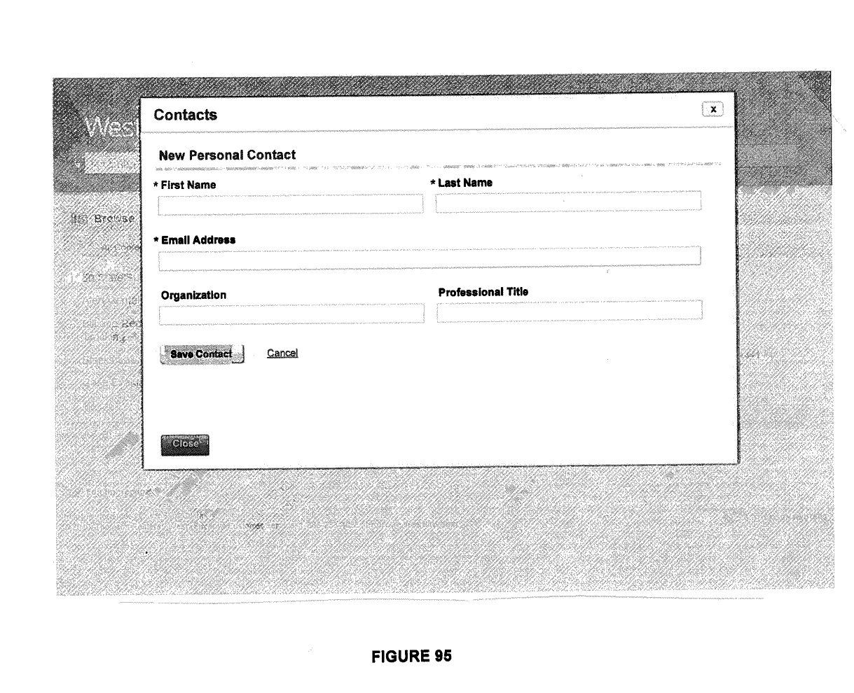

FIG. 95 illustrates an exemplary interface for adding a user and modifying personal information of an existing user. As shown in FIG. 95, in one embodiment, the interface includes a plurality of text entry fields for specifying a first name, a last name, an email address, an organization, and a profession title.

For a new user, the plurality of text entry fields contains null values. For an existing user, the plurality of text entry fields are populated with values received from the contact module 142 in response to a request. Once information is entered into text entry fields, the personal contact interface transmits a signal to the contact module 142 including information from the text entry fields. The contact module 132 then stores the personal information in a data store. New user and/or existing user personal information is then transmitted by the contact module 142 for display in the user list described in connection with FIG. 93.

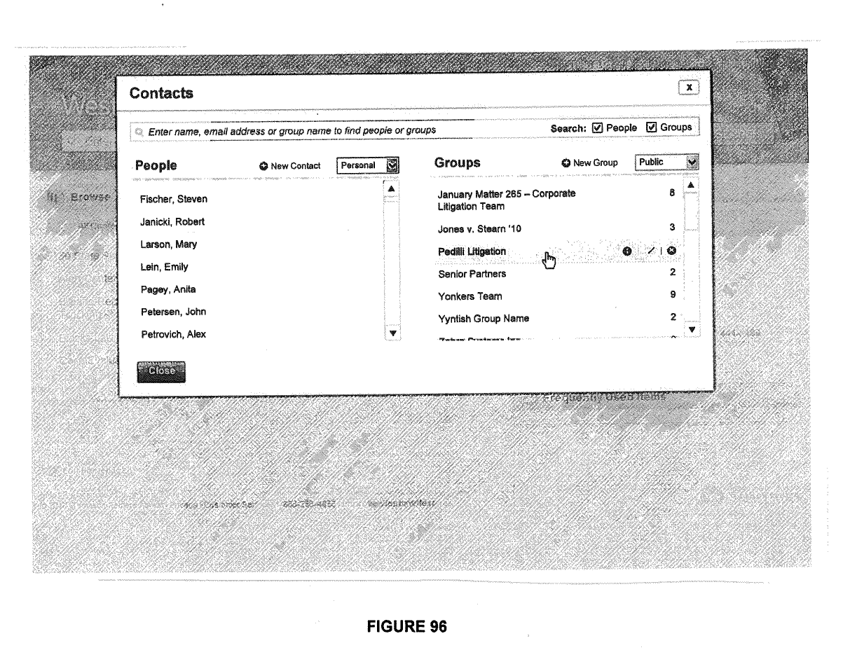

FIG. 96 illustrates further details of the group area provided by the exemplary interface shown n FIG. 93. As shown in FIG. 96, in one embodiment, a group pull down menu is provided that allows a user to specify whether all groups, personal groups (e.g., groups in which the user is a member), or public groups (e.g., groups in which any user may join) are to be displayed in the list of groups.

In one embodiment, when a user selects a group from the list of groups, a plurality of icons is displayed. The plurality of icons include a “Information” icon that once selected, displays one or more users comprising the selected group, an “Edit” icon that once selected, displays an interface for removing users from the selected group if the user has the appropriate authority, and a delete icon that sends a request to the contact module 142 to delete the selected group from the system if the user has the appropriate authority.

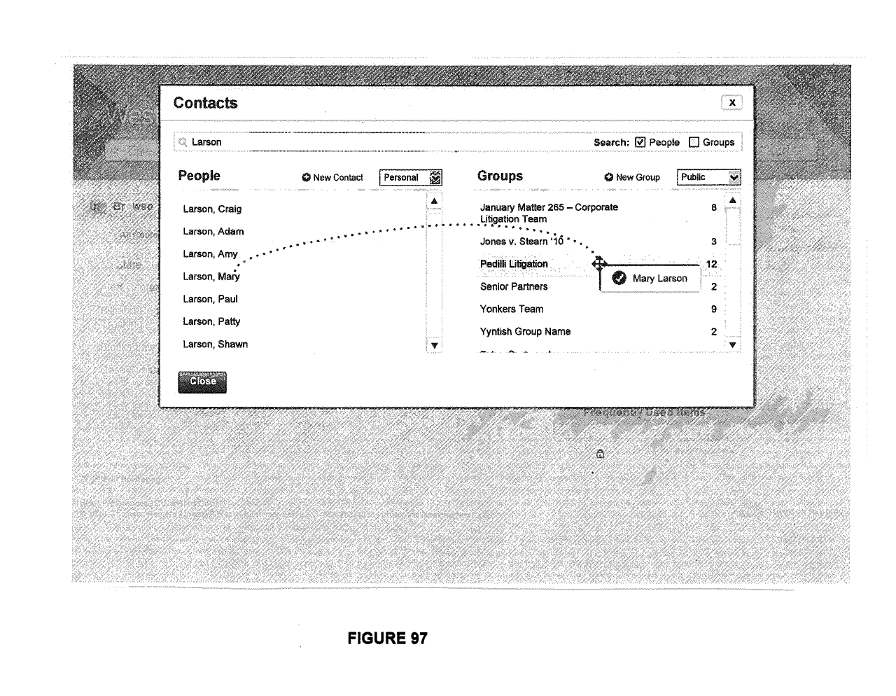

FIG. 97 illustrates an exemplary interface for adding an existing user to an existing group. In one embodiment, a user can click/drag/drop a username onto a group list item to add the respective user to the group. In addition, as shown in FIG. 97, each group list item includes an indication of the number of users associated with each group. In one embodiment, once a username is dropped onto a group item name, the exemplary interface transmits a signal to the contact module 142 to associate the selected username with the group item name. The context module 142 then stores the updated user membership of the group in a data store and transmits a signal to the exemplary interface indicating the same for display. For example, in one embodiment, the number of users displayed with the group item name is incremented and displayed.

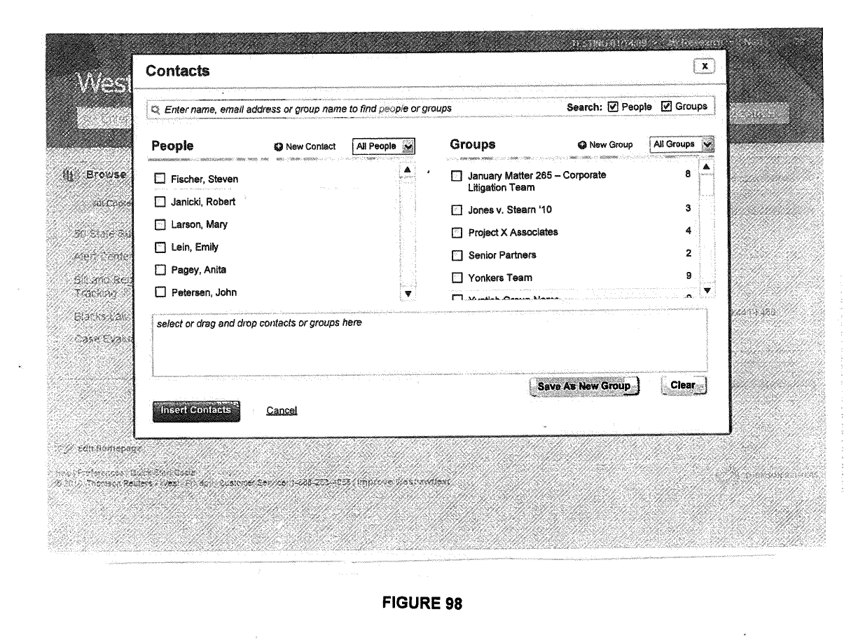

FIGS. 98-100 illustrate an exemplary interface for adding users to a new group. As shown in FIGS. 98-100, in one embodiment, each user item displayed in the user list and each group item displayed in the group list is associated with a check box. Further, a drop area is provided such that once a user selects a check box associated with a user item or a check box associated with a group item, the user item or group item is automatically added to the drop area. In one embodiment, when a user hovers over a user item or group item in the drop box using a pointing device, such as a mouse, the user item or group item hovered over receives a strikethrough display style. If the user then selects the strikethrough user item or group item, the selected user item or group item is deleted from the drop area. Upon the user specifying a name for the new group and selecting the “Save as New Group” button, the exemplary interface sends a signal to the contact module 142 including the specified new group name and data items in the drop area. In response to the signal, the contact module 142 generates the new group, associates any users or groups indicated in the signal with the new group, and stores the new group and user and/or group associations in a data store.

Various features of the system may be implemented in hardware, software, or a combination of hardware and software. For example, some features of the system may be implemented in one or more computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

### CONCLUSION

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the following claims and their equivalents.

What is claimed is:

1. A method of providing online legal research comprising:
receiving a first signal comprising a first query for searching a first set of legal documents;
in response to the first query, identifying a second set of legal documents, the second set of legal documents being a subset of the first set of documents;
receiving a second signal indicative of a user annotation to be associated with a particular document within the second set of legal documents;
associating the user annotation with the particular document; and
storing the user annotation and a reference to the particular document in a data store.

2. The method of claim 1, further comprising:
receiving a third signal comprising a request for the particular document; and
sending a fourth signal indicative of the user annotation and the reference in response to the request.

3. The method of claim 1, wherein associating the user annotation with the particular document comprises associating location information included in the second signal indicative of a location in the particular document with the user annotation.

4. The method of claim 1, further comprising associating multimedia information included in the second signal to at least a portion of the particular reference, the multimedia information describing at least one of a visual indicator and audio indicator.

5. The method of claim 4, wherein the visual indicator is a graphical highlight of a portion of content included in the particular reference.

6. The method of claim 4, wherein the multimedia information and the user annotation are associated with at least one of a username, a date, a client identifier, a project identifier, or combination thereof.

7. The method of claim 4, wherein the second signal further comprises at least one of a user name and a group of users allowed viewing, modification, or deletion of the user annotation or the multimedia indicator.

8. The method of claim 4, further comprising:
receiving a fifth signal indicative of an event type to be associated with the multimedia information, the user annotation, or a folder;
associating the event type with one of the multimedia information, the user annotation, and the folder; and
sending a sixth signal comprising a notification of an event occurring relating to the event type.

9. The method of claim 8, wherein the event is associated with at least one of an addition, a modification and a deletion of at least one of the user annotation, the multimedia information, and the folder.

10. The method of claim 8, wherein the notification is an e-mail notification.

11. The method of claim 8, wherein the notification is an invitation to view the particular document and at least one of the user annotation and media information.

12. The method of claim 1, wherein the data store is a shareable folder.

13. The method of claim 12, wherein content of the shareable folder is added, modified, or deleted based on at least one of a username and a group of usernames allowed access to the shareable folder.

14. The method of claim 4, further comprising:
receiving a fifth signal comprising a second query for searching at least one of a first set of user annotations and a first set of multimedia information;
in response to the second query, identifying at least one of a second set of user annotations and a second set of multimedia information; and
sending a sixth signal indicative of at least one of the second set of user annotations and the second set of multimedia information.

15. The method of claim 14, wherein identifying the second set of user annotations comprises comparing content of each of the first set of user annotations to the second query.

16. An article comprising a machine-readable medium storing machine-readable instructions that, when applied to the machine, cause the machine to:
identify a second set of legal documents from a first set of legal documents in response to receiving a first signal comprising a first query, the second set of legal documents a subset of the first set of legal documents;
associate a user annotation with a particular document associated with the second set of legal documents in response to receiving a second signal indicative of the user annotation and the particular document; and
store the user annotation and a reference to the particular document in a data store.

17. The article of claim 16 including instructions that, when applied to the machine, cause the machine to transmit a fourth signal indicative of the user annotation and the reference in response to receiving a third signal comprising a request for the particular document.

18. The article of claim 16 including instructions that, when applied to the machine, cause the machine to associate location information included in the second signal indicative of a location in the particular document with the user annotation.

19. The article of claim 16 including instructions that, when applied to the machine, cause the machine to associate multimedia information included in the second signal to at least a portion of the particular reference, the multimedia information describing at least one of a visual indicator and audio indicator.

20. The article of claim 19 including instructions that, when applied to the machine, cause the machine to associate a graphical highlight of a portion of content included in the particular reference with the particular reference.

21. The article of claim 19 including instructions that, when applied to the machine, cause the machine to associate one of a username, a date and time value, a client identifier, a project identifier, or combination thereof, with at least one of the multimedia information and the user annotation.

22. The article of claim 16 including instructions that, when applied to the machine, cause the machine to allow viewing, modifying, or deleting of the user annotation or the multimedia indicator based on at least one of a username and a group of users indicated in the second signal..

23. The article of claim 16 including instructions that, when applied to the machine, cause the machine to:
associate an event with one of a folder, the multimedia information, or the user annotation in response to receiving a fifth signal indicative of an event type to be associated with the multimedia information, the user annotation, or the folder; and
transmit a sixth signal comprising a notification of the event.

24. The article of claim 23 including instructions that, when applied to the machine, cause the machine to associate the event type with at least one of an addition, modification and deletion of the user annotation, the multimedia information, or the folder.

25. The article of claim 23 including instructions that, when applied to the machine, cause the machine to eMail the notification.

26. The article of claim 23 including instructions that, when applied to the machine, cause the machine to transmit an electronic invitation notification to view the particular document and at least one of the user annotation and media information.

27. The article of claim 16 including instructions that, when applied to the machine, cause the machine to store the user annotation and the reference to the particular document in a shareable electronic folder.

28. The article of claim 27 including instructions that, when applied to the machine, cause the machine to allow content of the shareable folder to be added, modified, or deleted based on at least one of a username and a group of usernames allowed access to the shareable folder.

29. The article of claim 19 including instructions that, when applied to the machine, cause the machine to:
identify at least one of a second set of user annotations and a second set of multimedia information in response to receiving a fifth signal comprising a second query for searching at least one of a first set of user annotations and a first set of multimedia information; and
transmit a sixth signal indicative of the at least one second set of user annotations and the second set of multimedia information.

30. The article of claim 29 including instructions that, when applied to the machine, cause the machine to search content of each of the first set of user annotations response to the second query.

31. A system comprising:
a data store;
a server coupled to the data store, the server including a processor and memory storing instructions that, in response to receiving a request for access to a service, cause the processor to:
identify a second set of legal documents from a first set of legal documents in response to receiving a first signal comprising a first query, the second set of legal documents a subset of the first set of legal documents;
associate a user annotation with a particular document associated with the second set of legal documents in response to receiving a second signal indicative of the user annotation and the particular document; and
store the user annotation and a reference to the particular document in the data store.

32. The system of claim 31 wherein the memory stores instructions that, in response to receiving the request, cause the processor to transmit a fourth signal indicative of the user annotation and the reference in response to receiving a third signal comprising a request for the particular document.

33. The system of claim 31 wherein the memory stores instructions that, in response to receiving the request, cause the processor to associate location information included in the second signal indicative of a location in the particular document with the user annotation.

34. The system of claim 31 wherein the memory stores instructions that, in response to receiving the request, cause the processor to associate multimedia information included in the second signal to at least a portion of the particular reference, the multimedia information describing at least one of a visual indicator and audio indicator.

35. The system of claim 34 wherein the memory stores instructions that, in response to receiving the request, cause the processor to associate a graphical highlight with a portion of content included in the particular reference.

36. The system of claim 34 wherein the memory stores instructions that, in response to receiving the request, cause the processor to associate one of a username, a date and time value, a client identifier, a project identifier, or combination thereof, with at least one of the multimedia information and the user annotation.

37. The system of claim 31 wherein the memory stores instructions that, in response to receiving the request, cause the processor to allow viewing, modifying, or deleting of the user annotation or the multimedia indicator based on at least one of a username and a group of users indicated in the second signal.

38. The system of claim 31 wherein the memory stores instructions that, in response to receiving the request, cause the processor to:
associate an event with one of a folder, the multimedia information, or the user annotation in response to receiving a fifth signal indicative of an event type to be associated with the multimedia information, the user annotation, or the folder; and
transmit a sixth signal comprising a notification of the event.

39. The system of claim 38 wherein the memory stores instructions that, in response to receiving the request, cause the processor to associate the event type with at least one of an addition, modification and deletion of the user annotation, the folder, or the multimedia information.

40. The system of claim 38 wherein the memory stores instructions that, in response to receiving the request, cause the processor to email the notification.

41. The system of claim 38 wherein the memory stores instructions that, in response to receiving the request, cause the processor to transmit an electronic invitation to view the particular document and at least one of the user annotation and media information.

42. The system of claim 31 wherein the memory stores instructions that, in response to receiving the request, cause the processor to store the user annotation and the reference to the particular document in a shareable electronic folder.

43. The system of claim 42 wherein the memory stores instructions that, in response to receiving the request, cause the processor to allow content of the shareable folder to be added, modified, or deleted based on at least one of a username and a group of usernames allowed access to the shareable folder.

44. The system of claim 31 wherein the memory stores instructions that, in response to receiving the request, cause the processor to:
identify at least one of a second set of user annotations and a second set of multimedia information in response to receiving a fifth signal comprising a second query for searching at least one of a first set of user annotations and a first set of multimedia information; and
transmit a sixth signal indicative of the at least one second set of user annotations and the second set of multimedia information.

45. The system of claim 44 wherein the memory stores instructions that, in response to receiving the request, cause the processor to search content of each of the first set of user annotations in response to the second query.
